(19) United States
(12) Patent Application Publication
(10) Pub. No.: US 2016/0212201 A1
(43) Pub. Date: Jul. 21, 2016

(54) Dual node network system and method

(71) Applicant: Jean Alexandera Munemann, London (GB)

(72) Inventor: Jean Alexandera Munemann, London (GB)

(21) Appl. No.: 13/999,740

(22) Filed: Mar. 17, 2014

(51) Int. Cl. H04L 29/08; H04L 12/24

(52) U.S. Cl. CPC H04L 67/104; H04L 41/12

(57) ABSTRACT

A dual node network system and method. An emperor node associated with prime nodes and adjunct nodes. Prime nodes are dual torrent nodes associated with individual users, having nodes A and B and may be associated with adjunct dual torrent nodes. An emperor node may be an emperor node of a separate network, referred to herein as an allied network and is in contact with other prime nodes. The present invention provides an organization of torrents to peer nodes, files shared, with whom the individual files are shared, and any limits places on files shared.

### CROSS REFERENCING TO RELATED APPLICATIONS

This application claims priority to U.S. Provisional Application 61/798,773, filed Mar. 15, 2013, incorporated herein by reference in its entirety.

### FIELD OF THE DISCLOSURE

Embodiments of this disclosure relate generally to dual node networking solutions in which dual data streams are utilized to update nodes in a network of computing devices.

### BACKGROUND OF THE DISCLOSURE

Current computer networks fail to incorporate a dual-node network system and method for continuously updating nodes by torrent streams.

### SUMMARY

Other embodiments, systems, methods, computer-readable media, aspects, and features of the invention will become apparent to those skilled in the art from the following detailed description, the accompanying drawings, and the appended claims.

### BRIEF DESCRIPTION OF THE DRAWINGS

Reference will now be made to the accompanying drawings, which are not necessarily drawn to scale, and wherein:

FIG. 1 is a data flow diagram of the example system search engine utilizing the user based

context-aware document data.

FIG. 2 is a schematic block diagram of an example architecture for a search engine system with a distributed database

FIG. 3 is a representative method flowchart featuring the steps of creating user defined tags.

FIG. 4 is a representative method flowchart featuring the steps of creating sponsored tags.

FIG. 5 is a representative method flowchart featuring the steps of creating embedded tags.

FIG. 6 is a representative graphic user interface [GUI) that allows a registered user to log in or a new user to register in the social networking website.

FIG. 7 is a representative GUI after a registered user has logged in to provide a starting point to utilize the social networking website's featured functions.

FIG. 8 is a representative GUI of a registered user's profile page, which enables the user to work with tags, invite friends, create teams, and other social networking tasks.

FIG. 9 is a representative GUI of another registered user's page where a user can invite to his team and send or request tags.

FIG. 10 is sequence of steps showing how lexicon data is filtered for relationship markers that exceed a threshold.

FIG. 11 is an illustration of how one stream in a two-part torrent stream updates the second stream.

FIG. 12 is an illustration of tags placed in a string.

FIG. 13 is a sequence of steps executed on a user device to request an anonymous ID.

FIG. 14 is an illustration of streams A and B forming an updatable torrent stream.

FIG. 15 is an illustration of open and closed torrent streams between a user's devices and other users communicating with the user over a computer network.

FIG. 16 is a representative GUI showing a plurality of torrents managed by a user.

FIG. 17 is a representation of a node network having an emperor node in communication with other nodes.

FIG. 18 is a representation of an emperor node associated with prime nodes and adjunct nodes.

FIG. 19 is a representation of decentralized network disengaged from an emperor node.

FIG. 20 is a representation of different devices used in a node network having an emperor node.

FIG. 21 is a representation of different devices used in a node network having an emperor node.

FIG. 22 is a representation of different devices used in a node network having an emperor node.

FIG. 23 is a flow diagram depicting a user journey over a node network.

FIG. 24 is a representation of a helix architecture for a node network of emperor nodes, prime nodes, and adjunct nodes.

FIG. 25 is a representation of a helix architecture for a node network of emperor nodes, prime nodes, and adjunct nodes.

FIG. 26 is a representation of a helix architecture for a node network of emperor nodes, prime nodes, and adjunct nodes.

FIG. 27 is a representation of prime nodes on different pitches of a helix architecture for a node network.

FIG. 28 is a representation of prime nodes on different pitches of a helix architecture for a node network.

FIG. 29 is a representation of prime nodes on different pitches of a helix architecture for a node network.

FIG. 30 is a representation of prime nodes on different pitches of a helix architecture for a node network.

FIG. 31 is a representation of prime nodes on different pitches of a helix architecture for a node network.

FIG. 32 represents various file sharing details for different nodes on the node network.

FIG. 33 represents various file sharing details for different nodes on the node network.

FIG. 34 represents various file sharing details for different nodes on the node network.

FIG. 35 represents various file sharing details for different nodes on the node network.

FIG. 36 represents various file sharing details for different nodes on the node network.

FIG. 37 represents message dissemination between various users on the node network having different proxy levels.

FIG. 38 represents various data streams utilized in a trading environment using the node network.

FIG. 39 represents various data streams utilized in a trading environment using the node network.

FIG. 40 represents various data streams utilized in a trading environment using the node network.

FIG. 41 represents a basic tool rose configuration having a social network messaging function.

FIG. 42 represents a basic tool rose configuration managing various types of files.

FIG. 43 represents a flow diagram showing two users using instances of the tool rose and node network to share tagged files in a consumer setting where one user is shopping for a car.

FIG. 44 represents a three-dimensional version of the tool rose.

FIG. 45 represents a three-dimensional version of the tool rose.

FIG. 46 represents a basic tool rose configuration having an aging function.

FIG. 47 represents an illustration of a tool rose.

FIG. 48 represents a basic tool rose configuration having a login/settings function.

FIG. 49 represents a basic tool rose configuration having a tagging function for tagging files.

FIG. 50 represents a basic tool rose configuration having a tagging function that includes emotional indicia to be associated with tagged files.

FIG. 51 represents a basic tool rose configuration having a tagging function that includes emotional indicia to be associated with tagged files.

FIG. 52 represents a tool rose having various types of tagging functions presented to a user for tagging files.

FIG. 53 represents a tool rose having a search function that expands to allow a user a variety of different types of search functions.

FIG. 54 represents various additional search functions expanded from a tool rose configured to provide standard and advanced search functions for files on a network.

FIG. 55 represents a display of search results returned by a tool rose having an ordered highlighting of search results.

FIG. 56 represents a display of search results returned by a tool rose having tags associated with the returned search results.

FIG. 57 represents a basic tool rose having numbered petals that are expandable to additional displays.

FIGS. 58A and 58B represent a dual helical arrangement of tool roses manipulated on a touch display.

FIGS. 59A and 59B represent tool roses of various shapes and colors arranged in a helical arrangement.

FIG. 60 represents tool roses in helical arrangements having a staggered arrangement of monochrome to reduce eye strain.

FIG. 61 represents tool roses in helical arrangements having a staggered arrangement of monochrome to reduce eye strain.

FIGS. 62A and 62 B represent a tool rose modifying a displayed plurality of files to include tags placed by the tool rose.

FIG. 63 represents a tool rose selected from combined helixes of various tool roses displayed on a touch screen to a user.

FIG. 64 represents a tool rose having various expandable tool roses contained therein.

FIG. 65 represents associated tool roses displayed in alternating monochrome configurations to reduce eye strain.

FIG. 66 represents associated tool roses displayed in alternating monochrome configurations to reduce eye strain.

FIG. 67 represents associated tool roses displayed in alternating monochrome configurations to reduce eye strain.

FIG. 68 represents associated tool roses displayed in alternating monochrome configurations to reduce eye strain.

FIG. 69 represents associated tool roses displayed in alternating monochrome configurations to reduce eye strain.

FIG. 70 represents associated tool roses displayed in alternating monochrome configurations to reduce eye strain.

FIG. 71 represents associated tool roses displayed in alternating monochrome configurations to reduce eye strain.

FIG. 72 represents multiple helixes of tool roses intersecting when displayed to a user for selection.

FIG. 73 represents a website being reviewed with the helix structure of tool roses of FIG. 72 displayed to provide various editing and tagging functions to a user while reviewing the website.

FIG. 74 represents a tool rose having a pictorial display and various levels of functionalities included in layers around the pictorial display.

FIG. 75 represents a tool rose having a pictorial display and various levels of functionalities included in layers around the pictorial display.

FIG. 76 represents a tool rose having additional search capabilities including contextual search.

FIG. 77 represents a tool rose having a search capability based on degrees of separation, profession type, emotion type, location type, and an expandable interaction space associated with the different search types displayed.

FIG. 78 represents a dual-oscillating display of a pseudo random number generator.

FIG. 79 represents an outer shell sieve filter used in connection with the pseudo random number generator of FIG. 78.

FIG. 80 represents a tool rose integrated with other devices onto a glove worn on a human Hand.

FIG. 81 illustrates a human wearing a pendant and ear attachment that connect a user with the node network.

FIG. 82 represents the human ear.

FIG. 83 represents the ear attachment of FIG. 81.

FIG. 84 represents the pendant attachment of FIG. 81.

FIG. 85 represents interfaces presented to a user when reviewing an image showing items of interest to the user.

FIG. 86 represents a tool rose and other interfaces presented to a user when reviewing an image showing items of interest to a user.

FIG. 87 represents personalized links associated with images presented to a user when reviewing images.

FIG. 88 represents personalized links associated with images presented to a user when reviewing images.

FIG. 89 represents personalized links associated with images presented to a user when reviewing images.

FIG. 90 represents personalized links associated with images presented to a user when reviewing images.

FIG. 91 represents a deep focus camera capturing an image and in communication with a computer and data store.

FIG. 92 represents multiple deep-focus cameras capturing images of a subject from different angles and in communication with a computer and data store.

FIG. 93 represents a three-dimensional image of a human body and associated documents.

FIG. 94 represents a three-dimensional image of a desk.

FIG. 95 represents multiple layers of screens positioned and aligned for display of three-dimensional images.

FIG. 96 represents a section of an individual screen magnified using a specific color to create a sense of depth to a user.

FIG. 97 represents a color table showing a listing of various colors and their respective frequencies and wavelengths.

FIG. 98 represents association of colors between multiple screens.

FIG. 99 represents a magnified section of a screen in FIG. 98 set in a five-point pattern to create a sense of depth.

FIG. 100 represents three screens aligned for display of three-dimensional images, an etching point, and a light source.

FIG. 101 represents a magnified section of one of the screens shown in FIG. 100.

FIG. 102 represents an augmented reality projection system having aligned screens for display of three-dimensional images as well as placement of deep focus projectors and scent delivery units in proximity to the aligned screen.

FIG. 103 represents a deep focus cube used in a film studio sound stage.

FIG. 104 represents a movable, three-dimensional camera cage or grid used for removal of the appearance of cameras placed in view of other cameras during image capture.

FIG. 105 represents a plan view of the camera cage of FIG. 104.

FIG. 106 represents placement of the deep focus projectors, scent delivery units and aligned screens in proximity to a human viewer.

FIG. 107 represents a set of scent delivery units that communicate with each other.

FIG. 108 represents a scent cartridge by itself and placed in a multiple-cartridge unit.

FIG. 109 represents a foil-backed scent cartridge and a backing plate that controllably releases scents from the scent cartridge.

FIG. 110 represents a multiple-cartridge unit of FIG. 108 also with the backing plate of FIG. 109 and various other functional components.

FIG. 111A and FIG. 111B represent a scent broach having scent generation and other functional components.

FIG. 112 illustrates visualization of a tied link chain where links have a meta data tag of family birthdays.

### DETAILED DESCRIPTION

Illustrative embodiments of the disclosure will now be described more fully hereinafter with reference to the accompanying drawings, in which some, but not all embodiments of the disclosure are shown. The disclosure may be embodied in many different forms and should not be construed as limited to the embodiments set forth herein; rather, these embodiments are provided so that this disclosure will satisfy applicable legal requirements. Like numbers refer to like elements throughout.

Embodiments of the disclosure now will be described more fully hereinafter with reference to the accompanying drawings, in which embodiments of the invention are shown. The invention may, however, be embodied in many different forms and should not be construed as limited to the embodiments set forth herein; rather, these embodiments are provided so that this disclosure will be thorough and complete, and will fully convey the scope of the invention to those skilled in the art Like numbers refer to like elements throughout.

Traditional web-searches have been relying heavily on automated algorithms for document mining and web-searching. They may utilize heuristics related to keywords or strings inside web-based documents to identify documents related to search terms. Some examples of these heuristics may be utilizing a word frequency match between a search term and terms present in the document For example, if a user queries a web-search engine with the term “Matrix”, the documents may be identified based on the occurrence of the term “Matrix” within the webpage documents.

These heuristic searches may not be able to differentiate semantic contexts of various terms or perform semantic analysis regarding the meaning of specific terms. Therefore, referring back to the previous example, the user may be querying for vastly different types of documents. If the user is a mathematician, the word “Matrix” may be in reference to a rectangular array of numbers. If the user is a fan of science fiction, the word “Matrix” may reference a popular 1999 movie starring Keanu Reeves. A web search engine utilizing only heuristics and statistical algorithms may return irrelevant searches to many users.

These systems may not account for additional context or human knowledge to personalize or customize the web search based on the needs of a user. For example, the best webpage for learning about mathematical matrix operations may not rank highly on the search results of a traditional search-based engine. The webpage might not contain the appropriate met tags or data for a traditional search engine to identify. Further, in the set of all-internet users, people may have various expertise and specialty for which they are better able to provide semantic understanding or contexts-based understanding.

These people may have unique knowledge about specific websites and documents. Therefore the knowledge encompassed by these experts” may provide for more relevant web search results that are customized for the preferences of a user. The experts may encompass a broad range of patterns, preferences and skills that may be utilized and leveraged for a more satisfactory experience.

Embodiments of this disclosure provide for human-knowledge based tagging or identification of web documents. This knowledge may be utilized and restricted based on community membership, contextual usage, social media connectivity, ratings, emotions and other such contextual information.

In one example, an opera singer “Placido”, who comes from Spain may be invited for an opera performance at the “Detroit Opera House.” Although, the area near Detroit Opera house is deemed emotionally “safe” by human-based experts of the city of Detroit, areas surrounding the opera house can be rated anywhere from “Shady” to “very dangerous” by these local experts. If Placido wanted to try the local cuisine at a restaurant and uses a traditional search engines and inputs the terms “Michigan Cuisine” and “Detroit”, a top search result may include “8 Mile Grill” and directions for the 8 Mile Grill through a road known as the 8 mile road. However, there are certain parts of the 8 mile road that may be deemed dangerous, and an alternate route may be “safer” for Placido. Traditional search engines would not be able to utilize emotion-based understanding and therefore would be unequipped to answer Placido's query.

However, if the search engine could tap into a local expert's knowledge, the local expert “Marshall” who is very familiar with Detroit and incredibly familiar with “8 Mile Road”, may be able to input his knowledge of various sections of 8 mile with emotional ratings such as “Safe” and “unsafe.” Placido would be able to determine if the restaurant “8 Mile Grill” is in a safe neighborhood.

The invention includes a creating user-informed-customized tags. The method provides an ability to retrieve the tags from an online social networking environment that supports tags re

Tags can be created by the user via the provider's user interface by defining various tag parameters, e.g. name, graphic icon, etc. This invention discloses a system and method for creating customized tags that represents personal characteristics and preferences, by users of a social network website, to facilitate online social networking, as well as advertisement method in the online social networking environment by using sponsored tags.

Tags can be embeddable in that they could be inserted in a website GUI for display by a user. Also, tags may have embedded contents, e.g. a photo, a song, a location of a profile page, a shout out, an expression of feelings, tags, or presents.

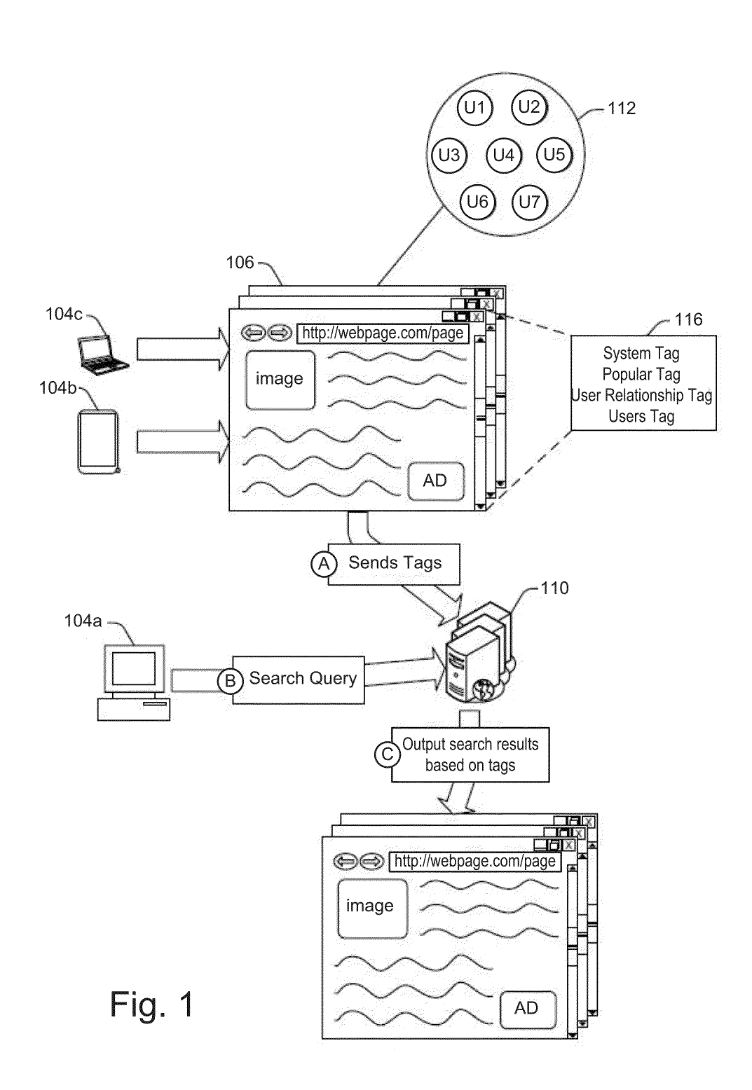

FIG. 1 is a data flow diagram of an example system for expert-informed information acquisition. In the example system, a website 106 may be visited and viewed by individual user and their individual user devices 104. Further, the website may be related to a topic have particular content Therefore, the content of the website 106 may be identified through the use of identifier tags. In the example system, the website 106 may have an automated tagging or a system tag based on the words or other tokens utilized in the website. For example, if a website has text for the words “fast ferry”, one can associate that with search query relating to a “ship”, for example. However, these automated system tags may not be able to provide semantic understanding of a particular document Further, users may browse a particular website and for that particular website 106 and may provide user-specific tagging. If many users from many different areas and expertise provide similar or same tags, then the websites 106 may have popular tags associated with many users. Further, users may have specific context or specific-user group related terminology. For example, a group of marine engineers may be interested in different information than a group of tourists who visit a cruise. However, similar terminology maybe used on both websites. Therefore, while browsing, a group of marine engineers may add additional context such as “engineering” or “ship design” as tags. However, these tags would not be equally applicable to all. Therefore, the user relationship tag may be restricted via user group. Finally, a user may provide his individual tag for specific information.

Further, the user specific tags may contain other information such as “emotion”. In operation A, with all of these tags, a user device, an application downloaded on the user device, a web-browser add-on may send all these contextual tags to the search engine server 110. The service provider system 110 may identify compare the query with a hierarchy of user-defined tags. This hierarchy may be based on user preferences and may be prioritized based on privacy and group settings.

In operation B, a user device 104 may enter a search query. During the search query, the user may enter keywords, restrictions on relationship tags. For example, if a user wants to utilize relationship tags by people who are directly connected to him on a social network, or communicatively connected to him directly the user would be able to enter such a restriction that only tags from people who have one degree of separation would be utilized. Further, the user may have negative refiners such as hiding search results that have already been seen by the user, excluding websites with certain tags. For example, if a marine engineer did not want to view websites about “cruise lines”, the marine engineer may input a negative refiner such as “vacation” and this would remove all websites having an associated tag of “vacation.”

In operation C, based on the hierarchy and user-specific tags, the service provider system 110 may output a search results based on the TAGs.

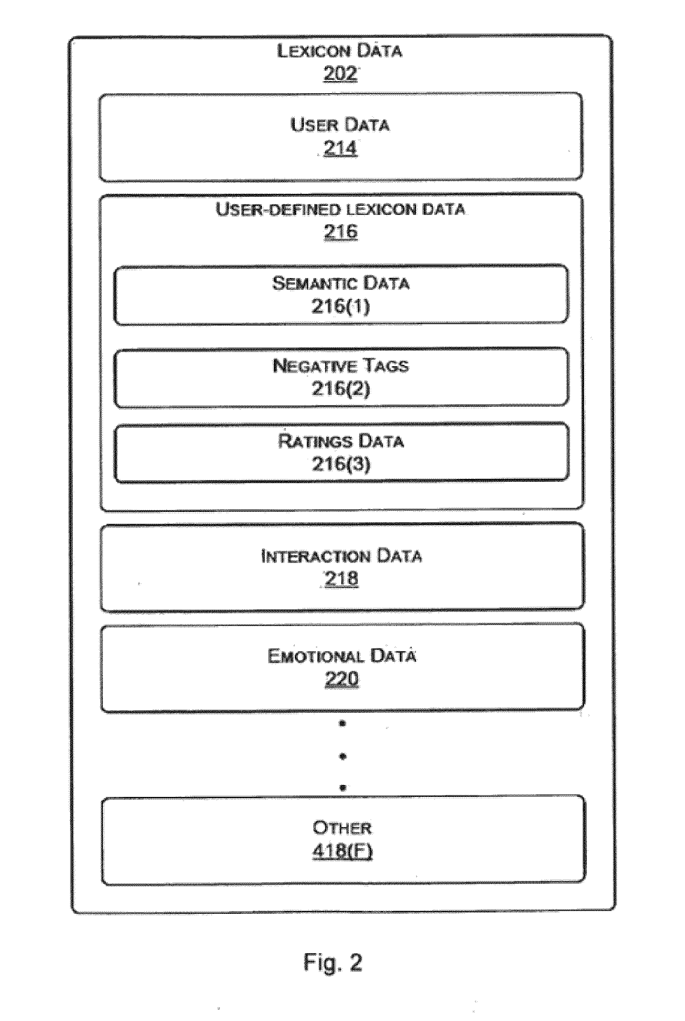

FIG. 2 a data hierarchy.

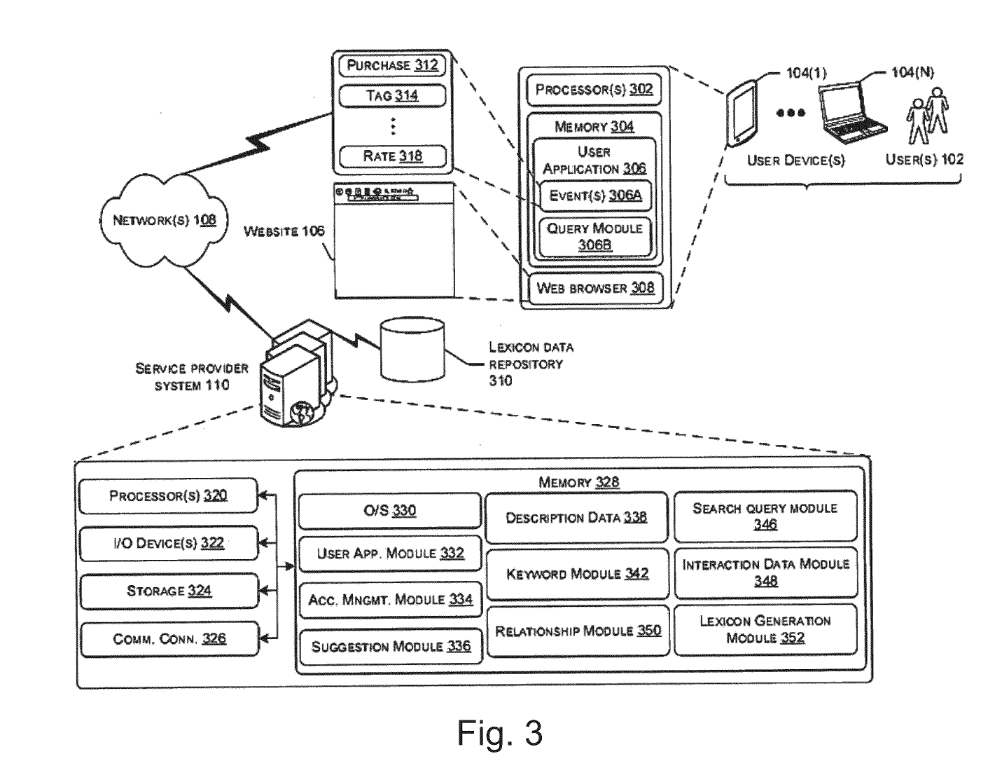

FIG. 3 depicts an illustrative system or architecture 300 in which techniques for providing suggestions based at least in part upon keyword analysis may be implemented. In architecture 300, one or more users 102 (e.g., account holders, guest users, etc.) may utilize user computing devices 104(1)-(N) (collectively, user devices 104) may interact and receive data from one or more search engine servers 110. In some examples, the networks 108 may include any one or a combination of multiple different types of networks, such as cable networks, the Internet, wireless networks, cellular networks, and other private and/or public networks.

Turning to the contents of the user device 104 may be configured with one or more processors 302 configured to execute machine-readable instructions. The processor 302 may include a central processing unit (CPU), a digital signal processing unit (DSP), a reduced-instruction set computer-processor (RISC), a complex-instruction set computer processor (CISC), a microprocessor, a microcontroller, a field-programmable gate-array (FPGA) or any such combination thereof. The processor 302, may be configured to execute program instructions or machine instructions that may be stored in a memory 304.

The memory 304 may be any computer-readable medium, coupled to the one or more processors 302, such as random access memory (“RAM”), read-only memory (“ROM”), and/or removable storage devices. The memory 2xx may store one or more program modules or program applications such as the user-application 306 and a web-browser 308. The memory 308 may store data files such as those related to a user's lexicon. The machine-readable storage medium may include, but is not limited to, hard drives, floppy diskettes, optical disks, CD-ROMs, DVDs, read-only memories (“ROMs”), random access memories (“RAMs”), EPROMs, EEPROMs, flash memory, magnetic or optical cards, solid-state memory devices, or other types of media/machine-readable medium suitable for storing electronic instructions.

Turning to the contents of the memory 304, the memory may be store a user-application 306 to facilitate the interaction with the service provider system 110. In some embodiments, the user application 306 may be a proprietary application known as the “Tool Rose.” The user application 306 may be a platform specific application such as that specifically designed for a mobile phone or a tablet computer platform. Further, the user application 306 may be an add-on or a modification of a web-browser application 308. Through the web-browser, the user may view or interact with one or more websites documents 106. The user application 306 may allow the user to provide context related to the website 106 to the service provider system 110. Further, the user application 306 may identify related web-sites through browsing patterns, clicking patterns. Further, the user application 306 may provide validation of other users's tags and lexicon.

For example, in some examples a user may just browse the website 106 for information acquisition. In other examples of websites that may provide user interaction data through the user application 306 may include any website that supports user interaction. These may include social networking sites, online retailers, informational sites, blog sites, search engine sites, news and entertainment sites, and so forth. Therefore, the user-related context data or context tags may include word tags, emotional identifiers, subject matter tags, location identifiers, negative identifier tags etc.

In addition to monitoring user provided tags, the user application 306 may provide interaction data and find related or associated users. In some examples, the website 106 may host a social networking platform for interacting with other users and/or sharing items. Based on these communication patterns or social networking connections, the user application 306 may determine related users in various contexts. For example, a user could be a social networking identifier connection. In other examples a related users could be related through similar browsing patterns, similar tagging patterns, and similar negative identifiers.

The service provider 110 may receive data indicative of the interaction between the website 106 and the user through the user application 306 to identify related users and also provide a shared lexicon among the related users.

Further turning to the user application 306, in some examples, a user 102 may log in or otherwise enter a session. The log-in may be based on receipt of log-in credentials such as a user identifier (“ID”) and/or a password. However, in some examples, the service provider may utilize cookies or some other state-verifying technique to determine that a user 102 is still logged in or was last logged in from the same computing device such as, but not limited to, user device 104. Alternatively, or in addition, a user 102 may maintain a session over multiple log-ins, using multiple different user devices 104, and/or over a period of time that may be longer than a typical web browser session. In some aspects, the events monitors 306A may be configured to keep track of actions, events, and/or occurrences associated with one or more session IDs, user IDs, web sessions, log-in sessions, and/or user accounts. As such, in some examples, the actions, events, and/or occurrences of a user 102 (or multiple users) may be transmitted to the service provider system 110. Examples of such events may include purchases 312, keyword tags 314, user ratings 318 and validations etc. The service provider 110 may utilize these events to identify additional related content and make suggestions or recommendations to the user. The events monitor 306A may contain a user interaction module to enable a user to set security settings.

Further turning to the contents of the memory 304, the query module 306B may be utilized for a user-query utilizing the user application 306. In one example, the user may utilize data files such as a user-specific lexicon and context related to certain websites. The user may input a list of search parameters or query parameters that may include keywords. Further, during the search query, the user application 306 may transmit either the user-specific lexicon or a unique identifier associated with the user-specific lexicon to the service provider system 110.

In one non-limiting example, a user 102 may access a website 106 in conjunction with a user application 306 on one of the user devices 104. While accessing this website 106, the user may enter a query involving keywords to a service provider system 110. The user 102 may be presented with a graphical user interface (“GUI”)th may be configured to display one or more query results. Further, the user may receive one or more recommendations related to other search terms, or other related websites that may not be directly provided by the query.

In another non-limiting example, a user 102 may input an image into the query module 306B. The service provider system 110 may receive the image, identify context related to the image and output other images or other data in relation to the image.

Now, turning to the contents of the service provider system 110. The service provider system 110 may include any type of computing devices such as, but not limited to, mobile, desktop, thin-client, server, and/or cloud computing devices. In operation, service provider system 110 may be configured to execute computer-executable instructions in order to form a special-purpose computer or particular machine that facilitates context-based information acquisition. Operations for providing context may be relationship analysis, graphing, keyword analysis, and/or suggestion services. In some examples, the service provider computers 110 may be in communication with one or more users devices, other service provider systems, social networking systems etc. via the networks 108, or via other network connections. In certain embodiments, the service provider system 110 may include one or more servers, perhaps arranged in a cluster, as a server farm, or as individual servers not associated with one another. These servers may be configured to host, receive, store, and/or process information acquisition, file sharing, lexicon sharing, information crawling, relational tagging and other such services based on requests from the one or more service provider computers 110. Additionally, in some aspects, various services may be separate and distinct from one another and may also be provided through the user of one or more user devices 104 in relation to the user application 306. For example, if a user belongs to a particular user group that may have a shared lexicon in relation to certain websites, this shared lexicon may be stored in any of those user devices.

In one illustrative configuration, the service provider system 110 may include at least one memory 328 and one or more processing units (or processor(s)) 320. In some examples, the processor(s) 320 may be implemented as appropriate in hardware, software, firmware, or combinations thereof. Various implementations of the processor 320 may include computer-executable or machine-executable instructions written in any suitable programming language to perform the various functions described. The processor 320 may include a central processing unit (CPU), a digital signal processing unit (DSP), a reduced-instruction set computer-processor (RISC), a complex-instruction set computer processor (CISC), a microprocessor, a microcontroller, a field-programmable gate-array (FPGA) or any such combination thereof. The processor 320 may be configured to execute program instructions or machine instructions that may be stored in a memory 328.

The memory 328 may store program instructions that are loadable and executable on the processors) 320 as well as data generated during the execution of these programs. Depending on the configuration the memory 328 may be volatile (such as random access memory (“RAM”)) and/or non-volatile (such as read-only memory (“ROM”), flash memory, etc.). The service provider system 110 may also include additional storage 324, which may include removable storage and/or non-removable storage. The additional storage 324 may include, but is not limited to, magnetic storage, optical disks, and/or tape storage. The disk drives and their associated computer-readable media may provide non-volatile storage of computer-readable instructions, data structures, program modules, and other data for the computing devices. In some implementations, the memory 122 may include multiple different types of memory, such as static random access memory (“SRAM”), dynamic random access memory (“DRAM”), or ROM.

Further, the service provider system 110 may contain one or more databases known as the lexicon repository database 310. This may contain various tags, web-crawled websites, file-sharing, images, videos among other things. Further, the lexicon repository 310 may be remotely hosted or stored locally.

The memory 328 and the additional storage 324, both removable and non-removable, are all examples of computer-readable storage media. For example, computer-readable storage media may include volatile and non-volatile, removable and non-removable media implemented in any method or technology for storage of information such as computer-readable instructions, data structures, program modules, or other data. The memory 328 and the additional storage 324 are all examples of computer storage media.

The service provider system 110 may also contain communications connection(s) 328 to communicate with stored databases, other computing devices or servers, user terminals, and/or other devices on the networks 108. The service provider system 110 may also include input/output (“I/O”) device(s) 322, such as a keyboard, a mouse, a pen, a voice input device, a touch input device, a display, speakers, a printer, etc.

Turning to the contents of the memory 328 in more detail, the memory 328 may include a wide variety of description data 338 and/or other stored data (e.g., data files, profile information, etc.), an operating system (“OS”) 133, and one or more application programs or services for implementing the features disclosed herein.

The description data 338 may include a wide variety of data associated with any number of data tag information, emotional identifiers, descriptors, restrictions, negative restrictions etc. item review information, item rating information, user profile information, etc. In addition to storing description data 338, in certain embodiments, historical information associated with events, actions, and/or other user interactions with various items may be stored. Indeed, a wide variety of information associated with items may be stored in the memory 328. The OS 330 may include one or more suitable applications and/or program modules that facilitate the general operation of the service provider computer 110, as well as the execution of one or more of the additional application programs.

The memory 328 may also include a keyword module 342, which may include any number of suitable applications and/or modules configured to perform keyword analysis on data and website documents. In operation, the keyword module 342 may identify an item or a group of related topics for purposes of performing a keyword analysis. A wide variety of suitable techniques may be utilized to identify a group of related websites or documents. As one example, one or more websites 106 associated with user events (e.g., selections, clicks, views, ratings, purchases, reviews, etc.) may be identified during a session or across multiple sessions. In certain embodiments, the websites may be identified based upon the utilization of a filtering technique. As another example of identifying a group of related websites, a graph or a subset of a generated graph (e.g., a content based graph, a collaborative filtering graph, a hybrid graph, etc.) may be identified. In certain embodiments, multiple groups or clusters of related websites may be identified from a generated graph. As yet another example of identifying a relevant websites, a new website to be added to an existing tag or lexicon.

Further, the above mentioned techniques utilized by the keyword module 342 may also be utilized to identify similar users or user relationships. The keyword module 342 may identify a group or related users, based on associated user events and associated user-provided tags.

Once one or more groups of related websites have been identified, respective description data 132 or lexicon data associated with each of the websites may be accessed from memory 328 or obtained from any number of data sources or other components of the architecture 100. Any number of suitable information extraction techniques and/or evaluation techniques, such as latent semantic analysis (“LSA”), heuristic information extraction algorithms (e.g., a term frequency-inverse document frequency (“TF-IDF”) analysis, etc.) and/or data-driven information extraction algorithms, may then be utilized to evaluate the description information 338 or the related tag data, n certain embodiments, one or more terms and/or phrases included in the description data 132 for a website or in relation to a user group may be weighted for purposes of determining keywords for the item. Additionally, one or more identifiers may be located and utilized to identify certain words and/or phrases to be weighted. For example, when evaluating a movie, terms and/or phrases that specify a genre for the movie may be weighted. Similarly, when evaluating an apparel item, terms and/or phrases that specify, define, or describe a style for the item may be weighted. Additionally, in certain embodiments, certain terms that commonly appear in the description data 132, such as “a,” “the,” and/or other relatively common terms, may be filtered from the keyword identification analysis.

Additionally, one or more respective lists of common keywords that are representative of each of the groups of related items may be determined. Any number of suitable evaluation techniques, such as a TF-IDF analysis and/or other suitable information extraction and/or evaluation techniques (e.g., heuristic information extraction algorithms, data-driven information extraction algorithms, etc.), may be utilized to determine a list of common keywords for a group. In certain embodiments, shared keywords between the various websites included in a group may be identified. For example, a list of keywords for each website in a group may be compared in order to determine a list of common keywords for the group. In other embodiments, description data 338 for multiple websites may be evaluated utilizing a TF-IDF analysis (or other suitable analysis) in order to identify keywords that are shared across the various users of the group. As desired, certain terms in the description data 338 for the items may be weighted during the analysis. Additionally, in certain embodiments, commonly appearing terms may be filtered from the analysis.

An example TF-IDF analysis may determine a number of times that various terms appear in description data 338 for a website identified by a particular user-group. A term frequency may be determined from the number of times that a term appears compared to a total number of terms in a document For example, if a particular term appear three times in a 100 word document, then the term frequency may be calculated as (3/100) or 0.03. Additionally, the TF-IDF analysis may determine a number of documents (e.g., description documents for various items) in which various terms appear. An inverse document frequency may be calculated from the number of documents in which a term appears. For example, if a term appears in 10 out of 250 documents, then the inverse document frequency may be determined as the log (250/10) or approximately 1.4. A TF-IDF score for a term may then be determined based upon the term frequency and the inverse document frequency. Utilizing the example above, a TF-IDF score for a term may be calculated as the product of the term frequency and the inverse document frequency. In other words, a TF-IDF score of 0.042 may be determined for a term. In certain embodiments, TF-IDF scores may be evaluated in order to determine or identify common keywords or terms that are representative of a group of items.

These keywords that may be analyzed may be either “system tags” or “user-group tags.” These may be weighted accordingly based on the context of the search or information acquisition.

Once a list of common keywords has been determined or identified for a group of related websites, or users, the list of common keywords or also known as a lexicon may be utilized to generate or make a wide variety of different types of suggestions, such as clustering suggestions, suggestions for topics associated with the websites, items, and/or recommendations of similar websites.

With continued reference to FIG. 3, the memory 328 may also include a suggestion module 336. In some aspects, the suggestion module 336 may be configured to provide suggestions and/or recommendations for users (e.g., a suggestion of a number of topics to use for a clustering analysis, etc.) and/or to a user 102 based on actions or events (e.g., based on viewing, rating, purchasing, etc.) associated with their internet browsing and communication patterns. In certain embodiments, the suggestion module 336 may be configured to generate suggestion based at least in part upon identified keywords tags or a similar lexicon. As desired, the suggestion module 336 may also utilize a purchase history or other historical information during the generation of suggestion. For example, the suggestion module 336 may be configured to provide a suggestion (i.e., a list of similar items, a topic that the user 102 may be interested in, etc.) to a user 102 in response to an action or event In other examples, the suggestion may be a general suggestion based on habits, likes, or past purchases, or other historical and/or aggregated information regarding the user 102.

A wide variety of different types of suggestion may be generated as desired by the suggestion module 336. In certain embodiments, the suggestion module 336 may evaluate respective lists of common keywords associated with various groups of items in order to determine a number of topics to be utilized for a clustering technique, such as an LDA analysis, a canopy clustering technique, a hierarchical clustering technique (agglomerative, divisive, etc.), a centroid-based clustering technique (e.g., k-means clustering, etc.), a distribution-based clustering technique (e.g., Gaussian distribution, etc.), a density-based clustering technique (e.g., density-based spatial clustering of applications with noise (“DBSCAN”), ordering points to identify the clustering structure (“OPTICS”), etc.), a deterministic annealing clustering technique, etc. For example, a graph (e.g., a collaborative filtering graph, etc.) may be evaluated in order to determine various subsets or clusters included in the graph. Respective common lexicon may then be determined for each of the subsets or user groups. A total number of identified common keywords may then be calculated across all of the subsets or all users based on overall usage or tagging patterns. The total number of keywords may then be utilized to determine a number of topics, groups, or centers to be evaluated during the performance of a latent Dirichlet allocation (“LDA”) or other suitable clustering technique. For example, a number of LDA topics for evaluating and forming clusters associated with an electronic catalog may be determined.

For example, if a user were browsing an electronic shopping site, as an example of generating a suggestion, an evaluation of keywords may be utilized to make suggestion and/or recommendations associated with new items, such as new items to be added to an electronic catalog. For example, a description for a new item may be evaluated in order to determine keywords associated with the new item. The keywords for the new item may then be compared to respective lists of keywords associated with various groups of items (e.g., subsets of a graph, etc.) included in the electronic catalog. Based upon determined correspondences and/or similarities between the keywords for the new item and the keywords associated with other items, one or more topics and/or categories that best fit the new item may be determined. Suggestions and/or recommendations may then be made based at least in part upon the determined topics and/or categories. In this regard, suggestions and/or recommendations may be made for new items without waiting to collect historical information (e.g., viewing information, rating information, purchase information, etc.) associated with the new items. Other types of suggestion may be generated by the suggestion module 138 as desired. The described suggestion is provided by way of example only.

Further turning to the contents of the memory, an interaction data acquisition module 348 may be configured to receive various events from the event module 306A from the user device 104 is configured to acquire the interaction data 218. The interaction data acquisition module 248 may be a stand-alone module or have functionality incorporated into other modules. The interaction data acquisition module 348 may retrieve interaction data 218 from other modules, devices, and so forth, or may generate interaction data. Interaction data 218 may include communication interactions between users 104, social networking interactions, similar interests and group memberships. The interaction module 348 may analyze the interaction data and provide a context for the lexicon and the propagation of the lexicon to the users.

A relationship module 350 is configured to access interaction information 218. The relationship module 350 may determine relationship data associated with users 104. As used herein, “related” and “relationship” indicate an affiliation between two or more parties. This affiliation may be legal (such as married spouses), filial (such as siblings), organizational (such as being members of the same club), professional, friendly, and so forth. Relationships may be defined by frequency of contact, context of contact, duration of contact, or more. Relationships may be thus connections between users 104 which are of some particular significance to the participants. For example, a user 104 may attribute much greater significance to a recommendation from a friend of many years than from a stranger on the street. Relationships may also be dynamic and change over time.

The relationship module 350 may determine relationships through explicit inputs, such as entries within a social network, manual entry by the user, and so forth. For example, a user 104 may enter user data about other members of the household and indicate the relationship such as spouse, child, parent, roommate, and so forth. In some implementations, this data may be derived or included as part of the user data that the user 104 may provide during interaction with a merchant, another users or utilization of the user application 306. For example, the user 104 may set up an account with an online merchant and indicate that spouse user 104 has equal rights to make account changes, to make purchases, and so forth while child users 104 and 104 may only add items to a suggested shopping or wish list Using this information, the relationships between these users as members of a family may be determined.

The relationship module 350 may also build relationship data using interaction data 218. An interaction between two or more users may be used to establish a relationship. For example, user 104 may share information about a particular product, topic or webpage document with user 104. This act of sharing may establish a relationship. The relationship may be strengthened by the first user 104 replying back to the second user 104.

A lexicon generation module 352 is stored in the memory 328 and is configured to identify and associate user-defined lexicon. The lexicon generation module 352 is configured to access interaction data 218 comprising interactions between one or more users 104 and one or more webpages or documents. For example, data about interactions associated with a particular topic or subject may be accessed. The lexicon generation module 352 determines a relationship between the one or more users and a target user 104. For example, the target user 104(1) is friends with users 104(2), 104(3), and 104(4). Lexicon data is determined based at least in part on the interaction data 218 and the determined relationship(s) with the target user. Continuing the example, interactions such as users 104(2), 104(3), and 104(4) posting comments on a particular.

Further turning to the contents of the memory, based on receiving and identifying the keywords, the service provider system 110 may be configured to storing a wide various of information may store a variety of information such as that described below. The repository 310 may store user data 214 about the users 104 including one or more of user identifications, lexicon preferences, privacy settings, social network data, and so forth. This user data 214 may include relationship data, such as connections within a social network, user affiliations, user-group preferences, location information and so forth.

The user-defined lexicon data 216 may be stored. This may include semantic data 216(1), negative filter data 216(2), ratings data 216(3), or a combination thereof. The semantic data 216(1) may include a special designation, definitions, identification, mark, term, symbol, text, sound, image or other multimedia. The semantic data 216(1) may identify one or more terms and associations for search results. The negative filter data may also include exclusionary information regarding special designations, definitions, identification, mark, term, symbol, text, sound image or other multimedia. The ratings data 216(3) may include descriptions, characteristics, rankings, terms of use, and so forth.

Interaction data 218 may be stored in the repository 310. The interaction data 218 describes one or more interactions of one or more users 104 involving one or more of social networks or group affiliations. These interactions may include, but are not limited to, inquiries, page views, purchases, shares, replies, messages, recommendations, blog entries, or a combination thereof associated with the one or more users. For example, the user 104(1) may be presented with a specific search term, click on a website in relation to the term, and proceed to view the website. The user 104(1) may then activate a command to share that website with user 104(2) who is related to the user 104(1), generating an interaction between users 104(1), 104(2), and the website in relation to the specific term. In one implementation, the interaction data 218 may comprise a message entered by one of the one or more users 104.

The lexicon data 216 may adjusted based on a relationship marking or a relationship counter. The relationship detail may identify that the target user 104 is having at least a portion of the interaction with a subset of available users. Continuing the example, at least a portion of the comments posted by related users 104(2), 104(3), and 104(4) may be presented. The relationship counter may indicate a number of interactions, such as messages, associated with the consumer object from related users. The relationship counter may comprise a numeric representation of a value indicative of the strength of the relationship. Further, for a user, the relationship counter may be increased or decreased based on a trust criteria. In other implementations non-numeric representations may be used. In one example, the relationship interactions may be symbolized by colors or temperatures ranging from “hot to cold”, and these may be used a filter with regards to the specific lexicon data. In some implementations, the lexicon data may be filtered based on interactions associated with particular users 104 or groups of users.

In another implementation, the lexicon data 216 may be filtered to remove interactions which have aged beyond a pre-determined amount For example, the relationship counter may be configured to count interactions which are less than two weeks old. As a result older interactions may be omitted from the count.

Further turning to the contents of the memory 328, the search query module 346 may be facilitated to provide results of relevant webpages 106 or documents to a user. The search query module 346 may utilize data files from the repository, or alternatively retrieve data from the user application of the particular user 306 or related users. The lexicon data may provide various semantic tags 216 to identify the webpage documents. For example, lexicon data may location information for a user, tags indicating keywords, terms of arts, industry specific jargon, identifying visual information and audio information. Are examples of user-defined lexicon data 216 that may be utilized to identify and return queries based on user-specific lexicon. The lexicon data may be stored in advance in the query request.

Further referring to the search query module 346, it may receive a list of search parameters or query parameters input by a user seeking documents. These search or query parameters may include, but is not limited to keywords, restrictions, negative identifiers or limitations, ratings etc. The search priorities may prioritize the results based on different parameters in the order of preference by the user for example.

In one illustrative example, if a user has a negative filter set for particular types of emotions or words, the negative filter may restrict all or a portion of the documents with tags that are identified by these filters.

The search query module 346 may provide contextual matching of the search parameters with the lexicon data and identify a list of webpage documents that satisfy these search parameters on the lexicon data. These identified web page documents may be transmitted or outputted for display to the user device. The search query module 228 may output to display the web pages satisfying search or query parameters inputted by the user, the presentation may further identify a rating, an expert, additional tags, emotions or negative emotions.

Further turning to the contents of the memory, in some examples, the account management module 334 may be configured to maintain, or otherwise store, account information associated with one or more requested accounts. The account information may include account holder information, a user ID, a password, acceptable answers to challenge questions, etc. In this regard, users 102 may be authenticated when accessing and/or utilizing the website.

Additionally, during operation, the user application module 332 may collect and/or track information associated with various user events and/or actions (e.g., clicks, reviews, ratings, etc.) associated with items. In certain embodiments, the collected information may be stored in memory 328 and/or any number of suitable databases for subsequent evaluation by the service provider computers 110.

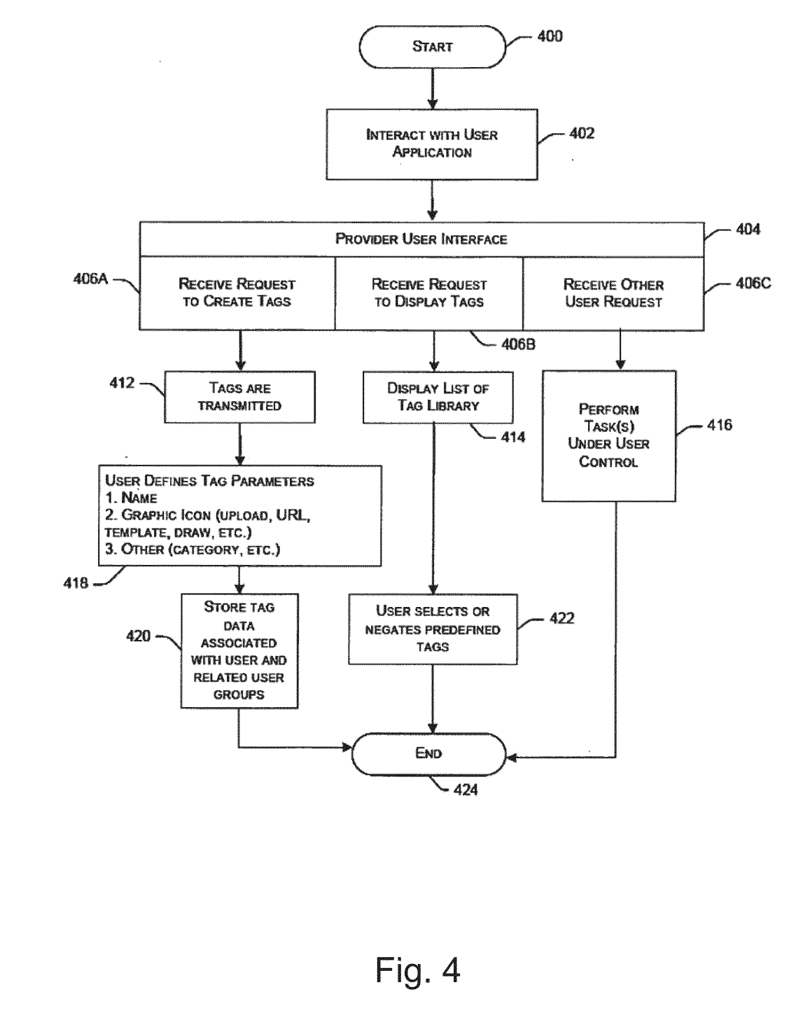

FIG. 4 is a representative method flowchart featuring the steps of creating user defined tags for a lexicon.

In operation 402, a user may utilize the user application 306 and the associated GUI with the user application to provide an interaction to create user-defined lexicons or a user-specific tagging.

In operation 404, a user is provided with a user interface to create tags. For example, a keyboard bar or a search bar may extend from the user application.

In alternative embodiments, the user can request to create tags (operation 406A), or request to display predefined tags (406B), or request other tasks 406(C).

If in operation 406, the user opts to create a user-defined customized tag, a GUI associated with the user application 306 enables the user to create customized tags in operation 412.

In operation 418, the user may further by defining the tag parameters 118, e.g. a name, a graphic icon, a category, etc. Once the customized tags are defined, the tag data can be stored and associated with the creator (user), user groups or everyone for future use based on verification and ranking.

If however, in operation 406, the user instead chooses to display the list of tag library, then in operation 414, the tag library may be imported from other lexicons. For example, if there is another user that is related to this user, or a common user group, common click patterns among other things. In operation 414, the user-application may render a GUI shows predefined tags for the user to browse.

In operation 422, the user can select tags among the predefined tags displayed 122, or opt to create customized tags 412 if he does not want to use the predefined tags. In addition to selecting a predefined tag a user can negate a predefined tag 422. For example many websites may utilize or generate tags that do not directly relate to the content provided on the website to increase their rankings and display in a convention heuristic based search engine. For example, a website may utilize hidden text with commonly searched keywords. For example, an independent politically active group who dislike a particular candidate “Rick”, they may create websites about “donkeys” and utilize hidden text with the word “Rick.” Therefore, in a search for the word “Rick” a website for “donkeys” may appear. To combat this issue, a user may provide negative tags and these negative tags may be associated with a user group or with the general lexicon.

If the user has chosen to request other tasks 110 from the provider GUI 104, he can perform the tasks 416 and end the session 424.

[Include Standard Disclaimer Text]

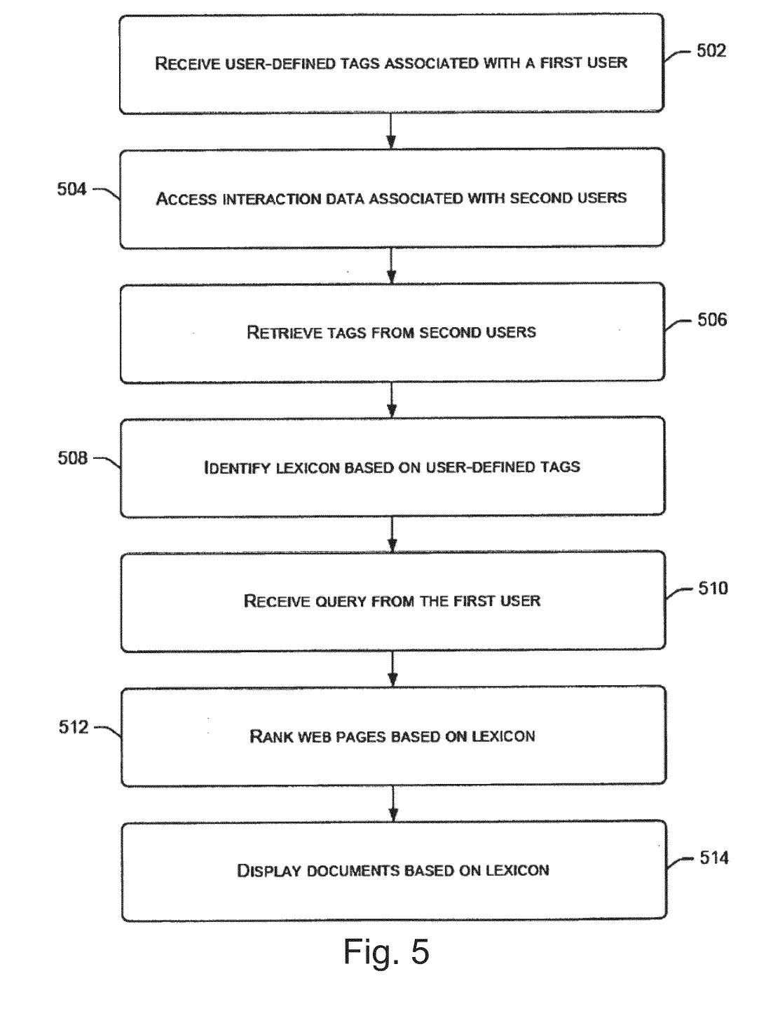

FIG. 5 is an example method for a user-based context dependent search engine.

In block 502, the service provider system 110 may receive tags or other user-defined personalization for documents, content for the corpus. The content may include multimedia information, textual information, audio information, image information, video information, or the like, computer programs, scripts, games, logic, or the like. The tags may identify a specific context associated with the documents or webpages. For example, the tags may identify specific keywords, location-based information, links to other documents, data files etc. In block 504, interaction data associated with the user may be identified, o more links between the one or more tags and tag associated information (TAI) are generated. A link can include one or more relationships between a user-specific tag and TAI. In some embodiment, an interaction data may include or be represented by one or more static relationships. In further embodiments, the one or more links identifying relationships between the one or more tags and the tag associated information may have dynamic relationships. For example, if a tag is associated within a user-group, the tag may be less relevant to people outside the user group, therefore, the relationship to the document with the tag may be diminished.

In block 358, a lexicon may be generated based on the tags. For example, the lexicon may be generated to associate a portion of the interaction data, with keyword terminology and tags. Further, certain images and emotions may also be identified and used.

The lexicon may be encoded for access and transmission. The encoding may be in XML or other mark-up languages to identify certain user-specific tags, lexicon, user-groups, images etc. For example, the lexicon data may include a video data in relations to certain documents for increased relevancy to the user.

In block 510, the search engine server may receive a query from a user for information using certain keywords. The query may be either for a topic, an image, a recommendation on a restaurant etc. The user may also send optional preferences and parameters in the query.

In block 512, the documents may be ranked based on the lexicon for the user and the user-related preferences. The highest ranking webpages may be selected is selected, as this maybe the webpage documents that would be most suitable for the users' query.

At operation 514, the highest ranking websites is presented to the user. It may be presented either on the user device. The total number of websites presented to the user may vary based on the size of the users' browser screen and preferences.

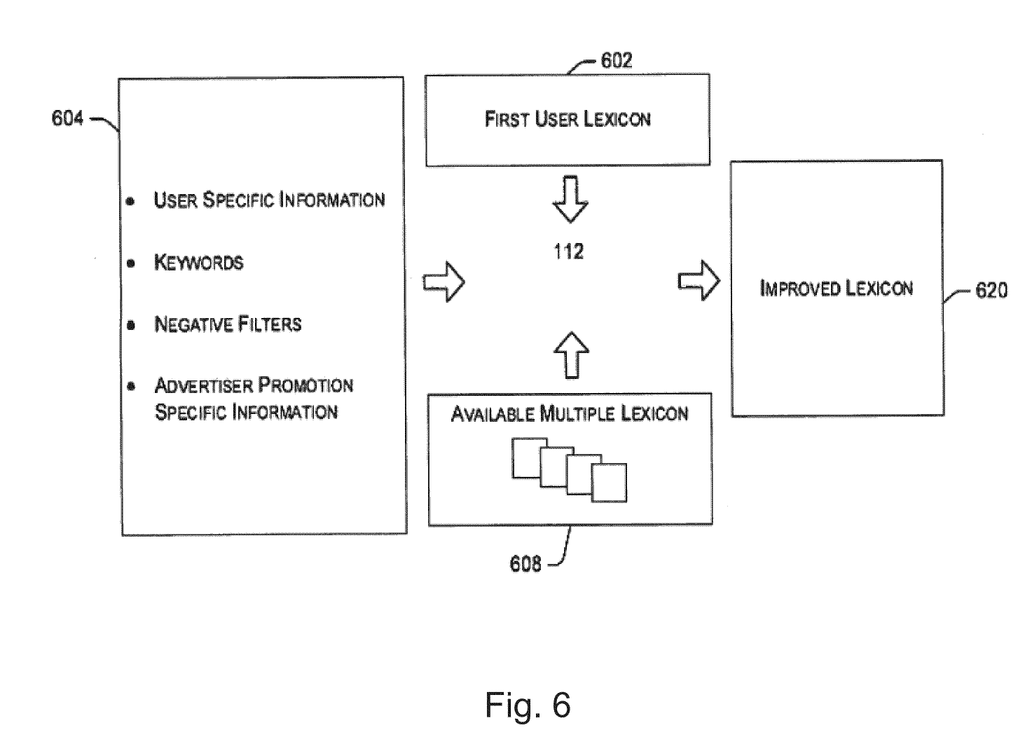

FIG. 6 illustrates a block diagram of an example data flow 600 for generating a lexicon, in accordance with embodiments of the disclosure. With reference to FIG. 6 a first user's lexicon content 602 may be identified for inclusion in a particular document or subject For example, lexicon may be identified the service provider system 110 as illustrated in FIG. 3. As another example, lexicon's content may be identified by an input transmitted by a user device 104.

Additionally, a wide variety of information 604 may be identified and evaluated in order to determine additional lexicon to be incorporated in reference to a documents or a group of documents. Examples of information that may be evaluated include, but are not limited to, user specific information (user profile data, user emotion, user ratings, user-preferences, etc.). If it involves a product, service, or other item information (e.g., pricing information associated with an item, rating information, review information, item variation information, etc.), associated content specific information (e.g., content presented via a website, complementary product information, etc.).

Based upon an evaluation of at least a portion of the information 604, available multiple related lexicons 608 may be determined, selected, and/or generated for incorporation into context specific lexicons for either the document or for the users. The multiple user lexicons 608 may then be combined with the first lexicon 602 in order to generate a thorough lexicon. In other examples, if a user may decide to use a negative filter on a particular user group or content provided by certain user groups. For example, if someone was searching for “recipes” and the person were vegetarian, she might have negative filters from recipes from the American Beef Association etc. Therefore, when she searches for recipe, the lexicon is specifically subtracted from search terms.

Improved lexicon 620 with both filters and additions may be created. This lexicon may be user-specific, subject-specific, document, specific or document group specific.

As desired in various embodiments, a wide variety of variations may be made to the data flow 400 illustrated in FIG. 6. For example, other criteria and/or information may be evaluated out of order or combined with other methods The data flow 600 illustrated in FIG. 6 is provided by way of example only.

Illustrative Processes

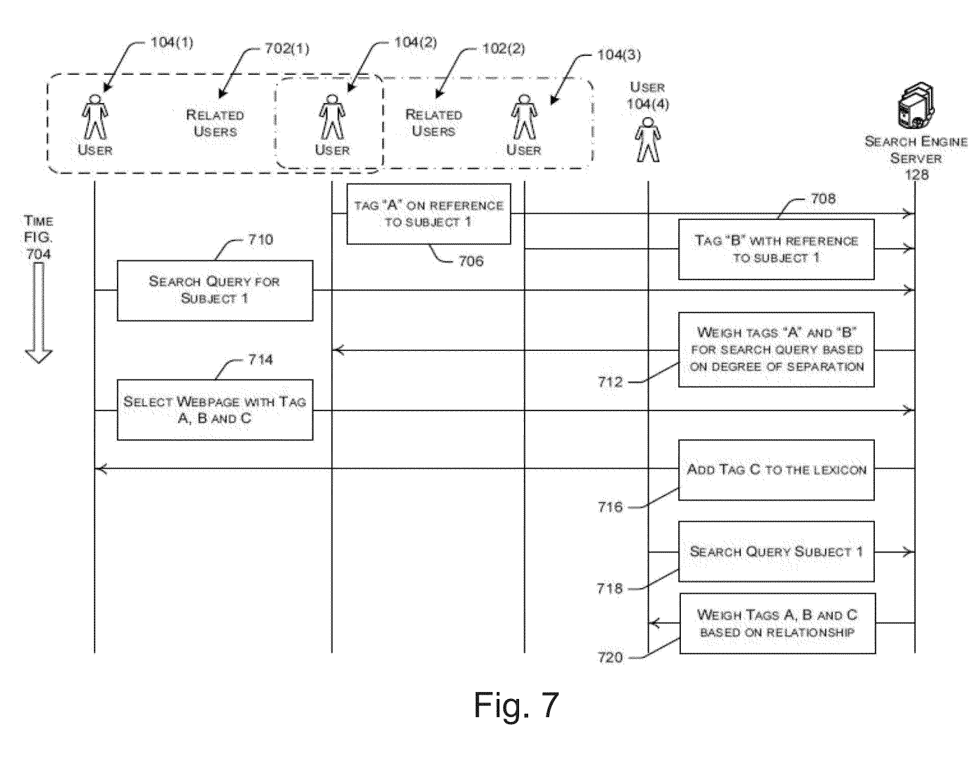

FIG. 7 illustrates a communication flow diagram 700 of several interactions between users 104 and the service provider system 110. By way of illustration, and not by way of limitation, four users are depicted 104(1)-104(4) having associated user devices 104 (not shown) as well as the search engine server 128. The communications may be transported by the network 108. In this illustration, the relationship module 350 has determined that users 104(1) and 104(2) are related to one another. The relationship module 350 has also determined that user 104(2) is also related to 104(3). User 104(4) is unrelated to users 104(1)-104(3). In this diagram, time increases along the direction of arrow 704.

At operation 706, a user 104(2) “Alice” communicates with the service provider system 110 to provide a tag “A” on a subject 1. For example, Alice may be commenting on the subject 1 utilizing tag A. This comment may be addressed to a particular group of users 104, or may be available to all.

At operation 708, a user 104(3)” Bob” communicates with the search engine server 128 to provide tag “B” about the subject 1. Continuing the example, Bob 104(3) may be identifying an image with relation to the subject 1. As above, this comment may be addressed to a particular group of users 104, or may be available to all.

At 710, a user 104(1) “Carol” requests information about subject 1 from the search engine server 128, or from another server in communication with the service provider system 110 or the user.

At operation 712, at least partly in response to the request, the service provider system 110 provides weighs tags A and B in relation to the degrees of separation. For example, Alice is directly connected to Carol. However, Bob is separated by Carol with two degrees. In this example, the search engine may weigh Alice's tags more heavily than Bob's tags because of the degree of separation.

At operation 714, the user 104(2) may provide to the search engine server 110 an additional comment “C” on the consumer object For example, the user 104(2) may view a personal tag from another user and add personal experience with regard to the tag.

At operation 716, the service provider system 110 provides interaction data comprising the additional comment “C” to the users 104(1) and 104(3). This may be in response to a request by the users 104(1) and 104(3), or may have been pushed or sent without query to the user devices 102 associated with the users 104(1) and 104(3). The user 104(2) does not see a social marker 124 associated with this comment because it originated with user 104(2).

At 718, an unrelated user “Esha” may request information about the subject 1 from the service provider system or another server. Because the user is unrelated, the comments and interaction data may not be as relevant as it is for Alice, Bob and Carol.

At 720, the service provider system 110 may weigh the tags for A, B, C for the user Esha 104(4). Because the Esha user 104(4) is unrelated to user Alice, Bob or Carol, the lexicon may be filtered or otherwise weighted to account for the non-relationships of these entities. The lexicon or other interaction data 218 associated with the query may be available to the unrelated user “Esha” 104(4). For example, the user “Esha” 104(4) may view detail information about the topic of subject 1 which may include the comments “A,” “B,” and “C,” recommendations from the users, and so forth. However, because no relationship exists between users 104(1)-104(3) and the user 104(4), the search results may be significantly different for “Esha” 104(4).

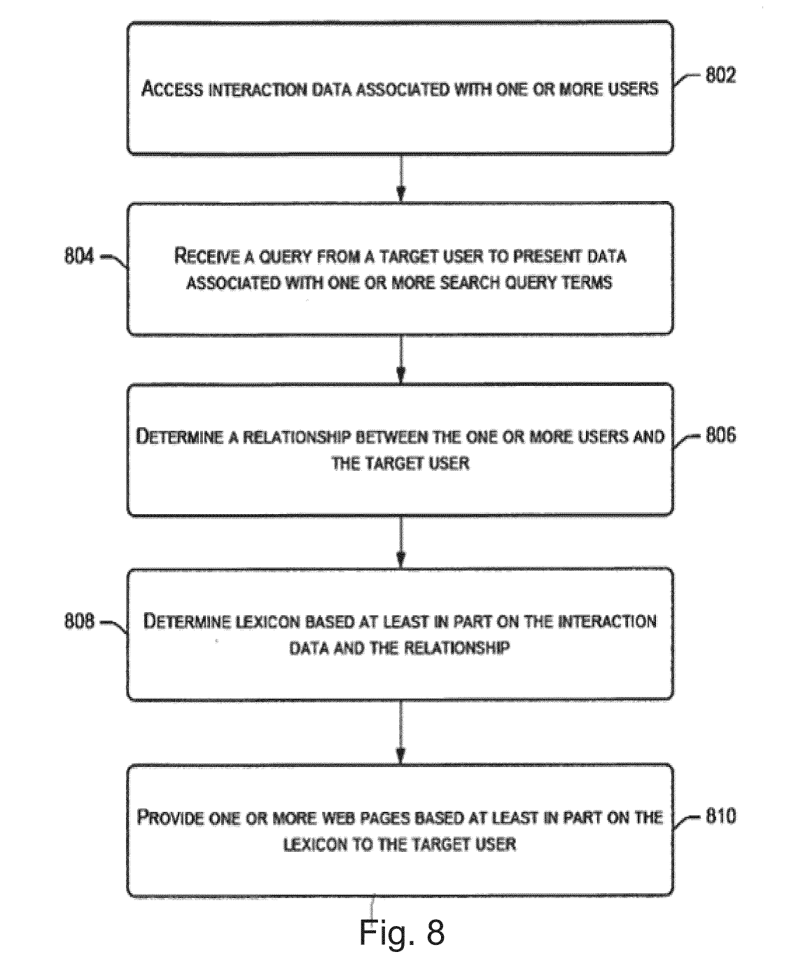

FIG. 8 illustrates a flow diagram 600 of a process of generating a lexicon based on interaction data. The process may be performed at least in part by the user device 104, the service provider system 110, another device, or a combination thereof.

At operation block 802 accesses interaction data 218 associated with one or more users devices 104(U). As described above, this interaction data 218 may comprise inquiries, page views, purchases, shares, replies, messages, recommendations, blog entries, or a combination thereof associated with the one or more topics which may be that the user device 104(11) has previously commented on a particular topic, website or document.

At operation block 804 receives a query from a target user device 104(1) to wherein the query contains terms associated with the interaction data 218. The terms may be terms or art or specific terms related to a topic or a subject raised during an interaction between users.

At operation block 806 determines a relationship between the one or more users 104(U) and the target user device 104(1). As described above the lexicon generation module 352 may retrieve relationship information from the user data 214 or generated by the relationship module 350. Continuing the example, the target user 104(1) may be determined to be friends with the user 104(11). The target user 104(1) may be identified by receiving login credentials, inspecting a cookie associated with an Internet browser, from biometric data, and so forth.

At operation 808 determines lexicon data based at least in part on the interaction data 218 and the relationship. As described above with respect to the lexicon generation module 352 in this example, this determination may utilize the comment made by the user devices 04(11), the target user's device 104(1) query, and the relationship between users 104(1) and 104(11).

At block 810 provides lexicons based at least in part on the interaction and relationship analysis to the target user 104(1). For example, the search engine server 128 may send to the user device 102 the lexicon which the user device 102 may then identify as the users's specific lexicon during a search query.

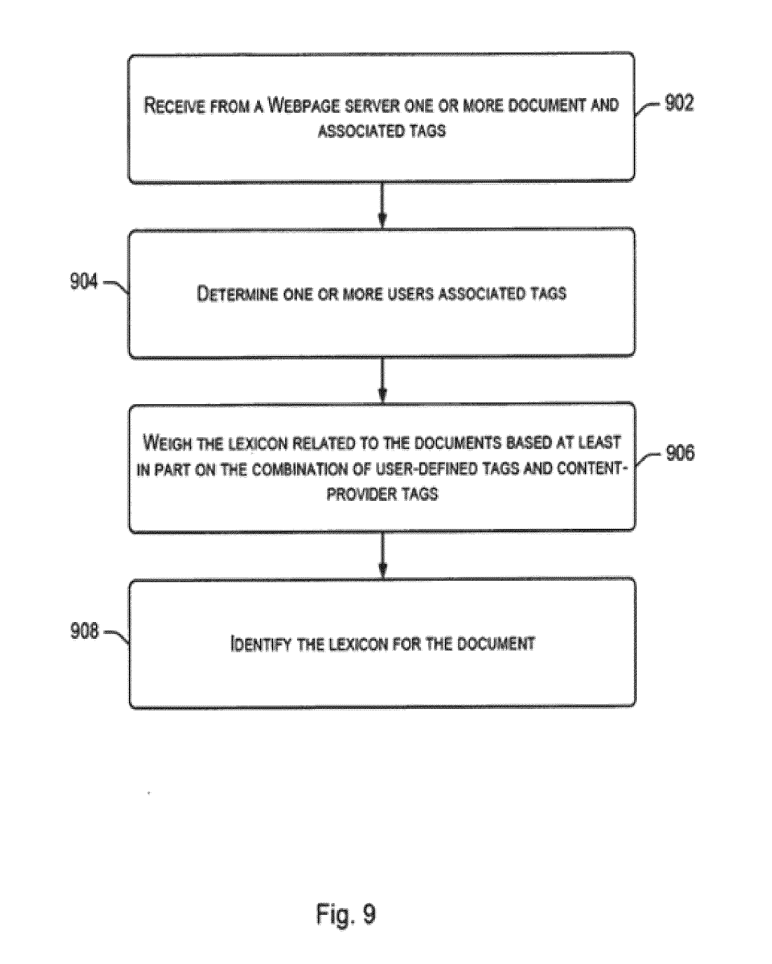

FIG. 9 illustrates a flow diagram 700 of a tagging or identifying the website content.

Block 902 receives from a website documents associated with the website. The entity may comprise an individual, a company, a group of companies, a marketing cooperative, and so forth. The documents may include, but is not limited to, text, sound, graphic, video, or a combination thereof. For example, the documents may be text and a link associated with other relevant documents. The documents may be transmitted with content provider tags that may identify the context and describe various human-related semantic knowledge of the documents.

Block 904 determines one or more user-tags associated with the documents. In some implementations, this determination may be based at least in part on the interaction data 218. In other examples, the users may provide or identify the documents with certain context or semantic meanings or lexicon.

Block 906 generates lexicon that may be weighted based on the content-provider tags and the user-provided tags. For example, if many users across many community groups, with various interaction data provide certain tags, these tags may be receive a significant weight in comparison to the tags received by the content provider. For example, content providers may utilize certain tags to ensure that their websites are produced as the top listing for many web queries. Therefore, in order to maintain the integrity of the search results, the user-provided tags may be given greater weight if there is a significant different.

However, in other examples, if the user-provided tags is in agreement with the content provider tags, there may be a different weighing criteria in determining if these tags are relevant to the lexicon for the documents.

Block 908 associates the lexicon to the documents. Therefore, upon a query, the lexicon associated with the document may be utilized for identifying a relevance to a query.

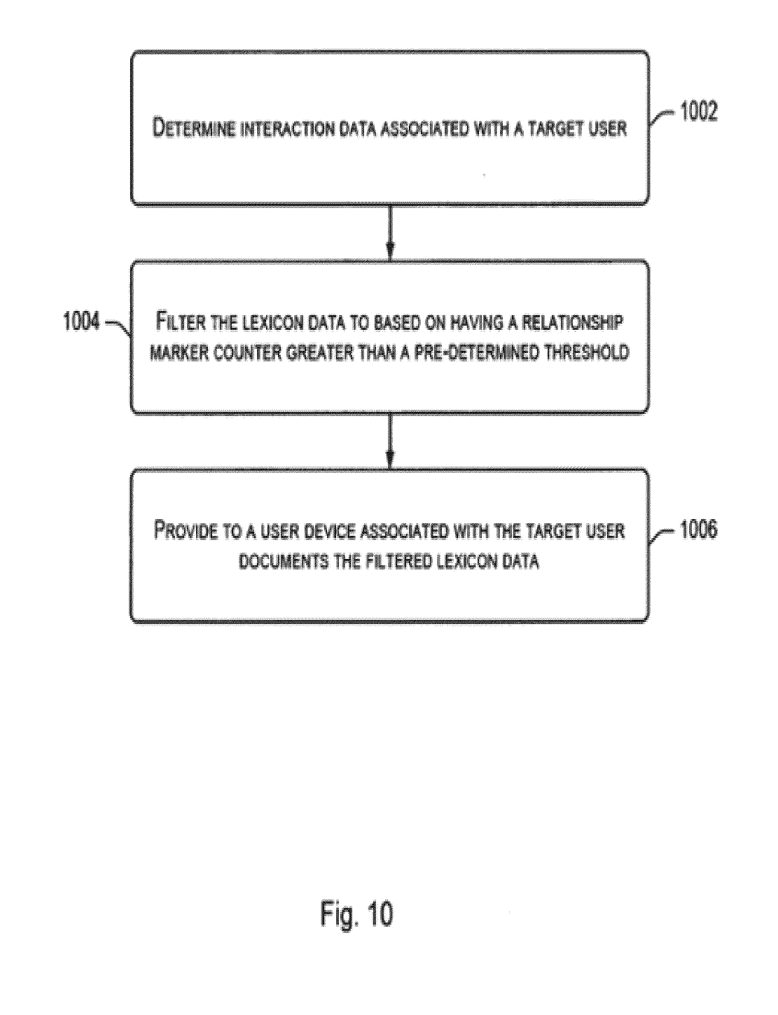

FIG. 10 illustrates a flow diagram 1000 of a process of providing a search engine query. The process may be performed at least in part by the user device 105, the service provider system another device, or a combination thereof.

In block 1002, the service provider system 110 may determine the interaction data based at least in part on the relationship with the target user and one or more other users. The relationship may be based on degrees of separation in a social network. The relationship may be further based on location, or interaction.

Block 1004 filters the lexicon to select data or tags having a relationship counter greater than a pre-determined threshold. As described above, the relationship counter indicates a number of interactions, such as messages, associated with the website, a lexicon associated with a group of website documents, products services etc. from related users. In some implementations, each interaction may increment the counter.

In another implementation, the lexicon data may be filtered by one or more attributes. For example, instead of, or in addition to the relationship counter and pre-determined threshold, the lexicon may be filtered for a particular user 104 based on certain preferences such as by date, by content, and so forth.

The pre-determined threshold may be statically or dynamically set The threshold may be set by a system administrator and applicable to one user 104 or a group of users 104. In another implementation, individual users 104 may set their threshold value. The threshold may be dynamically set, such as by comparing when the user selects the relationship the counter value. For example, some users 104 may typically disregard interactions until they have three or more interactions. Thus, for those users 104, the system may dynamically adjust so that relationship counters are presented when there are at least three interactions.

In block 1006, the filtered data may be provided to the user device.

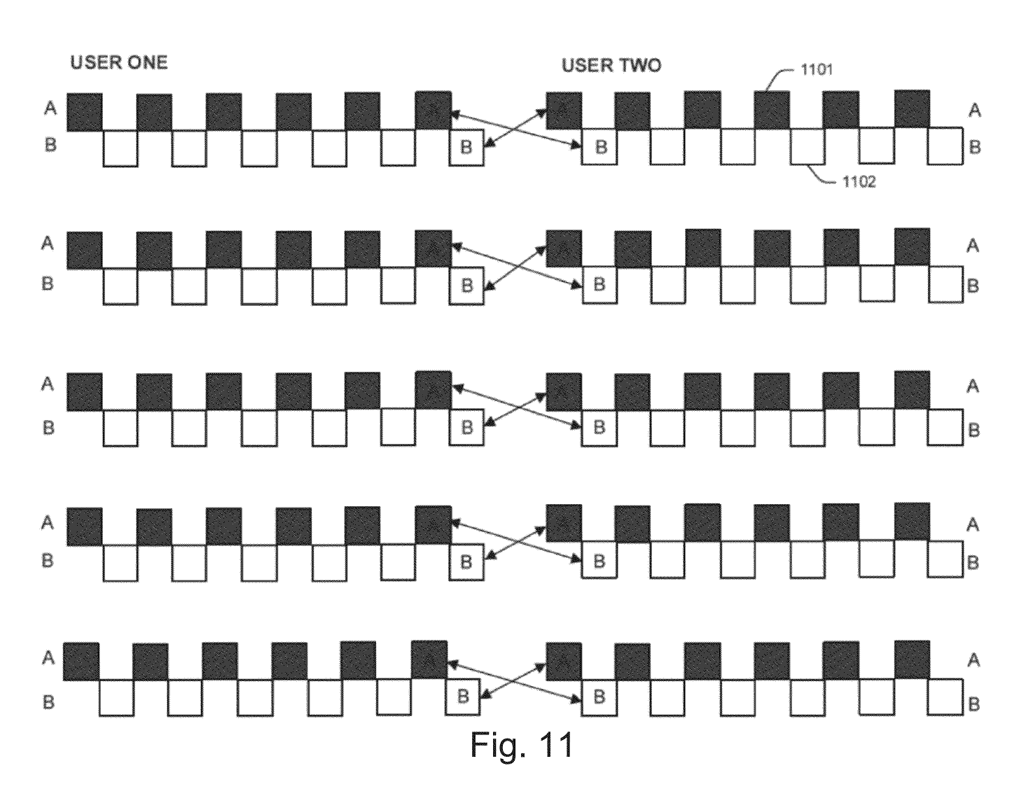

FIG. 11 is a representative data structure for the tags and related privacy settings. A user device 104 may have different tags, each with a different preference level indicated by 1, 2, 3, and 5. Each level may indicate a privacy level associated with the tag, indicated by a degree of separation. For example, a level 1 may indicate a direct communicative relationship. The user may be share the tags depending on the level of trust.

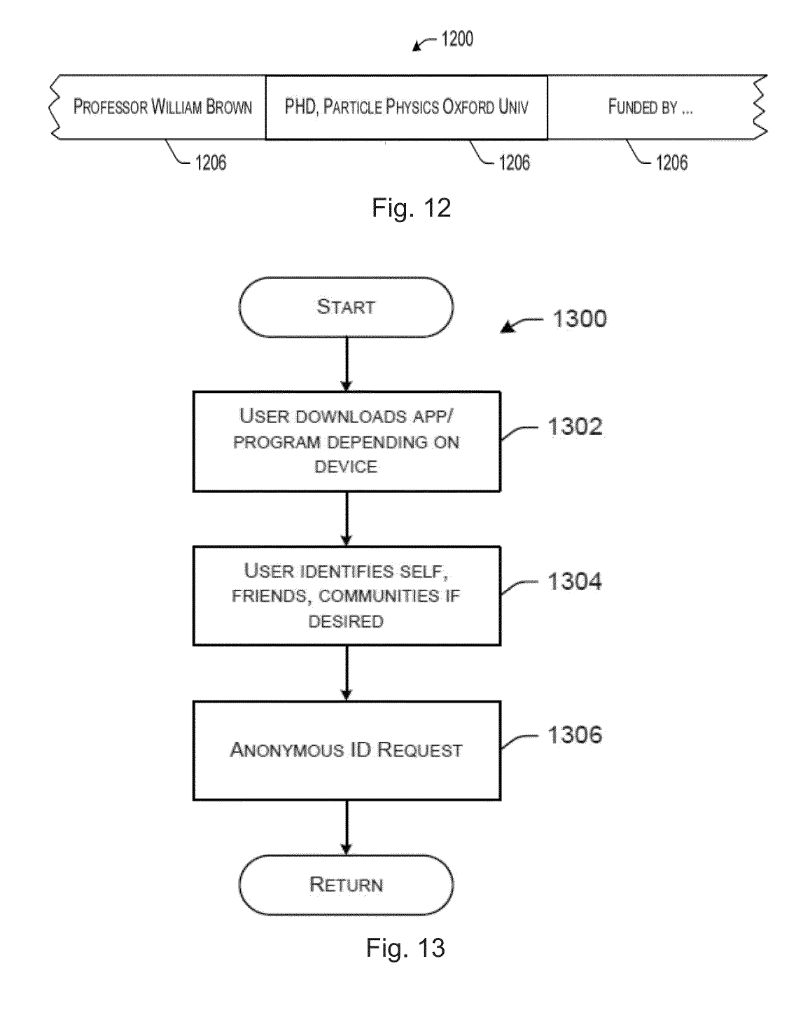

Directing attention to FIG. 12, tags 1202-1206 can be joined in string 1200 to help the search i.e. “Professor William Brown,” shown in tag 1202, “PHD Particle Physics Oxford University,”—Tag 1204, and “Funded By Cern,” shown in tag 1206. So in the example shown in FIG. 12, on scientific papers accreditation and funding can be linked in the tags, this of course would work with a wide variety of applications, such as films or any other group enterprise. Strings of tags work well for individual users and simple applications also. In an embodiment, the tags in string 1200 are weighted based on the user's choice. In embodiments where tags 1202-1206 are weighted equally, the cumulative amount of positive or negative tags (1 through 3+) make the first result hopefully the most relevant If not, the user can tweak the weight of the tags in the tag sting in advanced mode, or chose negative tags to further refine the result. Results are based initially on positive agreement of tags, with initial tags taken from websites' meta data. Users can simply agree with meta data, and upon agreement the meta data is converted into tags.

Descriptions of the node network architecture embodiments of the present invention explained with reference to a user interface referred to herein as the tool rose, which is explained in detailed below after the function and applications of the node network architectures contained herein are described.

Adding tags (or disagreeing with the tags) is encouraged by the ease of use of the tool rose user Interface. When a user disagrees with a tag, that disagreement becomes a tag also. Each user, their devices, and each community have unique identifiers. Each tag has the user's ID attached and is dated, which enables the removal of already-seen results, or selection of already-seen results to aid the search. At set moments consistent with privacy needs of users, the unique identifiers can be removed if or when required. The present invention utilizes a torrent method that differs from a standard torrent in that at the moment each single torrent file is given its own unique identifier, each user is given unique identifier. However, in an embodiment, one can still maintain anonymity by requesting an anonymous ID. Each user has his or her own unique user identifier (referred to herein as a “UI”) and a password for authorization. A further elaboration of the UI can be used for the user's devices. For example if their UI is “ABCD,” their device(s) can be identified as ABCDA or ABCDB etc. Directing attention to FIG. 13, there is shown generally a sequence of steps 1300 that show interaction with a user device from the user perspective. At step 1302, the user downloads the app or program depending on their device(s). At step 1304, the user identifies himself, his friends and communities if desired. The user receives a identifier and pass-code for himself from service provider system 110, and from communities they are linked to, going through whatever security protocol the communities have instituted. Users also reciprocate with an asked friend and can be acknowledged by their friends, and have the facility to remove the friend's ID from their stream. At step 1306, if the user wishes to tag anonymously, he or she can request from service provider system 110 an anonymous tagging identifier, and a pseudo-randomly generated, encrypted key is then generated for that user. Service provider system 110 has the ability to delete tags from the network, keeping it safe, and still allows anonymity.

Each privacy or tag or community level has an add-on to that UI identifier which is also unique, enabling sharing by choice, degree of separation, community etc. For example, consider that user 0 has the UI of userO, and each device, if logged on and linked, would be userO1 or user02 etc. At each tag level, privacy level, community, etc., there is a further refinement on the UI, so the most private level in which the userO shares information between devices is for example userOa, the next level of sharing is userOb, etc. It is anticipated that a strong level of cryptography is provided for the most private levels. Every standard file seeded has a UI that is linked to the user and to the privacy level chosen. Each time users log on, the can choose their own ID, or use an anonymous ID (double blind key). There also is no need to log in to search standard tags, but the login is needed to search private tags, by degree of separation, private communities and the like. Thus, using the torrent system of the present invention as described herein, each community creates its own alternate Internet as a heterogeneous network solution.

The service provider system 110 has its own node computers that operate on private streams so that user updates don't choke the base registry with direct information. With open tagging as described herein, each user is tied in by their initial registration to a specific base node computer, and the computers of the service provider system 110 update each other at set times. Each set user group, private community or the like also can choose select devices such as any Internet-enabled device, computers, tablets, mobiles, watches, televisions, etc. to act as main nodes when needed by a level of users to avoid choking the system. Directing attention to FIG. 14, each torrent file level consists of two variable data streams A and B. Stream A is used as a base standard registry. Stream A is updated by the program from stream B at set moments of time as the data is accrued and changed. The data in stream A and B are time stamped, with this the program recognizes and updates from stream B to stream A.

When the user tags the meta data, it is stored in stream B, which then updates stream A. Each time A is updated it automatically saves the base registry file and seeds updates to stream B of the allied devices and computers within the privacy setting. B updates to A, which updates to other users' stream B and so on in a cyclical fashion. Streams A and B are in the same torrent structure, two halves of the same whole. When there is a new tag, it is attached as meta data to a URL, or as meta data to a identifier of the base program file (for example, word processor files or image or sound files), that is then stored in the base registry, the meta data is time stamped, with this the tags are shared from stream B, to A at set moments and new tags are recognized to be shared to the privacy levels of the users choice. Tags are either user-identified, or base definitions, base definitions are set categories of standard URL meta data or user-based tags such as emotion etc. as described herein. Stream A also updates streams and seeds to the node the user is identified with, again dependent on the privacy setting of the user.

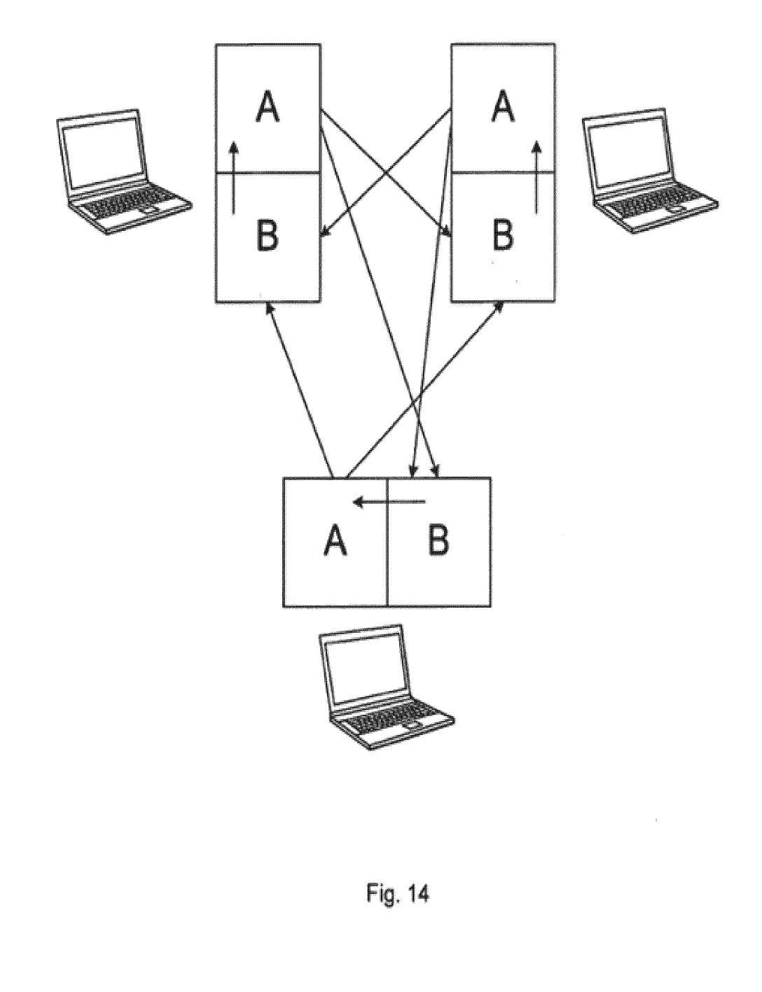

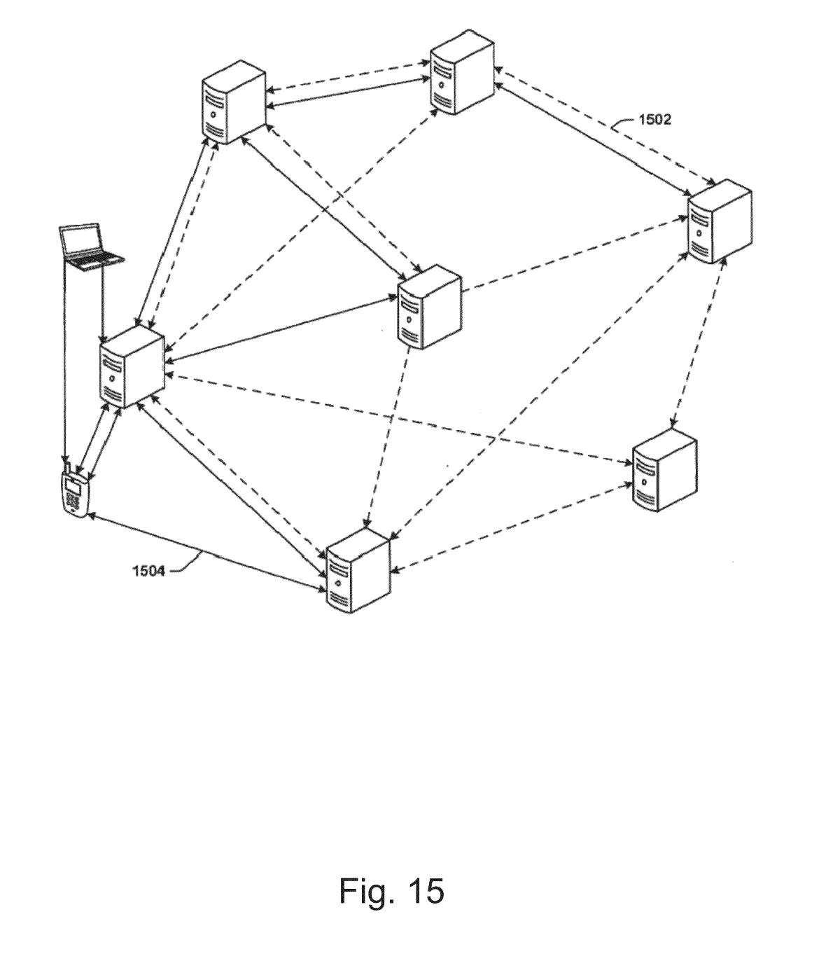

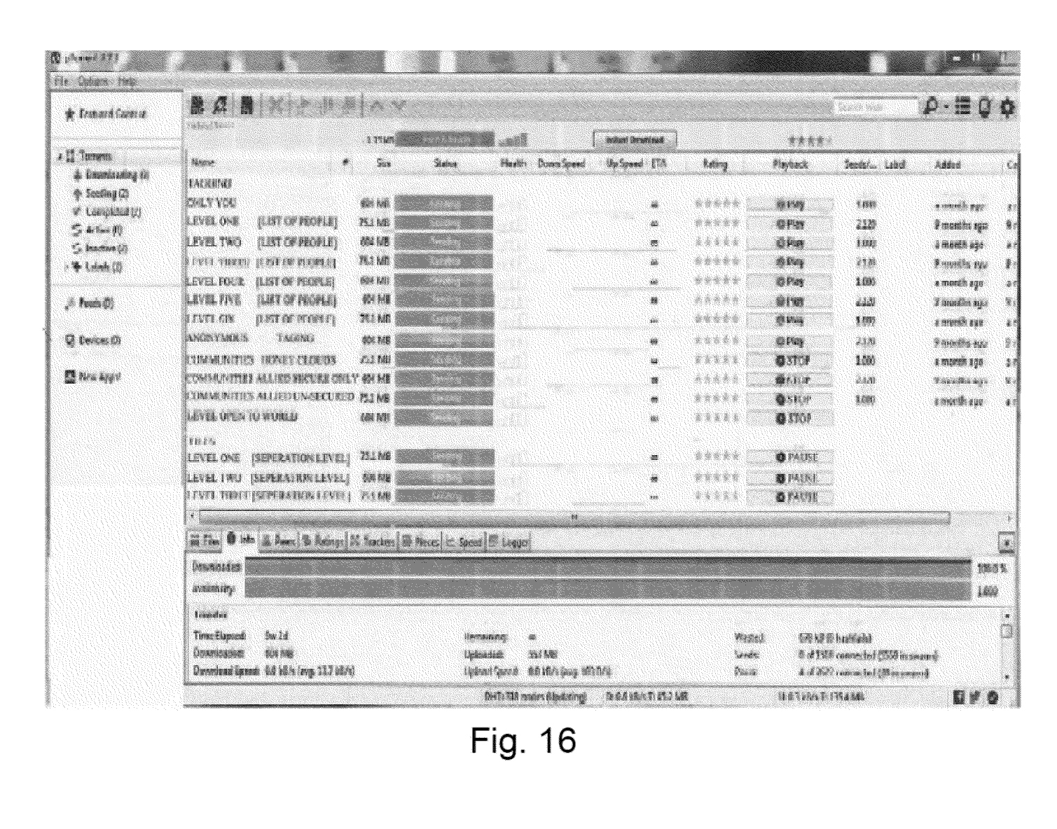

Directing attention to FIG. 15, each device acts as a server for every other device the user wishes to interact with, or other users, or communities, and as such maintains privacy. Each user and each community have unique identifiers enabling direct communication. As shown in FIG. 15, arrows having dashed lines such as arrow 1502 show the open torrent streams. The solid lines 1504 show closed torrent streams, either between a user having multiple devices backing up information and tags, or degrees of social separation or set communities. Again, as service provider system 110 is the main seeder, it stores copies of all open tags, and allied community tags, to enable general search. Each torrent file contains identifiers to the tagging information level, community (or club etc.) share level, and a file share level, all of which may have various degrees of privacy. This is illustrated in FIG. 16, where multiple torrents are shown. This way, the information is placed in the appropriate torrent, and at each level the user can choose how to interact by sharing only what they want to.

The torrents file streams are updated continually, unlike a standard torrent. With this facility the tool rose can forward messages from users who are linked, and as the tool rose is linked to service provider system 110, it can also, given permission, forward standard messages, such as Facebook pm's, tweets, email etc.

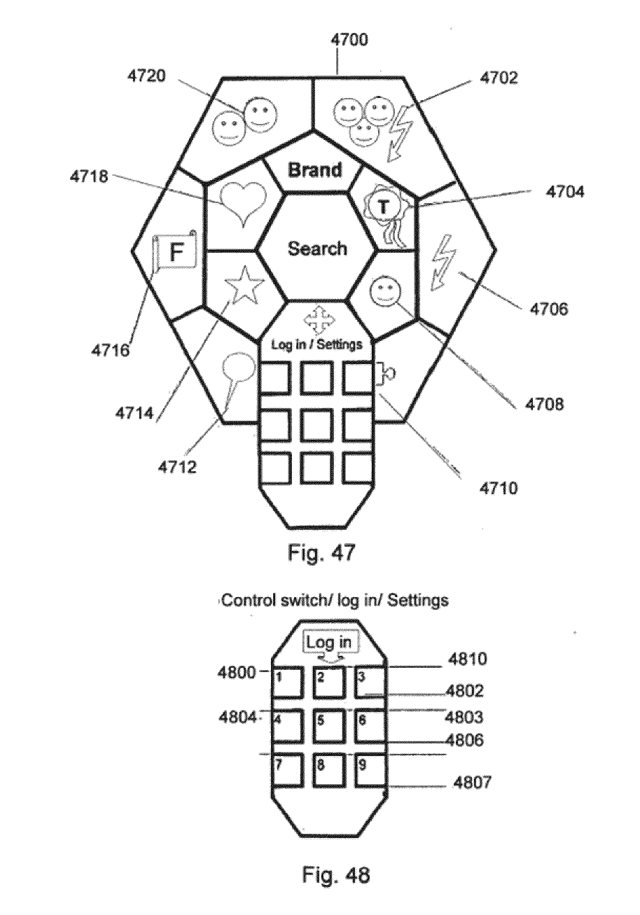

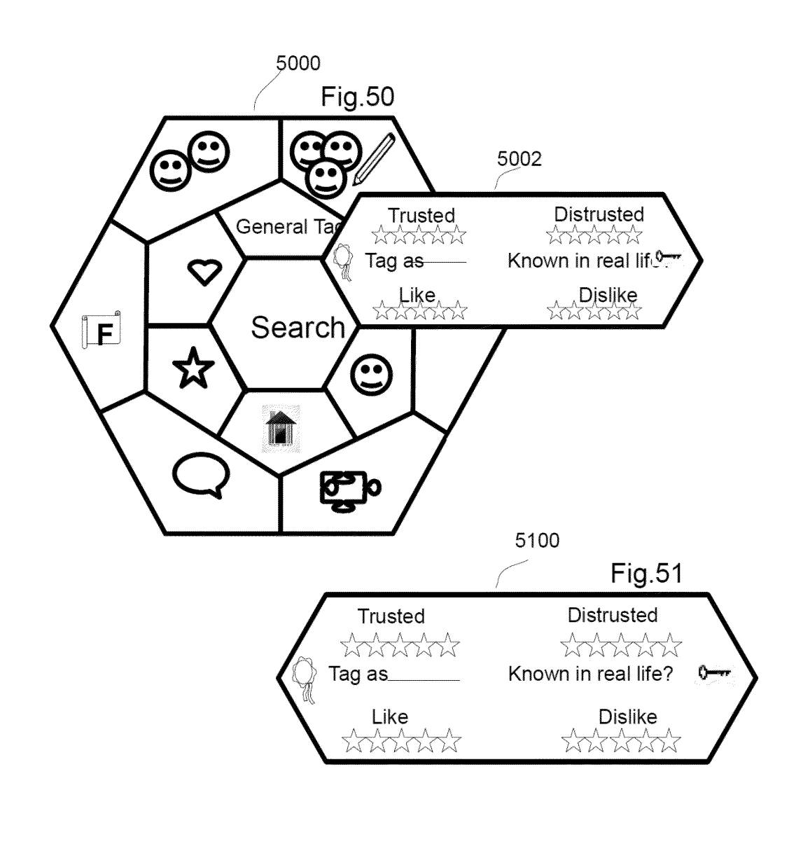

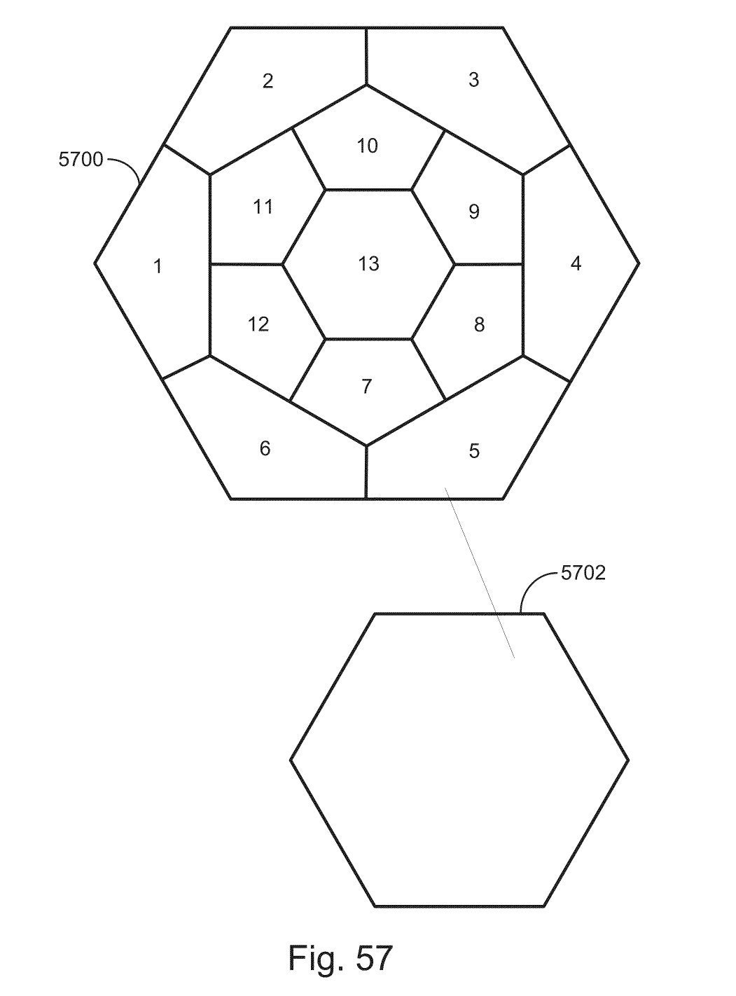

User 1 joins a node network, downloads tool rose, receives the origin identity key code and creates a password and index name (i.e. alexllondon), sets the privacy level to that name (i.e. searchable or not, and within what degree of separation) and whether a location tag should be attached initially. They are logged in to their personalized tool rose node network, they personalize the standard settings, and authorize a search by the tool rose on their device for contacts, then log in and synchronize appropriate networks and network contacts. They then download the tool rose to any other device and synchronize it with the origin device, each subsequent device being set as an adjunct to the original prime identity. The user then authorizes a search on their device via the tool rose and selects which files to share, and with what adjunct devices, if any, or whom, which networks and at what level of security and openness etc. When the tool rose scans the devices files, the depth of the scan is up to the user, and if a full scan is selected it will add meta data tags to imported files, or overlay linking meta data to chosen files. Users can choose to fully import the files or short cut them from the origin file, if the file is set to “open share” the meta data is stored in origin format in the tool rose user file and that is automatically uploaded to a tool rose emperor node, the user can also add links to the files. The device, after analyzing its own files, searches and synchronizes any files from the user in other networks or devices. At each degree of openness the user will confirm they want to share the file, and dependent on the security pre-sets they may have to add a key, any upload to an open network could require system reauthorization and/or subsequent login to the tool rose. The user's node routing table is formed at initial download to their prime origin device. The router is continually updating the contact details of the arranged and prioritized contact list, emotion adding a further context and refiners on logical judgement, or computer logic. The tool rose graphical user interface illustrated and described herein in multiple embodiments easily enables adjustments to the illogical, human-quantified and emotionally-driven routing. In one aspect, the user manipulates the tool rose to update a file using quick link routing refiners displayed in a tool rose petal as an emoji, emoticons, symbols, and the like. The tool rose overlays the active file, with the tool rose 4700 in FIG. 47 (at reference numeral 4718) showing a possible emoji for like, reference numeral 4714 showing a possible symbol for priority, reference numeral 4720 showing a possible symbol representing multiple friends. FIG. 57 shows a basic petal formation in tool rose 5700, with each number representing a quick link to a refining emotion, a file or program, a specific person, or network. Directing attention to FIG. 50, at reference numeral 5002, there is shown a version of a petal quick link expanded with adjustable possible positive and negative variable refiners showing.

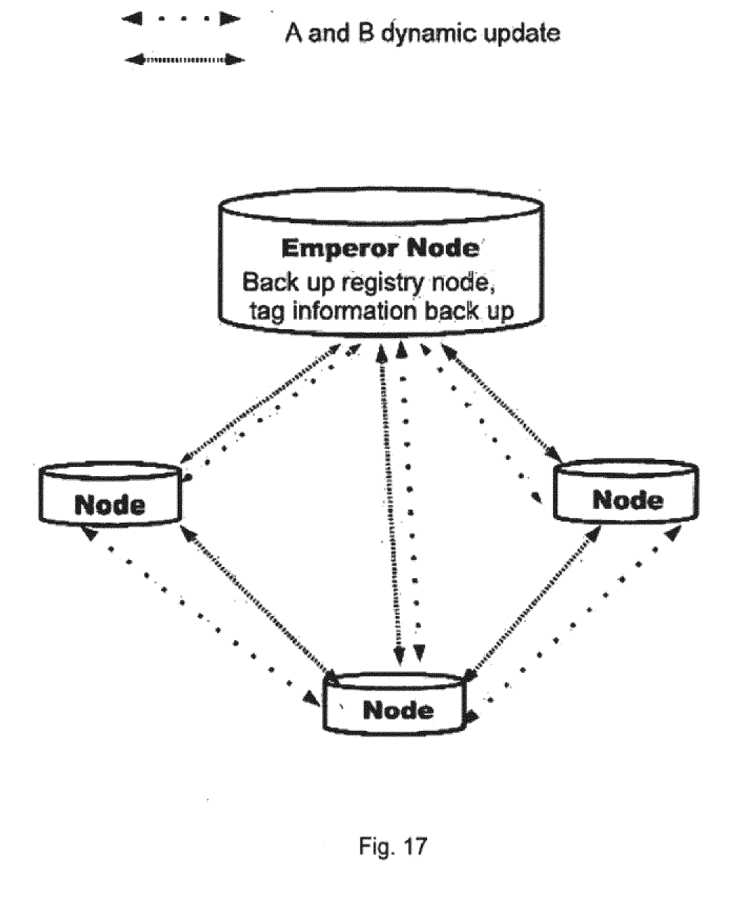

FIG. 17 is a representation of a node network having an emperor node in communication with other nodes. As shown, emperor node 1702 is a computing device or collection of computing devices configured to maintain a backup registry of nodes as well as backup storage of tag information provided by users of various nodes 1704-1708 in the network that are in communication with the emperor node. In accordance with the dual-node architecture of embodiments of the present invention, nodes are divided into a dual-node logical structure having node A and node B, as described above, and dynamic updates of nodes A and B are represented by the two lines connecting each of nodes 1704-1708 to emperor node 1702.

A prime node is the uniquely identified designation received by the first node in a personal network from an emperor node, an adjunct node has an unique identifier which is dependent from a prime, which is an affix on the primes unique identifier to coordinate network identity. A prime node may become an emperor node. An allied emperor is a node system from an alternate network which maintains base structural protocols, though may have different refiners, or joining requirements. An allied prime is a prime node from an allied network. A mirror prime is any proportional virtual routing partner to another prime node, in a virtual overlay naming structure, for structured dynamic multi-casting. An adjacent prime, is the hierarchical predecessor or subsequent prime, to any referred to prime node a peer to peer network.

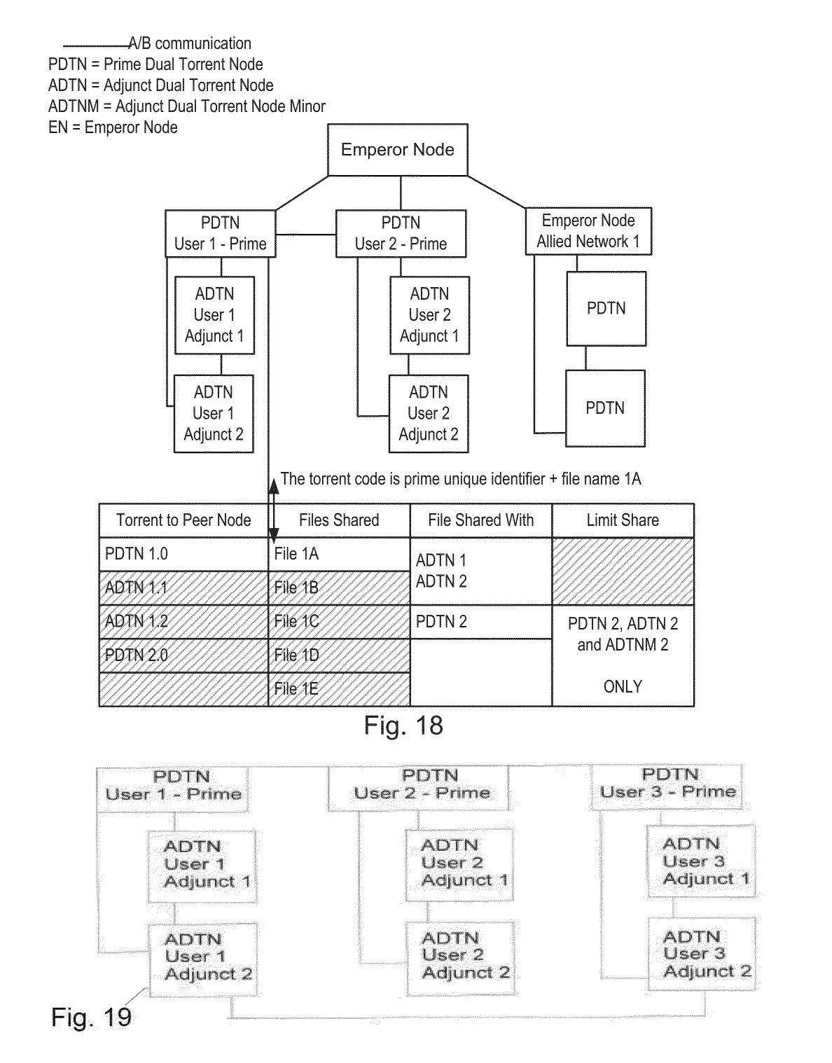

FIG. 18 is a representation of an emperor node associated with prime nodes and adjunct nodes. In node network 1800, emperor node 1802 is in contact with prime nodes 1804, 1806, and emperor node 1808. Prime nodes 1804, 1806 in embodiments are dual torrent nodes associated with individual users, having nodes A and B as described above, and also may be associated with adjunct dual torrent nodes 1810, 1812, respectively. Emperor node 1808 is an emperor node of a separate network, referred to herein as an allied network and is in contact with prime nodes 1814. Table 1830 shows organization of torrents to peer nodes, files shared, with whom the individual files are shared, and any limits places on files shared.

FIG. 19 is a representation of decentralized network disengaged from an emperor node. As shown in environment 1900, there is no emperor node; only prime nodes 1910, 1920, and 1930. Prime node 1910, associated with user1, is also in contact with adjunct nodes 1912, 1914. Prime node 1920, associated with user2, is also in contact with adjunct nodes 1922, 1924. Prime node 1930, associated with user3, is also in contact with adjunct nodes 1912, 1914. Adjunct nodes 1912, 1914 are shown in contact with each other. Adjunct nodes 1922, 1924 are shown in contact with each other. Adjunct nodes 1932, 1934 are shown in contact with each other, [and specifically 1914 and 1934 are in direct communication]

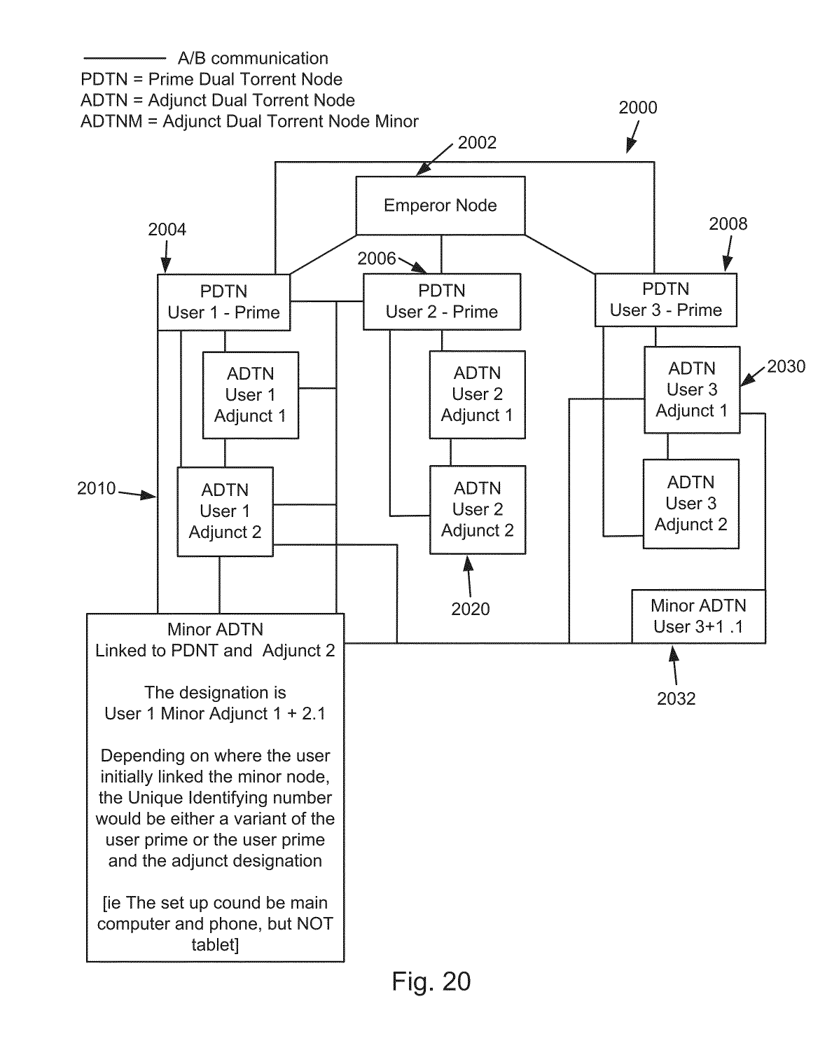

FIG. 20 shows a representation of a device connected in node network environment 2000. As shown, the emperor node 2002 is in contact with prime nodes 2004-2008, which respectively are in communication with adjunct nodes 2010-2030. As shown, a minor adjunct node 2032 connects to user3's adjunct node 1. Depending on where a user initially links the minor node, the UI may be either a variant of User 3's prime node 2008 or prime node 2008 and the adjunct designation. This set up is particularly useful for a user's devices, such as the user's main computing device and mobile telephone, for example.

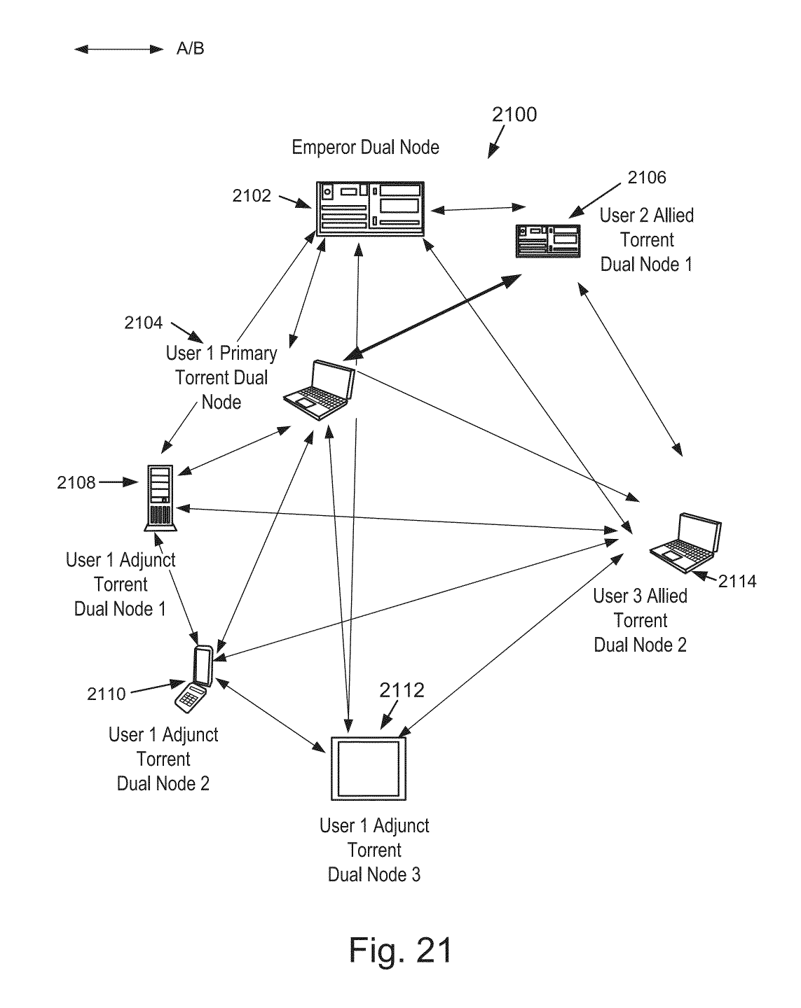

FIG. 21 shows network environment 2100 in which emperor node 2102 is in contact with user 1's prime node 2104, user 2's allied prime node 2106, user 1's adjunct node 2108, user 1's adjunct node 2110, user 1's adjunct node 2112, and user 3's allied prime node 2114. As shown, the various nodes are implemented in a variety of computing devices, such as game consoles, laptops, tablet computers, and smart phones.

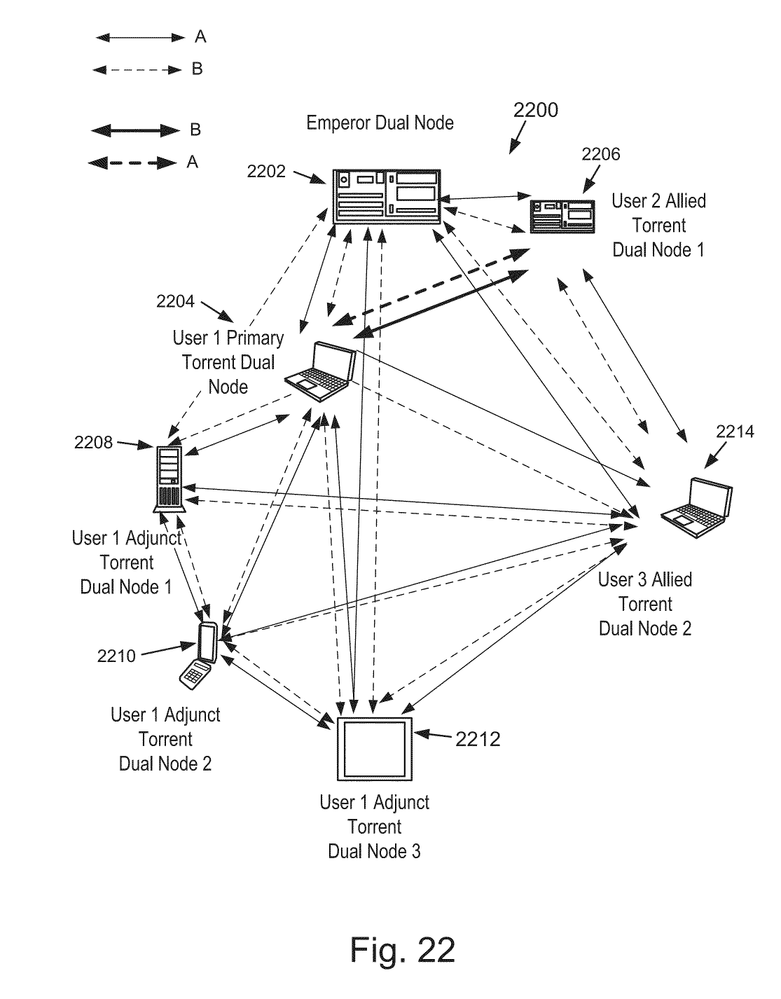

FIG. 22 shows how the dual node A/B updates take place between various devices shown in FIG. 21. In network environment 2200, A/B node updates described above, occur between the various nodes 2202 through 2214. The heavier lines showing prioritized and active streaming, the lighter lines symbolizing inactive streaming but the nodes are linked via routing table, so could go active at user prompt.

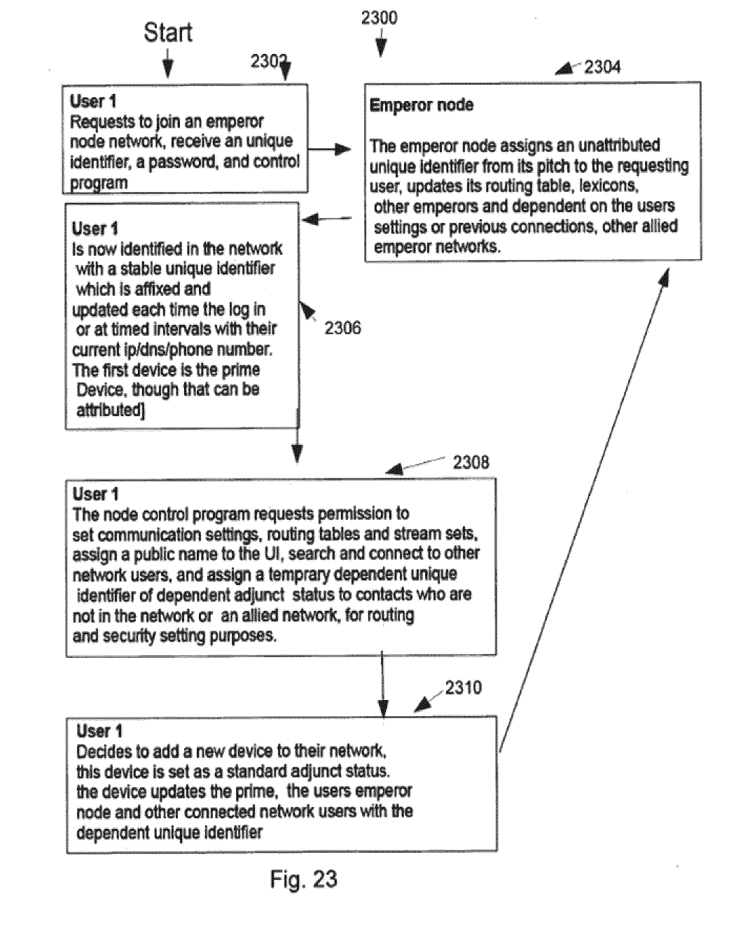

FIG. 23 is a flow diagram depicting a user journey over a node network. Beginning at act 2302, user 1 requests to join an emperor's node network such as those shown above in FIGS. 20-22, and receives a UI, password, and control program upon approval from an emperor node. At act 2304, the emperor node assigns an unattributed UI from its pitch to the requesting user, updates its routing table, lexicons, other emperors in the environment, and, depending on user settings and/or previous connections, other allied emperor networks. At act 2306, user 1 is now identified in the node network with a stable UI that is affixed and updated each time a login occurs or at timed intervals with their current IP, DNS, or telephone number. The first device a user connects with is designated as the user's prime node, although that can be attributed to a subsequently-connected device under the user's control. At act 2308, the node control program received by the user's prime node from the emperor node requests permission to set communication settings, routing tables and stream sets, assign a public name to the UI, search and connect to other network users, and assign a temporary dependent UI of dependent adjunct node status to contacts who are not in the network or an allied network for routing and security setting purposes. At act 2310, the user decides to add a new device to their network. This device is set as having a standard adjunct node status. This device updates the user's prime node, the emperor node to which the user initially connected, and other connected network users with the dependent UI. Control then returns to act 2304, where the process repeats for this user and/or other users. In this manner, users have the ability to add subsequent devices to the network and communicate using them with other nodes in the network.

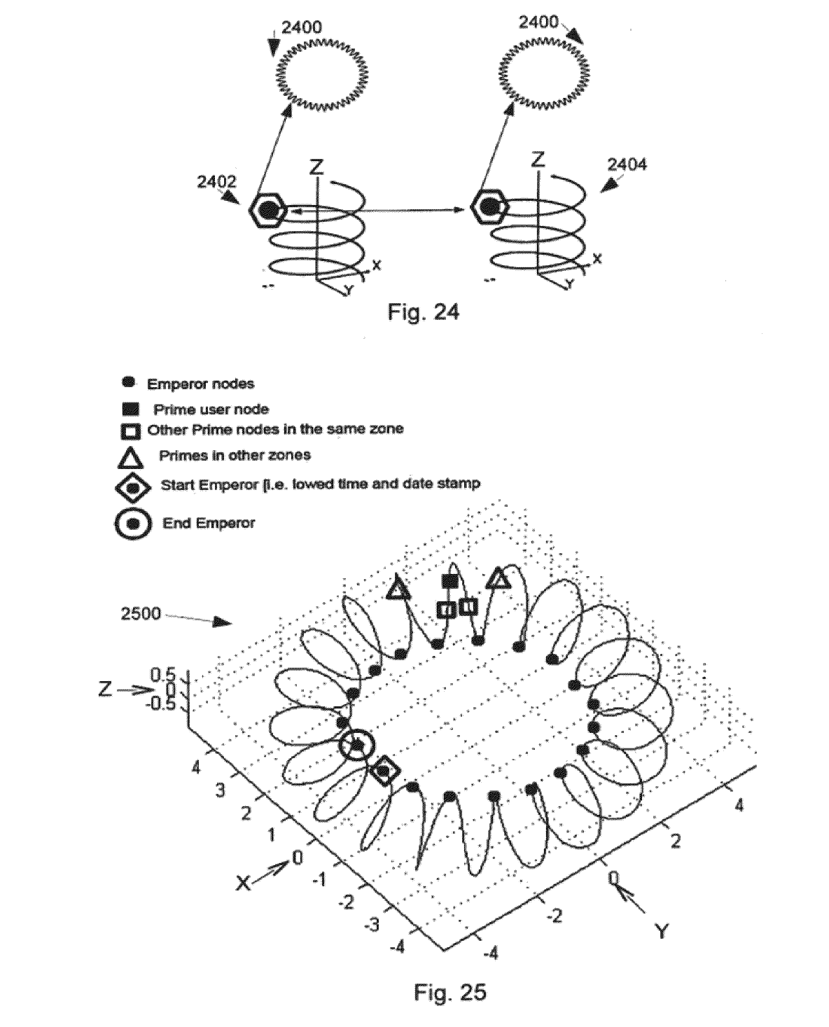

FIGS. 24-26 are representations of a helix architecture for a node network of emperor nodes, prime nodes, and adjunct nodes. Directing attention to FIG. 24, a helical structure 2400 is useful for visualizing the relationships between nodes in embodiments of networking environments of the present invention. Helix 2400 allows expansion by inserting additional pitches over time. As referred to herein, a pitch represents one complete revolution around the Z axis of the helix 2400. As shown FIG. 24 showing mirrored primes on different allied networks.

FIG. 25 illustrates a helix structure 2500 having emperor nodes located at each pitch in helix structure 2500. A starting emperor is defined herein as a node having an allowed time and date stamp associated with it, which is in communication with the other emperor nodes on the different pitches of helix structure 2500. To show a complete traversal of helix structure 2500, the end emperor node is adjacent to the start emperor node. Each pitch would have hierarchical designation, so time date to define position not an absolute, time date needed for best practice tided links, lexicons, and communication.

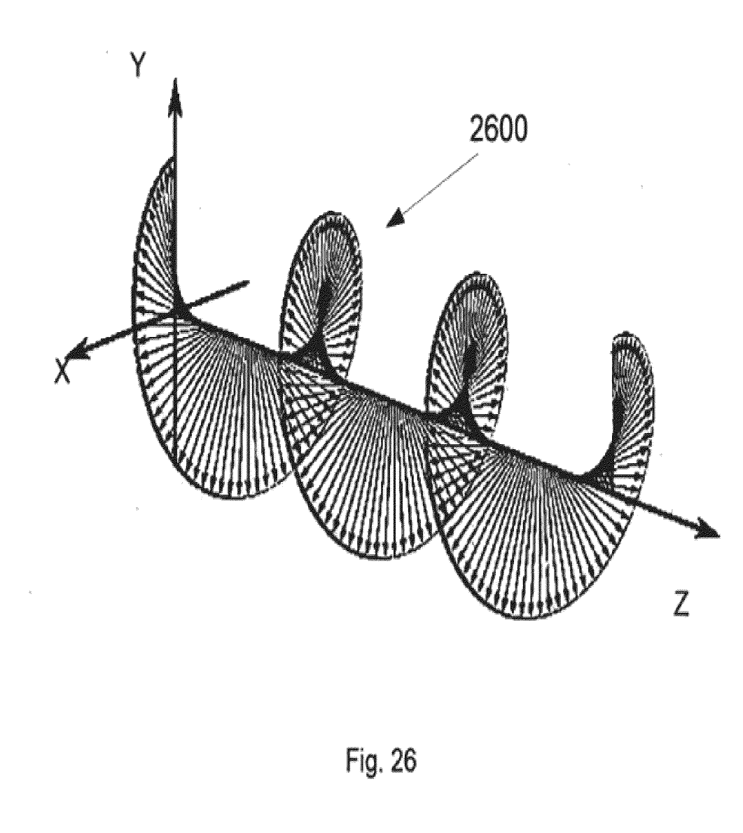

FIG. 26 shows the vectored helical structure 2600, which can be expanded to link together a very high number of node networks. Proportional designations set on pitch angles allowing controlled communications throughout the dynamic network.

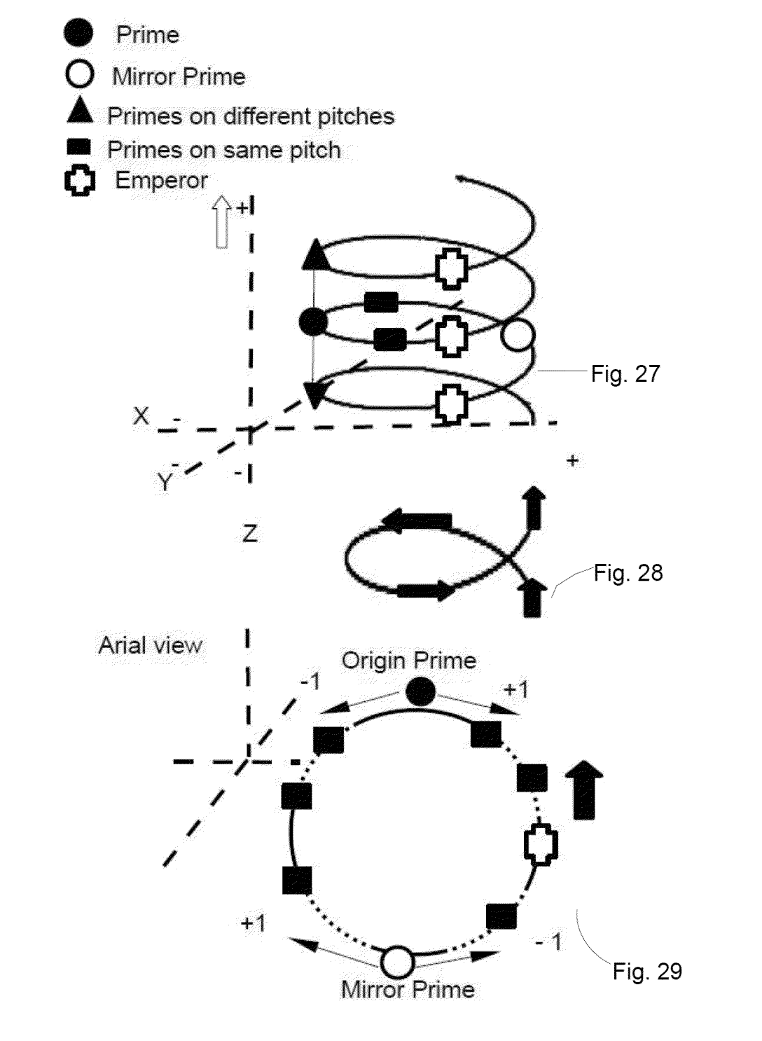

FIGS. 27-29 are representations of prime nodes on different pitches of a helix architecture for a node network Directing attention to FIG. 27, a prime node is shown on helical structure 2700 as being in basic contact with adjacent prime nodes on neighboring pitches, and potential contact with adjacent primes on its own pitch, a mirror node, its own emperor, and the other emperors of the neighboring pitches. FIG. 28 showing the vectored direction of traversal 2800 of helical structure 2700. FIG. 29 shows aerial view 2900 of the portion of helical structure 2700 and the vectored direction of traversal 2800, also showing the effect of the pitch vector for proportional multi-casting or controlled flooding, vector is very important as its the z vector which makes the proportional multi cast more controllable, and adds an extra safe guard as you wouldn't need a time stamp on the data flooded.

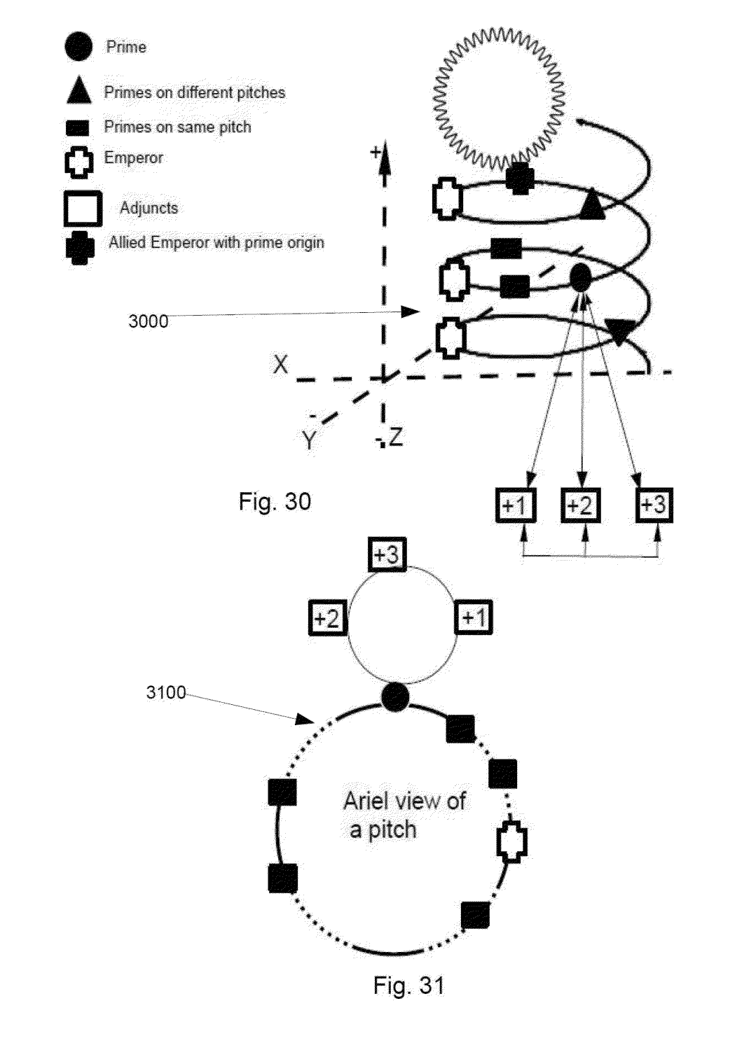

FIG. 30-31 Directing attention to FIG. 30, the helical structure 3000 showing connection to a separate helical structure through an allied emperor node which was a prime node in the original network. As shown, and described above, a prime node may have a number of adjunct nodes, in this case three adjunct nodes. FIG. 31 shows aerial view 3100 of helical structure 3000, emphasizing the prime adjunct association.

Directing attention to FIG. 30, helical structure 3000 shows connection to a separate helical structure through an allied emperor node with a prime node origin. As shown, and described above, a prime node may have a number of adjunct nodes, in this case three adjunct nodes. FIG. 31 shows aerial view 3100 of helical structure 3000. 32=sharing structure.

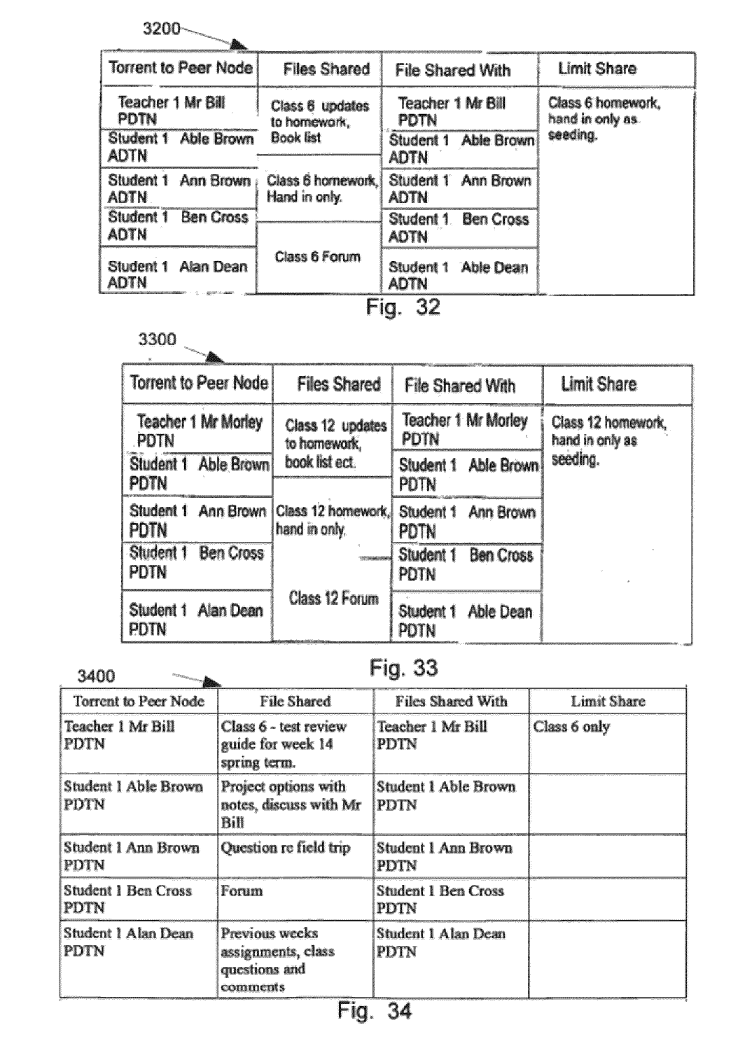

FIGS. 32-36 represent various file sharing details for different nodes on the node network. Directing attention to FIG. 32, routing table 3200 shows a prime node attributed to a teacher, the files he shares, and students represented by adjunct nodes. The prime node shares its files with its adjunction nodes, and also limits the files to be shared between the prime node and adjuncts, for example home work that is to be handed in is accepted only in a desired manner specified by the teacher.

FIG. 33 shows a routing table 3300 where the students of FIG. 32 are listed again, this time as prime nodes connected to a different teacher, who is also represented as a prime node. This routing table similarly shows the files to be shared, between which nodes, and the limits on the file shared.

FIG. 34 shows routing table 3400, which is similar to routing table 3200 but with fresh details for files shared, between whom they are shared, and file sharing limits. Thus, FIG. 34 shows the dynamic nature of file sharing between nodes as they are affected by updates. For example, routing table 3400 can change again with an update a week later, so that there is always a current routing table throughout the school term.

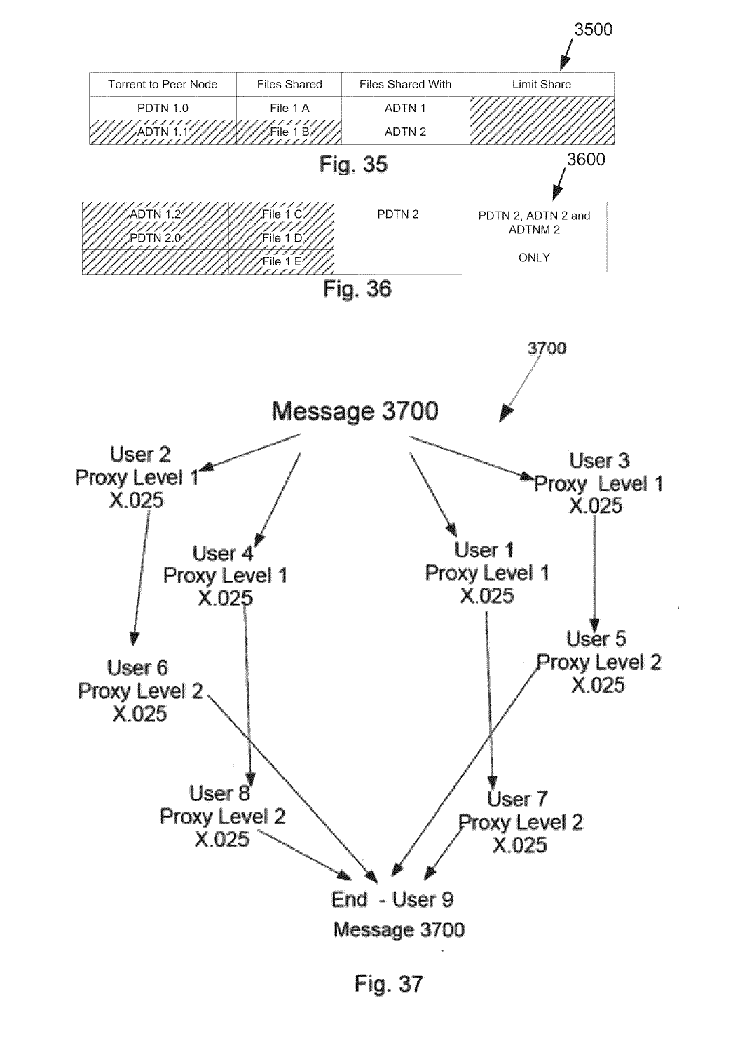

FIG. 35 shows prime dual torrent node [PDTN] 1.1 actively sharing freely files 1A-1D with prime allied dual torrent node PALDTN 2.0 (reference numeral 3500). PDTN 1.1 has previously shared those files with emperor node 1.1 in a limited manner. FIG. 36 shows at reference numeral 3600 prime dual torrent node [PDTN] user 1 has shared file 1A with user 1's own adjunct nodes and prime dual torrent node 2.0, though user 1 has limited the share, so user PDTN cannot share file 1A even with one of their adjuncts without a time to live activating and deleting the file in any further node.

FIG. 37 represents message dissemination between various users on the node network having different proxy levels. Message 3700 is shared with Users 1-4, all having a proxy level of 1. Users 1-4 then share message 3700 with users 5-8, all having a proxy level of 2. Users 5-8 subsequently share message 3700 with user 9, an end user. In this manner, message passing in the network is controlled through proxy levels for security.

Embodiments of the present invention automatically fill and cross-reference tagged or identified information, or information sources, across devices if desired. Examples include creating a file containing all emails, texts, word files, photographs, etc. from either a select user or users, or networks, or using selected key words, or other meta data, thus enabling easier organization. Selecting files to be “short cuts/ghosts” between devices, enables full cross device access when devices can communicate, and allowing minor devices to maintain lighter hard drive use. One doesn't need complete files on any one device for sharing or search of information if a file is open (meaning accessible with no time to live constraint), or at least open to that type of network, and the information has not been through the cryptography spin. The initial file would be split with meta data tags ordering it, and a person or program could choose to send or send automatically the whole file or segments. They, or the program, would select a segment of that file and only release that portion which is highlighted via the selection process. It is a system where the program which breaks up and reforms the file can recognize a person or automatically highlighted or specifically tagged information (or area) and prioritize that information with further meta data tags—i.e. a highlighted passage within a file, or a specific face in a photograph, or any x/y graph positioned tagged information, or keyword selected information or the like. For example, a face in a photograph would load before the rest of the photograph loads. With this system, the end user would not need a complete file to partially open a section and as such this would prioritize select data transfer across torrent p2p networks. The information could still have basic cryptography, just not the spin, and if unencrypted, the meta data would be open to all searches. Each origin user is a subset in the super origin base registry in the tool rose dual node net, and unless a proxy is used, the base register is adapted with a location proximity code; each subsequent user device is subset to their origin code.

Each user, and/or device can split into a new origin net and become an origin registrar for their own network. With this a user or device might have multiple registry values, but depending on which network they log onto and their activities, identification and responsibilities on a registry is different When logging onto the tool rose node net, their origin registry could not be replicated, with any other user, though it could be transferred to another personal device. Each code is linked to the user's name or pseudonym and passwords. If the users forgot the password, they would have to remember the designation of the device that they on were logging in on, and their user name. The tool rose could be set to delete all information contained within a user's private network or any specific device, but they would have to pass additional security protocols. This would add a layer of security if a device with an open tool rose was stolen.

The dual update nodes are relative and dynamic. They can be wholly or partially linked in private networks, with each node choosing whether to act as a tether to others in the network. All open tags and information (i.e. files etc.) scanned are collated, indexed and stored on emperor nodes and secure storage. Emperor nodes can request data automatically from each other and trigger searches on each other's open streams and tags (or storage stacks) to update requests from prime users across the system. An emperor is like a personalized server exchange.

In embodiments, emperor nodes are permanently online in a cloudlike environment. A new emperor is formed when a local emperor is at x % capacity (i.e. 70%). At this point, the latest-formed emperor triggers a new one to be formed, duplicating basic node programming, indexes, etc. The new emperor has subsequently a greater hierarchical identity number than the last one. The new emperor has a higher designation, and new users to the network are attached (or shunted) automatically to the highest regional emperor node.

Emperor nodes have static IP addresses and can hold fresh user information (i.e. messages, files, etc.) until a user logs in, where it is then transferred to the user's prime or another designated user node, and deleted from the emperor, unless the user wishes to maintain a copy on the emperor node stack. Open or shared information (i.e. mail), is dumped to the user's node and either deleted from emperor node, or stored in an account, like a normal sever.

Each prime user node has a twin in their emperor, not necessarily for information storage, but for stored settings and switching stream information and tags if the user wishes. Emperor nodes are super nodes made from multiple nodes with distinct regional structures; each has its own specialized functions composed of flexible hubs that help to organize and coordinate processing among the other independent specialized nodes' networks. Multiple, rapidly-shifting connections are managed by specialized processing hubs and networks in the emperor node. Heterogeneous cores have vector (i.e. tagging in open or closed formats changes the vector on the information stream) units for streaming, scalability, and core indexing of end user nodes. Each emperor node sections itself to work in small indexed designated units, which then forward the data to higher controlling hubs. The hubs control different networks. For example, users who tend to group in overlapping networks, as well as privacy issues, make certain tags open to specific groups. As set units become more active, more processing power and bandwidth is made available to those units. The information is like threads woven together to make rope.

A network setting can be selected at initial download (or later), and the node can be set as an “Allied Emperor” for index and identity purposes. An allied emperor node can also be set after usage and shows the need to designate a prime user node as an allied emperor, when a set amount of devices on a user network grows past a threshold number for user devices. The emperor nodes designate the allied emperor as a user network or an allied network for unit designation, for example processing and bandwidth.—this is based on information demands on nodes and prefix indexing to a user ID.

The emperor node system is decentralized but hierarchical, for duplication, expansion, back up, and jam reasons. In embodiments, each emperor node includes multiple parallel super nodes combined to form one emperor node. There are sets of communication hubs that relay the streams associated with sets of users, networks or tags, or tag fields (such as similar tags grouped together) to avoid blocking any particular sets of streams. The emperor nodes and user nodes hook up to each other as needed.

The nodes communicate on an ad-hoc basis because the super nodes are dynamic and there is less opportunity for a data traffic jam, or many of the other problems of mainstream hierarchical nodes. If one emperor node is down or flooded the user node jumps to the next closest in the hierarchy, until the failed node is functioning properly again. 51.) All nodes have the address indexes of the emperor nodes, and have other indexes to store and share information. Each user's nodes contain the user's own prime and adjunct nodes full indexes, as well as the emperor node addresses. Each user's node network can also contain the addresses and other indexes of allied networks and friends' addresses.

All nodes, when online or with open security settings, have continuous dual update of active information sharing, either in standard format or in a dual torrent stream. A user has total control over how information is received, and streamed, at what rate, with whom, and what networks. Each user node when online finds the local emperor or allied emperor and attaches itself. As the user is in total control, they can choose to seed and leech to their own devices on a private network, or to any other.

All user nodes have personalized sharing settings, for example selective timed sharing, selective amount sharing, selective files, and proportional sharing. All user prime and adjunct nodes are linked across devices. Each emperor node with the dual update stream maintains information correctly even if there are time lags or the connection drops momentarily. Emperor nodes back up to emperor stack backups, either at set times or set points of accrued data. As coding for the cloud also brings many extra problems, like time lag and cores disappearing in the middle of a computation when a connection drops, the dual update system previously described self-correct these issues.

Meta data tags have file locations, descriptions and key words, and x/y/z positioning. The tool rose nodes heuristically scans documents, images, videos etc. depending on security and privacy settings at initial download or upon user request, after satisfying user security prompts. Emperor nodes contain multiple communication layers in each stream, dictating how the privacy levels affect the information sharing. Files on prime or adjunct nodes are sorted into privacy and sharing levels via appropriate streams, so that data is sorted in the user's device primarily rather than the emperor node.

Information is ordered by the user nodes before transfer to an emperor node. This reduces flooding/jams etc. occurring at the emperor nodes. The information and tags are attached at the origin user node, and sent out in stream, either directly to another device within the user's own network, another user's device or node set on another network, or to an emperor node, or a combination there of, either via the Internet, or bounced in secure packet via mesh computing configurations.

Messaging via the node network works either in a standard sever setup, with the emperor acting as a normal server, the users designating their emperor node to hold the messages until they are online, and then the emperor node either passes on the message to the user node, then deleting the information from its storage, or holds it until the user deletes it Messaging can be directly to another device within the user's own network.

Messaging can also be directly from user to user, either via the internet or bounced in secure packet via mesh, as the dual update stream pauses sharing when not online or in a mesh configuration. Users can act as their own servers and the actual information doesn't necessarily pass through the emperors. If going via the emperor node, it informs the user node of the tool rose node ID and bounces that to the IP and the device that is requesting or sending the message, unless using a proxy mesh bounce, then the emperor has no access and the message is bounces across varying networks. Emperor nodes don't necessarily hold the information; they can deflect it, just holding a tag, that a user is online or active in a mesh (unless there security is denying that) or that there is information waiting to be sent from a set user (unless hidden and proxy) to another set user, or that there is information waiting to be collected by a set user, etc.

In open document streams for collaborative work with select users, each user could be highlighted in selected color coding or different type faces for identifying different people in collaborative work environment.

What makes the tool rose node structure different is how each node can chose, what part of a file, how to share it which other nodes regarding privacy levels and how much to share, no node in the system is passive, control is in the hand of an end user; it is not a purely in an automatic program, though a user can chose to use presets.

Users of the node system also have sectional prioritization of files i.e. depending on how the file is broken to component pieces, or fractured they can chose to download, or seed those sections first—they can also choose to seed or leach from distinct users or networks.

The Emperor nodes are hierarchical and their indexes are duplicated across all emperor nodes, and each emperor has a secure store. The way information is shared and sorted is decentralized and dynamic, as user nodes can share directly, and the user nodes hierarchy can change (prime/adjunct). Users have additional dynamism via security and personalization of sharing so they are in total control of what information is seeded, leached, or bumped via their personalized networks. The emperor dual super nodes are continually online, and are the depository of the initial program, the origin index of users, a backup of open data, and a streaming key source for copyrighted material. Emperor nodes can also bounce seed information across the decentralized user network, via Wi-Fi/blue tooth or other types of communication (i.e. mesh.) etc. if desired.

In another embodiment, the emperor node can stream a key code for copyrighted material at the same time as the material is being streamed, downloaded or after download. The key code can contain a timed lockout, and automatic scramble after a set amount of views (i.e. rental etc.), and an automatic delete, a scramble at an attempted hack, or unauthorized share, and a limit to sharing with adjunct devices. If the file is opened or played using the tool rose with the emperor node system, and a key code is used to protect a file the node would send an alert, as a scrambling if a hack is attempted, or if the file is attempted to be removed for the tool node stack to a different file for viewing out of the tool rose. Multiple users could use one initial Prime ID, and each be an adjunct within the group network to try and get around the copyright share, but as a purchase of copyrighted material would need to be paid for, this would require trust with the users regarding transaction details. The owners of the material can also set a diffusion share amount, so only so many adjunct nodes at any given time may interact with the material, and/or set a biometric identification interaction feedback to authorize the file interaction, so a specific user must be present, in furtherance the copyrighted material would hold the specific biometric data, and would not stream the access code without the biometric key authorization.

As nodes could be on any device, a wide variety of hosts could serve as a node. For example, a vehicle or vessel could be configured to act as node, or carry a node, and those nodes could be used for anonymous proxy\mesh bouncing of information.

The prime nodes are the initial designation to any user on the origin user device. A prime node can be on any device chosen, but it is recommended to use a device with a good processor, relatively high RAM and storage capacity as it would be the user's primary storage for the tool rose lexicons and files.

Each user on a device may have private and separate node files, and a device could be one user's prime, and another user's adjunct (or prime), depending on who was logged in. The node files are encrypted and as only one user could be active at any time, the device only shares via the node system as the logged on user. However, all open device files could be shared by the user, with the exception of copyrighted files, which are secured to one user. Though configured as primarily decentralized networks, users can store and stream information directly from emperor nodes, and use any mix of personalized stores and emperor node stores. Thus, users may use an emperor node for storage and for indirect sharing with a specific other user.

The emperor node system is an organized, decentralized network. Each node is super node. Churn is not an issue as emperors provide stability as they are like cloud-based servers though each has a separate hierarchical designation. Emperor nodes prevent information request flooding as search is channeled through selected private networks, and directly through the private networks, and emperor nodes, the meta data and tags are searched, not the files directly.

Users can de-link from emperor nodes, as each prime node keeps a copy lexicon of the prime node user's friends and networks, filtered by set degrees of separation, social networks, profession, trust, and/or participation history and the like. User identifiers are not reassigned if someone leaves an emperor node; they are placed in a dead stock cold storage file.

All open unsecured meta data tags, user tags and open files are stored on the emperor nodes, when a user makes a query, they decide where to search, i.e. which network, what profession, trust level, what type of tags, any open emperor, google etc.

Standard tool rose preset is to download by degree of separation, or direct from emperors. In a tool rose search, the meta data is searched first for speedy results, though the users can specify files or full websites to be searched also.

The node system can work without internet, and function via a mesh network or cabled connections between devises, as long as the node program is shared between the devices, (i.e. could be uploaded to a device by blue tooth or USB stick, etc.).

User identity (as in origin code number) within each network is permanent (unlike standard p2p torrent), but a person can have multiple identities depending on network security+(i.e. what identifiers are required in certain networks as acceptable identification etc.) in multiple networks. Each user identity on a device has a separate encoded node file so each login would open the appropriate user file. If required at each logout, either all or some of the information and files could be cryptography spun on the devise and a unique code as well as the user name and log in password would be needed to unlock it. Secured user files could not be shared out of a tool rose individual user file unless authorized. Unsecured files are transferred from the tool rose to the base device to be shared with all device users, and, though the files may be unsecured in the tool rose, they may still be encrypted.

At first download to a device and opening of the tool rose node system requires the user to give system authorization as a required security measure, and needs the users to say which, if any (or all) files the tool rose could access, and which base presets the security should take, the automatic presets are at the high security end. The user selects which files to share. A new file when opened has the option to be shared and at what security level, or in which network, which is useful in a collaborative edit of a document.

Each stream shared within the tool rose has its own file, which may contain multiple files. A file may appear in multiple streams. The tool rose may search within the users the open files or appropriate network and security open files within the tool rose files, but may not search the device unless triggered by the user as a security caution.

Meta data tags are placed on files based on an x/y or x/y/z as well as general contextual analysis. All nodes connected to emperor nodes have a set security stream, and a junk stream so corrupted files would get moved to the junk stream and the user would be notified with an alert Also before an open file could be shared by new users for the first time to the node net the tool rose scans it for viruses etc. Trust would be earned with time, and clean public uploads, and highly trusted users open might not have a full security scan. 78.) Node selective streaming by buffering priority parts of the files for example; 3 friends prioritize parts 1-2-3 of the file, such as a film, form either the internet, or from distinct networks, they then share that file within their group network, to a chosen device on one of their networks and they all stream the file directly to that This is useful for areas with low bandwidth, or for limiting data charges over standard mobile phone networks.

If in the node network utilizing instances of the tool rose, the nodes are hierarchical, as an emperor node must designate an initial user's code and store it in the node net lexicon on all emperor nodes. If in a private network, there must be an emperor node to designate the identifying origin codes to other nodes, but each node choosing to contain a network identity lexicon can become another emperor are any time, each emperor node having a differing identifier with which prefixes and designates the new node, the emperor node either designating the new code to the node based on physical location, or numerical IP address proximity. However, a network could break away from the emperor node network and not designate a new emperor, it's just in that situation there could be no new devices on that network without adjusting the identity lexicons.

The each node can control, or supervise the information that it acquires, or passes through it, and can designate privacy and content sharing levels with all other nodes depending on user preference. The only information that is not controlled is the encrypted spun proxy bounce information, but the user can choose not to participate in that form of information sharing.

The nodes can send standard files, or torrent structured files. Each user has a prime (first contact with origin code if on tool rose net) and further adjunct nodes linking their devices, this relationship is flexible and can change at the users prompt. The decentralized dual client server super node system, where the dual client server super node system acts as a router via the internet, the interprocess communication application layer controlling the client which is also the server, process synchronization and data synchronization via multiple user devices using torrent shared meta data, and or file sharing, each end user device possibly acting as a tether for any other in the user network, each device having a unique identifier within the user network, possibly co-opting a mac address along with the designated unique identifier dependent on the end user security choice.

User's nodes do not share streams until lodged in to the program with passwords or other identification. Access to each user's stream node is dependent on the user's password and or access code or other identifier; users can log in on alternate devices which have the node network platform.

Each node has a secure user file (or files) which are password protected, depending on the security settings, set to scramble or destroy themselves on an attempted hack. When someone logs in to the node net on a new device, the current device becomes either a primary dual torrent node, or an adjunct dual torrent node depending if the user already has a UI which they choose to use, they might use a standard identity or an anonymous identity (as previously described).

A user can state if they are guest on device and the nodes becomes a “temporary adjunct node,” and set the node to automatically delete user file on log out This enables the user “guesting” on a node, to choose to share a specific torrent or file, or check their messages. The user can pre-set which streams or files to access, or share on a guest adjunct node via their primary dual torrent node.

One can have multiple users per device, but they cannot be logged in at same time, each as has a unique identifier and file. Users can change primary and adjunct node designations, by deleting primary, the subsequent adjunct would then move up the UI hierarchy, or assigning an alternate primary, though each device would have to authorize the switch for security reasons if adjunct status.

Each primary dual node is set in dynamic alliances with other primary dual nodes (except the emperor node UI), at the users pre-sets. With this system, each user can share specific files, and have a private stream of messaging with another user or users.

Users can change their public user name, but the emperor node maintains the initial original UI attached to the users identity. A user can change an Emperor node from a “home” designation when moving location, though they maintain their original UI. As Emperors are location aware a user can chose to use another emperor to run a location based search.

Each node, and each torrent or information stream within the node, performs a dynamic cyclical A/B update system previously defined. One can set the nodes to share files to specific streams or other nodes automatically, or manually, and each stream has specific affix.

With the location and proximity aware aspect to the nodes, (if user security permits) when the user is connect to a local emperor node through an IP (or GPS marked mesh point), their address is noted. As the nodes also ping other user nodes, this combined with signals from other meshed devices, GPS etc., can lead to extremely accurate user triangulation, which would be useful in an emergency situation, or when trying to meet friends etc. The triangulation functionality of course depends on the security settings of the user logged in (the torrent sharing this can be paused, edited, or deleted), or if the user is using an anonymous ID, in those cases a proxy node host can randomly distribute the user before connecting to an emperor node, so they remain-A anonymous.

Using the node network for shipping is the same set up as a standard tool rose node net except—co-opting the IMO* and the ships name and/or National, or Open Registry Vessel Registration details into the tool rose Unique Identifier at initial registration with an Emperor node. Global port authorities to act as emperor nodes, each ship acts as a prime or adjunct node, the headquarters of a shipping line, that would be an allied emperor, though each ship would have the initial emperor designation of its home port, as well as any line designations.

The purpose of the node net is to share relevant information, a specific use for the maritime node net's would be warning other ships of dangers, such as bad weather, pirates, dirty fuel, icebergs, unusually large oceanic debris (or growth or movement of such) such as the great pacific garbage patch etc. In sharing information between a shipping line and ships, multiple update streams can also help manage fuel requests, personnel updates, maintenance details, etc. Each type of data stream can be collated and this would help general logistics at head office. International Maritime Organization (IMO) is a unique identifier for ships and for registered ship management.

The tool nodes have a set stream file for tags. The user's public name, tags and files can be set to be only viewable along degrees of separation, or by set degrees of trust, profession or set networks.

If a camera is location aware and connected in the tool rose node net, in a transportation setting, a tool rose connected to a screen or projection unit in a vehicle could request a tool rose on another vehicle to share its camera view or views allowing a user to choose an appropriate travel deviation. Each validated tag and cross connection to be a “thread” of information in a hub index, multiple users validate tags threads by positive or negative interactions, (i.e. in visual terms add to thickness+color of threads) enabling a tapestry of information in the Emperor nodes. The amount, and type of cross connections that are placed in the tags and open general information files meta data codes, the hubs organize and weave the information threads enable the emperor node to learn. Each tag thread at each validation by a user to gets “thicker” i.e. climbs a point per user in the hierarchy. A user can choose to just see or search different types of threads or tags. As each wave of tags or other information ebbs and flows, the web of connections is visualized.

As users maintain in their nodes a history of what the user has tagged, when changing the privacy in the users node, it sends the signal to other nodes which hold tags and files, all nodes holding tags below the new privacy threshold delete the information. A user can set that all or partial tagging information is only shared when they are online, so enabling full control over their information. If a tag has been held at an open public level for a specific length of time, the emperor node shifts it to a permanent public tags hub. The files, and tags are held by the nodes, not by websites, and a website can request open permanent public tags from public emperor nodes and also host it in site meta data.

Trading and Trading Streams

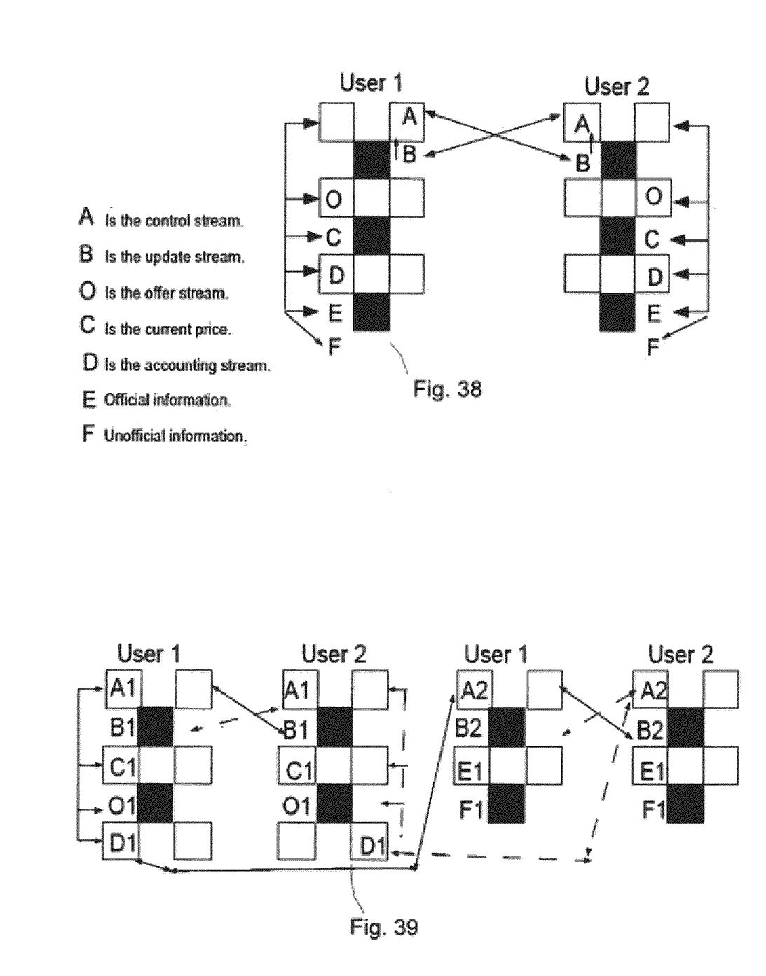

FIG. 38-40 represents various data streams utilized in a trading environment using the node networks described and illustrated herein, when configured as a private network, or networks with consistent security and identity requirements. An open exchange could be organized using the standard node net structure with full proxy possibilities as long as the preset of the exchange network would allow that

Users could either use a clearing house to run limits on trades available to users via a prefix to their unique identifier, or a timed and, or price limit on clearing individual trades could be set automatically in each network before the user would be blocked, for example in a network with a one-hour, and $1000 limit, any user trade could not have more then $1000 outstanding within an hour, if a trade was not paid within the hour, a user would be blocked automatically and would be blocked till payment was cleared, and if a user tried to complete multiple trades before clearing debts of $1000, they would be blocked.

In a closed private exchange, the exchange company node network would have the control of its emperor nodes, and those could shut down or block trades if necessary, by sending a blocking signal closing access to the network to specific or all nodes. The organization running the exchange is the emperor node or nodes, trading houses act like prime nodes, trades can be carried out by trading houses on the behalf of users if the users wish, or users can register with the emperor node as their own trading identity, all subject to the exchanges rules and regulations. The proxy system would work not work in the standard way in the emperor exchange node system, as the emperor node would

maintain full knowledge of the individual trading users' identities, and of the trading houses. However the trading houses could run and assign adjunct user proxies, as they would be liable to the exchange. The emperor updates all attached nodes and all attached nodes updates the emperor and all others they are linked or programmed to. In either structural exchange, each joined set of updating data streams within the node is a particular stock, commodity, currency, or other trade able item or items. Each time the item is bought or sold, the data streams are updated, each transaction order has the

unique identifier meta data tag of the node, the users and a transaction code (the transaction to be the stock/offer/time/price met etc.) attached to enable accounting. There are two open data streams (or torrents) for reports on the stock or commodity, one stream for only approved reports (i.e. CNBC/Bloomberg etc.), one for unapproved reports (i.e. general users), the reports can be tagged by all acknowledged users as to the veracity or accuracy of the reports, a user or organization can get approved by either requesting the controlling organization that runs the trading network, or users crowd requesting an approval to upgrade a report, reporter or organization. Torrents and, or standard data streams can be locked to certain users, and or passwords combined with set unique identifiers as multi path routing is possible via selected user nodes. This enables private trading if so desired, and approved by governing bodies, with this the users or organizations can choose to only trade with specific grades of securities, users, or organizations etc. via their privacy settings. This would be convenient with certain trades i.e. pension funds or trusts being only allowed to trade with certain quality of investments or users etc., for example no trades with arms manufactures etc. Each transaction is given a specific “time stamped and combined users unique identifier transaction code” as the transaction tag and a “tag payment pass code” to be given to the seller and buyer, after the tag is “paid” and acknowledged as paid, the accounting torrent is updated to the “tag history data stream, or torrent, with this facility a clearing house identifier if a clearing house is being used by the user would be added as it would be part

of the users identity code. The clearing house's unique identifier and the amount the user was enabled to use would be affixed to the user node unique identifier. If a clearing house was not used, at the discretion of the exchange, a user's trades could be limited by cost, and time, i.e. the user would only be able to trade x amount till the money owed was cleared with in set time limits, or there node account would be frozen and the user blocked. A possible stream set up would be as follows. The cyclical update information conjoined stream sets elaborated previously and in FIG. 38. An elaboration of the A and B dual cyclical update is as previously described. The B stream of users 3802, 3804 updates each other's A stream and the A stream updates everything including another user's B streams, the other streams update the B stream when new information is received from the user. The B stream is the stream which is most scanned for incoming security risks.

The C stream is the current price stream, which averages the difference between buying and selling orders and completed orders in the offer stream. The D Stream is the accounting stream, with cleared and outstanding trades, unless a G stream is used, then it only contains outstanding orders.

O is the offer stream, when a user puts in an offer for a set amount of shares etc. at a set price for a set time, and for a set amount, the offer is time stamped and attached with the users and nodes UI, it can be set to be live only for a specific time, or to become live or inactive during set parameters. This stream would contain passive orders, stop orders, stop limit orders, hidden limit orders, pegged orders, and executable quotes etc. It initially goes in the users own O stream which updates the B stream, which updates to the A stream and is then sent to other nodes, and when/if someone agrees then their UI is

attached to the offer, and that offer is updated to the D stream on all nodes. When an offer is put in the identifier is different for each type of offer, or order, each has different affix, either a prefix or suffix, depending on programming. The interface can be programmed to alert a user if a trade offer within set parameters is uploaded. The E stream is the verified information on the item such as a stock report The F stream is unverified information and tags. The F stream contains the user tags, as well as reports and all other information. With the information tagging and negative search system previously described, this adds considerable functionality, as dismissing what is not desired is very important to receiving relevant information. A user could set an alarm on their node to notify them automatically them when a specific stock, commodity or the like is tagged, or reported on by a specific user or organization, or set to gather metrics of positive or negative tags or other data on a stock or any other item. Of course the alarm can be set to monitor general or specific price movements in the stock. The G stream or transaction history stream, is not necessary, but can be used to maintain cleared orders, and keep the D stream lighter. The time stamped UI meta data tag is attached to the order “transaction history,” the “payment needed” part of the code is updated to “paid” when being updated from accounting to “transaction history.”

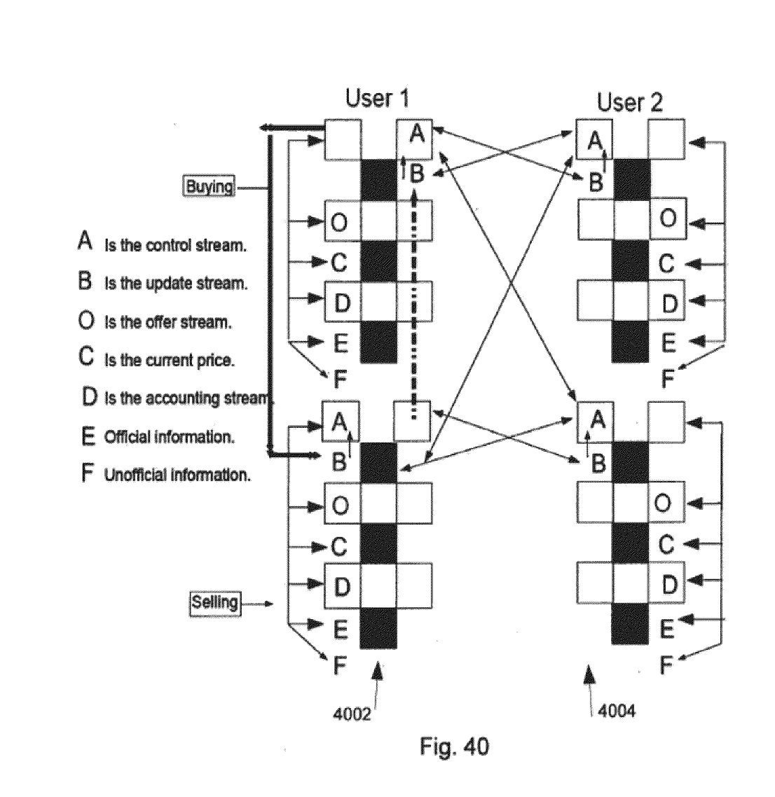

Users can choose to limit their access to data in the D/E/F/G stream via their node controls as previously described. For example a user could choose not to receive data on closed trades unless there part of users own history. FIG. 39 shows a scenario where the stock segmented in to A/B/C/D streams as described (reference numerals 3902, 3904), and A/B/E/F streams (reference numerals 3906, 3908) that enable the buying/selling to be faster as the A/B streams would only have to update those transactions in that stream set In the visual interface C would always be visible by preset, but the user can chose which other data streams should be visible. An alternate version shown in FIG. 40, shows buying and selling as linked separate stream sets (4002, 4004) cross updating with buying made out of A/B/C/D/O/E/F stream and selling made out of A/B/C/D/O/E/F stream, cross updating.

The node network architecture described above is useful to facilitate communication between air traffic control and aircraft, and between individual aircraft Communicating updates via a private secure node net via TCAS, ACAS, ASAS, ACSS, FLARM, GPWS, AIS-P or any, or all mix of the systems, or any other appropriate guidance and location system. A control program may be used to integrate and coordinate all necessary information relying on a similar base system as a standard node net.

An aircraft's unique identifier is based on initial emperor node location where the plane initially joined the network, combined with make and model identifiers, the tail number, and the flight code. The flight code is the part of the UI visible on the node net visual interface. In an embodiment, air traffic control towers are considered the emperor nodes. Emperor nodes overlap, then update and switch control of the data flow, as the planes move in the airspace of a new air traffic control tower/emperor node. Air traffic emperor nodes continually communicate with each other, and local emperors update flight updates and each communication with the plane to a hard data stream.

In an embodiment each aircraft is a dual node, each information stream of weather, location, velocity etc. is a data stream. Each plane is linked to as many other nodes or data streams as necessary. Each plane set to notify either just the control tower, just other planes, or both, depending on of the system used (i.e. TCAS, ACAS, ASAS, ACSS, FLARM, GPWS, AIS-P) etc.

As a flight would cross multiple air traffic control zones one have A/B update stream of the air traffic nodes communication as one stream, one would have at least one other A/B stream containing the flight engineering data of the plane, such as fuel consumption etc. though most likely there would be multiple streams with specific engineering data, and on board passenger data etc.

A plane could run three node versions:

1.) No tethering at all through the plane.

2.) The control prime plane node with the flight information, and an adjunct node set to act as a routing tether for passengers via the node net This would have the passenger's devices set as adjunct temporary nodes during the flight and allowing mesh communication between the passenger nodes on set frequencies within the plane adjunct node, or not depending on safety needs. With the prime plane node always having the ability to turn of the adjunct node if required, and the only data stream between the plane prime and the plane adjunct tether would be the amount of the data usage.

3.) Both the plane prime node and the passenger tether node run as completely separate nodes, with the routing tether having a separate control in the cockpit, so the plane node is a private system.

In furtherance this type of tethering node would be part of the “plane safety” mode currently used on air crafts by mobile devices, and would allow voice, email etc., this would benefit passengers and as the Wi-Fi is under the pilot's control, and s/he could limit passenger usage manually or set an automatic limit before it passenger usage would clash with the planes systems.

The node net is particularly useful for coordinating logistics and supply chains, either back end, front facing or both. In a front end client facing with potentially each client a node with a direct payment system, the store/company can personalize and advertise directly to the client depending on the user's security settings, and organized their ordering system based location aware sales. A possible conjoined stream setup could be as follows.

A/B as described

C stream—Client Product History

D stream—Advertising

0 stream—Ordering—i.e. from wholesaler or from factory

D steam—Accounting

T stream—Transit time of item i.e. time of order, manufacture, transit, and time it took to sell. These stream sets combine with the clients own product history, the logistic companies, the manufacturers, store buyers, and the accountants.

In an embodiment, each user and product has specific tags affixed to their unique identifier for company usage and the streams being searchable for various type of analysis. Another example would be a construction company utilizing the present invention for accurate timing with suppliers and workers on a construction project for the greatest efficiency, and coordinating with the clients for their specifications and authorization, and communication updates. This would cover a supply chain and a basic plan of works for new build, i.e. planning consent, the flow plan for deliveries, the staggering of the contractors and subcontractors i.e. builders, roofers, electricians, plumbers, carpenters, painters and decorators etc. who desire coordination with each other, suppliers and the like. Each stream set would be one project, though specific files could update further stream sets as required, and set by the users.

In an embodiment, a stream configuration includes:

A/B as described.

C stream—The inhouse file sharers, such as architects, engineers and the like, working on a project This stream can easily update them on progress of works and specific details.

D stream—Client Update—including build plans, design etc.

E stream—The contractor and subcontractors.

O stream—Orders and updates from suppliers—i.e. craftspeople, wholesalers, or factories etc.

D steam—Accounting.

T stream—transit time of item or items i.e. time of order, manufacture, transit—this stream is updated by the manufacturers also, and could be automated to indicate if an order is to be delayed and to update the relevant subcontractor.

In an embodiment, there are stream sets dedicated to a normal file update, and each contractor is a unique stream set, if desired by the end user.

Similarly, in another embodiment for a retail setting each item could have a standard battery-based or Wi-Fi-rechargeable mini node attached in manufacture in which the item's UI is preset to the brand or store as an emperor node network, each item's UI acting as a guarantee of authenticity, and each end purchaser adding their details or their pseudonyms to the UI of the item at purchase, or at their convenience, this could allow the item to ping (via Wi-Fi, infrared etc.) the store to greet the customer at entrance etc. If a purchaser bought multiple items they could directly accrue loyalty points from the brand, and depending on settings the item could ping other items of the same brand to enable real world brand interaction, which would be most interesting for brands such as multiple items in a collection opening special offers or interactions, or offering details of interest to the user. This would also work with security, as the item would be registered to the node of purchaser (or officially transferred to a new user/buyer), if the item were to be stolen, the official owner could alert the brand and authorities, this would enable an alert to be sent out. If the thief disabled the node on any item not interacting could either be highlighted and relevant authorities might be able to use this as probable cause to search. A person could also use this system to know if an item was authentic, stolen, etc. If a person wished to be anonymous, they could still register the item under a pseudonym and proxy, ask not to be tracked by the brand, and or require the brand to use a proxy UI or to disable the node. In an embodiment, the brand e-node would keep select UI's back for proxies as described previously, and proxy UI's in branding could be set to shuffle on store entrance to maintain anonymity etc.

Energy distribution network using the node net streams to facilitate direct communication of usage, from end consumers to the power plants. Usage updates to go directly to power plants, and to transmission companies, analysis is done by coordinating data. With user nodes having a origin stream from the electricity company, coordinating with the electricity meters at users home (or work), allowing greater analytics and instant usage updates to the power plant.

The node system of stream interconnections between power producers, and consumers ensures that power can flow more efficiently via analytics. Transmission and distribution losses in the USA were estimated 6.5% in 2007. In general, losses are estimated from the discrepancy between power produced (as reported by power plants) and power sold to consumers.

The power plants are emperor nodes, transmission companies are primes, and each end user is an adjunct, in terms of designations for unique identifiers. This end user unique identifier designation would either be stand alone in a closed network, or it could be affixed to the user's prior unique identifier from another emperor node network which has the same identity and security identifiers needs as the electricity network. With the user nodes possibly further split and each user device being further adjuncts is possible to show device usage, and each mobile device could power up from designated points at set prices, with billing to be set with previously coordinated contracts, or unique usage at sales points, this would be useful for filling electronic cars etc. Water, waste, and gas distribution may have similar stream set functions as electricity described above.

Another use of a secure private node network in accordance with embodiments of the present invention would be for emergency services. Emperor nodes could represent police or fire stations, hospitals and the like, and each user node associated with a person serving as an emergency responder.

All emergency services emperor nodes could further update a command emperor node for coordination in emergency situations, with specific communication streams running between emperor nodes and other nodes. Each station and each individual responder have secured individual communication stream, as well as open secured information streams between officers, all official communication would be stored on the local emperor node.

An additional difference to a standard node network would be that each car, truck or ambulance etc. would be the equivalent of an adjunct node to the initial emperor node, not to a user node. A user's unique identifier designation from the origin Emperor node may be stand alone in a closed network, or it could be affixed to the users unique identifiers from another allied node networks for ease of linking and managing information streams, depending on the users wishes regarding privacy etc. For example a node could be logged in to multiple networks i.e. both professional and personal, as long as the security requirements are met, so the information streams could be updating continually, and in furtherance each network streams could update an individual tool rose, or be each stream could be color coded in a single tool rose, or an individual petals.

With a torrent-based automated integrated traffic management system, bringing benefits to both private vehicles, autonomous cars, and public transport systems, exploiting the ability of the node net to reach users, and key devices, such as video cameras, stop lights, or other notice beacons for transmitting information. With the dual update notification and the homogeneous spread of up-datable information of the node net enabling private auto-mobiles to avoid congestion or accidents, reducing risk of accident, as well as speeding up journeys and improving traffic flow. In the case of buses, speeds can be adjusted to maintain schedules and avoid bunching while trains can be informed of dangers up the line.

Integrating public traffic management with private users to maximize efficacy of information, allows users to directly update personal inputs to the traffic information network, allowing user proximity to accurately predict traffic, such as public buses etc. Allowing satellite navigation and weather forecasting, and proximity pinging rates from users nodes in traffic (if the user node is a vehicle) in planning journeys and then adjusting routes in real time as events unfold. Adjusting dynamic message signs, roadside information transmitters, traffic counters, and automatic incident detection equipment as needed for smooth traffic flow etc. Automated vehicles sense their surroundings with such techniques as radar, GPS, mesh communications between nodes, advanced control systems interpret sensory information to identify appropriate navigation paths, as well as obstacles and relevant signage. The dual stream node net would enhance this with location pinging from all open users, and other vehicles. Direct private user information enabling the public transport network to be truly dynamic, and updatable.

The AB node update is the update stream set with unique identifier (UI) designated from the origin emperor node and a time stamp on a piece of meta data of when information is uploaded to the stream, which the node reads first, each times it updates or checks the stream. The update is hierarchical and dynamic, each time there is an update i.e. a user adds a file, joins a new group, community, changes there degree of separation etc., each piece of information affected would be notified vie the users UI and them spread across the node network, and be altered on all nodes. Even anonymous information files have UI's though the users are not necessarily personally identifiable apart from their sharing history.

To get a truly anonymous UI one would request the UI from an emperor node, as the emperor nodes may keep set percentage of pseudo random selected UI's for anonymous designation. These are shared with other emperor nodes and using a pseudo random number selection process.

The pseudo random UI's are mixed and re-designated to emperor nodes, with this the anonymous UI is not linked geographically to a set emperor node and the initial geographical location of an emperor node would not affect the proxy UI. The emperors shared stream of anonymous UI's is re shuffled at set moments and the remaining anonymous UI's are re designated. Each time an emperor is formed, the other emperors share their remaining anonymous UI's and they get re shuffled.

In a payment system using the node network of the present invention, for added security one could add scent and color as additional keys on top of any numerical, gestural or biometric keys.

The user UI is always affixed to a tag they place, however they can chose to use one or more network UI's affixed to their tags if logged in to multiple networks, the networks UI's affix to the users standardized tag base definitions on top of the standard tag and the word, phrase, image, or sound attached. Base definitions such as original language (i.e. English/Spanish etc.), semantic language i.e. regional slang with emotional context, professions, emotions positive and negative, identified or unidentified user, weighted respect for profession, weighted trust within network, average weighed trust between users such as how often a person trusts to what degree and how their opinion is trusted by others, semantic node computer generated tags due to subject or item analysis, and tag grid positioning. For example a user's origin emperor node is Alpha node network (ann01) user unique identifier is ann01-579-(15491014) (the last bracketed digits being the time and date stamp. For example, (15.49 October 14th) and the user has also logged in to Beta node net (bnn02) unique identifier bnn02-234-(18331115), depending on security and privacy their tags would be shared with both networks as ann01-579 and bnn02-234 or if the networks were allied the user tag could be only ann01-579 as the user joined that network first, and allied networks could share UI's. An example of a user tag for the word “funny” could be ann01-579-SallyBN-001-000-000-111-022-1-1-10-0-58-3G-funny-security settings privacy-file name-location-website, broken down it would be (Network ID-User UI-User Public Name (SallyBN)-English 001-no semantic meaning 000-no profession 000-identified user 111-respect 022-liked 1-positive 1-trusted by 10 people-distrusted 0-Look at 9/43/59/63) Data streams can be set to continually and randomly swap servers and/or nodes identities in a private proxy server network, so the information can be shared/hosted amongst a private network. For example if the data stream is a website, the standard internet portal designation hosting would be switching between proxy users, who log in to the network via the tool rose node. In furtherance, the information or “website” would be a data stream with a private designation, the UI possibly set by a user using a private proxy anonymous initial registrar and the UI and access to be shared in a select group, some who are chosen or agree to proxy host at pseudo randomly select times, which can change to random at a member users instigation, interaction with the site or file to be different for a “host” user to a general user. In furtherance the UI would be dynamic, as the server, or servers hosting the site would be dynamic. The site would be found via search for the site stream code name if open, or by invitation, by individuals familiar with the original UI, name and privacy setting etc.

Data streams can be set to continually and randomly swap servers/nodes identities in a private proxy server network, so the information can be shared/hosted amongst a private network. For example if the data stream is a website, the standard internet portal designation hosting would be switching between proxy users, who log in to the network via the tool rose node. In furtherance, the information or “website” would be a data stream with a private designation, the UI possibly set by a user using a private proxy anonymous initial registrar and the UI and access to be shared in a select group, some who are chosen or agree to proxy host at pseudo randomly select times, which can change to random at a member users instigation, interaction with the site or file to be different for a “host” user to a general user.

In embodiments, the IP is dynamic, as the server, or servers hosting the site would be dynamic. The site would be found via search for the site stream code name if open, or by invitation. The person or persons familiar with the original UI, name and privacy setting etc., could allow further user limited abilities in hosting or managing the site streams. The site stream could be replicated on multiple nodes continually updating one another. The site stream could be replicated with a new UI if the full information was shared by one of the originators of the site, though it would have a new UI. With this set up, the website would be invisible to the internet within certain security parameters or visible and hosted on a static server if desired.

The origin emperor node acts similar to standard server regarding messages, though the user can designate a new emperor to act as their “emperor server” and if the user changes their physical location for longer than a set time, for example two weeks, the node prompts the user to verify if they wish to change their local emperor to this new locale. If the user agrees, the users files stored on their previous emperor are transferred to the new emperor.

The meta data tags are shared across the emperors, but not always the complete files—if a file is requested in a local often, and it is not in the local emperor, the local emperor retrieves it from another emperor or emperors containing the file or files. If a user requests a file from their local emperor which it does not contain, the user is forwarded to either an open user with the file, multiple open users, or other emperors, or a combination of both emperor and user nodes. For example, when a new single is released from a world renowned singer, its file, due to high demand would be replicated across multiple emperors and depending on copyright and settings from the origin publisher; it could also be shared across user nodes. In yet another embodiment, publishers could allow open streaming with a scramble on the file if an attempt is made to open the file without permission.

In an embodiment, each node has information streams, and stream sets. Stream sets are interlinked updating streams with multiple files, stream sets can also be interlinked and grouped, for example a user might set a tool rose as an accounting rose, each type (such as mortgage, utilities, food, transportation, clothing, further refining to which store, which credit card, loyalty points if any, and the like) of expenditure could be set to a select petal, and each would be a basic updating stream or stream set One petal possibly showing the amount, one the percentage of expenditure etc., one showing the net positive or negative of the periodic and prospective expenses and income etc., the multiple streams combining to feed the tool rose the information and update the averages etc.

Selected streams from individual stream sets can form new stream sets. For example, a node would form a new messaging stream set by merging multiple streams from multiple users.

In an embodiment, there are four main structures for holding tags or files that are dependent on the user's security settings. All user tags are maintained by a user's node, and all emperor nodes. All user tags are maintained by the user's node, and the local emperor. All user tags are maintained by the user's node, and specific private network emperor nodes.

All user tags are held by user, and are only visible when a user device is online and streaming. As user's tags contain their UI, the user can delete all user tags at request from any one of the user's nodes dependent on their security settings, or they can or selectively delete certain tags, or change the degree of separation etc. Though all tags and meta data shared to an emperor node and (dependent on users settings) will be indexed and used, the open files may not be, dependent on the emperors own security or usage settings.

The tool rose interface of the present invention is now discussed with reference to various embodiments and figures. The tool rose can be visualized and or projected in a 360 degree way, and maneuvered to show different sides, with each segment or panel opening to show further information (like an orange or puzzle box), this real world 3D memory can aid file placement recall. The tool rose can be multiplied in to various specialized versions of its self, in 2 or 3d, and be moved to preferential position on a screen and rotated, or if projected it can be rotated, either via voice, gestures, touch, or moving a cursor. The tool rose can change the direction of its input to suit multiple language formats, such as standard western alphabets (i.e. left to right), Oriental (up to down), or Arabic (right to left) so native ways of communication are not disrupted as each way of imputing information is different The tool rose segments can be set to vibrate, ping a noise and/or flash different colors and at set, or different rhythms (such as accelerating in urgency), so as to alert the user when a message or notification comes in, such as a program has finished its task, a communication is received, or as a set alarm for an appointment etc. Different rhythms of vibration, flashing or noise can be used to notify different programs, people or urgency. In furtherance, each petal of a tool rose can be updated by a designated stream, or multiple streams, and each stream can be set to a specific node or another user's update news stream etc. In elaboration, a notification can also be an alarm, such as a flashing 15, then 5 minute warning for an appointment, each warning in a different color or tone, or the time remaining in an auction etc. The segments of the tool rose are dynamic, and can be moved for personal optimization of the user experience. The tool rose can be set to be opaque or transparent like a watermark, as this is easier on the eyes of the user and frees up screen space. The tool rose can have as many multiple segments, or multiple tool roses added as the user requires, as this is particularly useful for linked multiple devices such as linked smart watches, smart phones and the like, where the screen size is even more important, (with a tool rose node network ideally) and the user device could call up a tool rose segment from a higher-ranked device with more resources such as memory, storage, processing power, and the like, or additional node devices. For example a smart watch could have three minimal versions of the tool rose present, linking with further major versions on the phone allowing to synchronize certain files directly via Wi-Fi, Bluetooth, or the like. The tool rose can be either a platform and operating system controlling and linking multiple devices in a heterogeneous manner, or an application program within a device's operating system like a browser/search program, or an application adjunct leaching on an existing browser/search, the information collected by the tool rose can either stored and or shared by the user on their device, or network of devices or contacts, or stored on an external server (such as the dual node system). The information collected, such as various file types, or other data, can then either shared directly via the program, or optimized for various devices before sharing. The information automatically syncing across multiple devices and networks depending on the users presets. The initial basis of the information can also be identified and optimized either automatically or by the user (via tagging or allowing heuristic analysis) to aid search, security, or payment, for themselves, their network, or the rest of the community depending on privacy settings of the initial information sharer and the end down loader. When the user saves a file, they can choose 1, 2, or 3, etc. primary sites (and or devices) and/or multiple (ghosted) short cuts to aid cross referencing in search. The tool rose has functionality for automatically filling and cross referencing tagged or identified information, or information sources, across devices if user desired, such as creating a file containing all emails, text's, word files, photographs, etc. from either a select user or users, or networks, or using selected key words, or other meta data, thus enabling easier organization.

Selecting files to be short cuts/ghosts between devices, enabling full cross device access when devices can communicate, and allowing minor devices to maintain lighter hard drive use. For privacy, the tool rose may incorporate a geo-locator switch into the tool rose browser or application with an IP portal swap function operating via the nodes, or standard servers. Similarly, the tool rose may have a 2- or 5- or 7-page etc. back history delete as automatic privacy setting and have the application login to servers via multiple random proxy locations via the node net before starting browsing or searching. The user can chose a random privacy path, with a random end local, or have a set local (such as set to US, UK, EU, etc.). Also the users in the privacy setting can set or adjust how many proxy users or people can use their location, and what degree of separation in their settings if any. For example, one might allow a friend of a friend using him or her as a proxy, as there is trust that they are not doing anything bad, but would not want a stranger using him or her as a proxy. As each tool rose if it was in the dual node network described above has a unique identifier, information which was shared directly (if it was taken out of the network re-formatted and uploaded again, this would change tracking identifiers) could be tracked across the network and in the case of copyrighted files, each share would collect the identifiers. A file can be set only to open via the tool rose and only when receiving a streamed signal key from the origin server, otherwise the information could be set to scramble and, or destroy itself. With this copyrighted files could be protected. Information sharing via independent decentralized networks under proxy or anonymous settings would not always be able to collect and send identifiers to originators. If integrated with the scent system, alerts can also be done using scents. Each piece of tagging information shared via the tool rose to be rewarded with a non-decreasing point of social currency, the more open to the tool rose search community, the greater the social currency earned. In embodiments, the tool rose is user-specific, not device-specific, so to share across devices they preferably receive authorization passwords. In embodiments, the tool rose has individually illuminable petals, so colors and brightness or intensities can be assigned to the individual petals as the user chooses to configure them. For example, when a user is assigning a specific function, or functions, or stream sets to the individual petals. In embodiments, each petal has a pre-determined contrasting shade as a preset, to enable users to see the information layers easier. The tool rose, upon encountering an application, can receive instructions from the application as a preset on how to illuminate the petals, for example based on functions or controls used in the application. In embodiments, the tool rose petals can change illumination based upon how recently a petal was selected by a user; they can either fade from the most intense color or brightness when in use to eventually gray scale so that their color indicates that the petal has not been used for awhile. Frequency of use of the individual petals can be tracked by the tool rose, and the most frequently used petals can be shifted to a location on the tool rose that is most convenient to a particular user, for example to the left side of the tool rose if the user is left-handed, or into the center position if it is a larger area than the surrounding petals. The center of the tool rose can be a mode-change button that causes the tool rose to present a separate grouping of functions mapped to the petals so that a high number of functions can be grouped to instances of the tool rose. The tool rose can have a recursive property where, when you activate one petal or rose or roses, all the other petals or roses which are associated with related functionality are activated etc. For example, if you use the tool rose to edit a document, as well as listen to music, one petal or rose for the document editor and another petal or rose for the MP3 player. But when you select the document editor, while music continues to play over your device, all of the displayed petals are related to the document editor. Then you can back up, perhaps by hitting the center of the tool rose, and select the mp3 player petal that will turn all the displayed petals into mp3 player controls. Each program on the tool rose could be associated with set a color way—i.e. blue for work, word processing documents etc.; red for music, yellow for video, and the like. These selections may be preset, or defined by user selection. The symbols representing the programs or files on the tool rose petals are changeable, so that the user has increased personalization of the tool rose. They may either use standard symbols from the tool rose, or the applications standard images, or user's own images. The tool rose petals can be “pinned” open, and the tool rose can be left asymmetrical with the petals open for quicker access. This is especially useful for host devices having a solid state cache. By setting a specific priority notice for a person, organization and the like, the user is not notified on every message, just the important ones. Also a petal, tool rose or program can be set to open automatically when receiving a message, notification, or update from a priority person or organization etc. For example, a person could be waiting for an email, SMS, video, and the like, from a specific person or organization, and want to be notified immediately, in further elaboration a person receives an email with a spreadsheet attached and wanted an application to open the spread sheet automatically on receipt, as long as the security settings were open to this option from a specific sender and the programs limited to a select few it would be a convenience and not a security risk—another example a security software update could be set to automatically trigger a scan. In embodiments, a user may set multiple tool roses to different languages. With much of the world being multilingual it is useful to sort files into English and Spanish (or Chinese, etc.), for example, and have separate versions of a word processing program to open with appropriate spell check functions applied. Rather than just the petals expanding, or the tool rose being overtaken by a set of files, a user can instantiate a set of multiple tool roses i.e. one for documents, another for images etc. this could be automatic, or up to the user.

In embodiments, when a petal or rose opens a program or a page in the browser, document, picture, or video type etc., that controlling petal or its host tool rose is highlighted or enlarged to show that it is controlling that application. 26 B) The tool rose could be linked with a browser and all petals could be browsing tabs, each layer or color or size of petal to can be set to specific types of pages, i.e. top blue for news, bottom red social etc. As the tool rose can act as a node on a user's device, an action on any one device, tablet, jewelry device, desktop and the like can be duplicated on any other device supported by the tool rose once the user is logged in, as long as at least two devices with the information are capable of sharing the information i.e. via standard service providers, or via Wi-Fi, Bluetooth, infra-red, and the like. When the tool rose is part of the dual node net, it can use the user's open communication to proxy bounce information packets anonymously depending on the users security settings, i.e.—If the users device has Wi-Fi, wan, open Bluetooth, infra-red etc. or another open communication system, an information packet can bounce from one user to another in an open node bounce network, such that the user could set the information to be sent via degree of separation setting, or a specific network, so when the node spots another node within the parameters it bounces the information across as a zipped sleeper packet, the carrier tool rose node may, or may not be informed of the sleeper packet depending on their, or the originators, security settings, with the sleeper packet only opening on delivery to the appropriate tool rose(s) or node(s). If the user had logged in under a proxy, privacy request, the random generator would give them an anonymous location identifier, but the originator user must still must know the identifying code of the tool rose or node they want the information to be delivered to, or they could chose a specific network or emperor node to deliver the information packet to, but most users' security filters could typically be set to filter open messages as junk. The user receiving the private massage would be able to respond to the anonymous tool rose. With this system the users can use each other as a service network and would not need to use a standard service provider for multi-way communications. Open messages could be posts in an open forum hosted on the emperor node. The tool rose can be closed, open, or invisible to networks depending on the user's privacy settings, it can also be timed to be visible at select occasions, and only then gather or release information packets.

Rather than adhere to a 360-degree view of a 3D representation of the tool rose, like a scroll bar, the rotation to a desired configuration of displayed functions on the tool rose can vary based on the amount of functionality packed onto the tool rose: the user may to spin it two, three, or N full 360 degree rotations to display and activate a desired set of functions on the tool rose. When a petal pops open a page in the browser, document, picture, or video type etc., that controlling petal is highlighted or enlarged to show that it is controlling that application. The tool rose could be linked with a browser and all petals could be browsing tabs, each layer or color or size of petal to can be set to specific types of pages, i.e. top blue for news, bottom red social, etc. When users go to tag information in the tool rose, past tags will show, also the tool rose heuristics will also suggest tags, users will be able to tick box, or highlight specific tags to agree with the definition to earn social currency. In the tool rose, users can instantiate duplicate versions of the same program, in the petals and in multiple tool roses, and link the petals to duplicate. For example a user could set up one tool rose to be in English, another in Spanish, and link a pair of petals in each rose to constantly update a program, for example a document program which automatically updates the dual documents, one in Spanish, one in English functioning like an automatic translator etc. The tool rose program's meta data in the tag, would have a timed and mapped location notation of where on the screen the tag was placed by the user (or professional tagger for retail applications or product placement), as this would in effect give a virtual screen shot, and would allow the key tag of the system below key word or image recognition based on a combination of heuristic strings and user tags, then either the key word, or image becoming automatically active, or a key tag becomes automatically active.

The key word/image/tag activates in that manner that either becomes a hyper linked to the key word website, or other site such as retail, this would work in for brand recognition and in research. Contextual heuristic analysis to the positional grid tagging to enable identification in still, as well as moving images. The user tags are visualized if desired by users in the user interface, for example the tags could be in different colors or shapes depending what emotion, profession, etc. tags to be placed on a two- or three-axis grid, to show where the user is placing the tag. The tag position on the grid to be searchable by users. The tool rose can grow segments or petals of information like a flower calyx, using for example a golden spiral ratio to maintain visibility of the information. As the petals wrap around the center point, and the petals are not on the same vertical line as their direct neighbors, this would allow them to be very close together while in the closed bud phase, and grow as needed. In embodiments, the tool rose can have a setting where each rose or each petal function may have a different sound and/or trigger a different scent release. Each petal or button having a different tone and or vibration, such as ultrasonic vibrations, for example. The tool rose is incorporated into wearable embodiments or mobile devices and alternate message notification. For example, one could have a communication device set on silent, but to scent and or specific vibration, either mechanical or ultrasonic. One person in a contact list could be identified as a slow vibration and a scent of fresh bread and flash blue, while another could trigger the release of a scent of metal and cause the tool rose to vibrate quickly and flash red. This would also be useful for the blind or sight challenged. The tool rose nodes, when used as a virtual reality interface, or in a virtual reality interface, via projection or overlay, can be planted in set positions on an x/y/z grid, to aide three-dimensional memory placements. The tool rose can also interface with projection and overlay units to create a set of overlay locations, where each reality may have alternate roses planted in the same grid location, but accessing a different rose as the base reality location would be different. Each rose and each petal have a base code, which is hierarchical based on time created, and further base descriptors such as, last grid position, file type, color, if a short cut or ghost file, name, shared with which devises or other users attached in the meta data. Each petal can be a note, file, photo etc. (as previously explained), each petal can link and duplicate to a new tool rose, or another pre-configured tool rose, or simply be moved to another new or pre-made tool rose. A tool rose can have its own stream, and a petal can have is own stream, or simply be part of a tool rose stream. As the base address petal is linked in a stream, if duplicated it would be ghosted in a new tool rose and keep the base designation with the addendum added of the new tool rose.

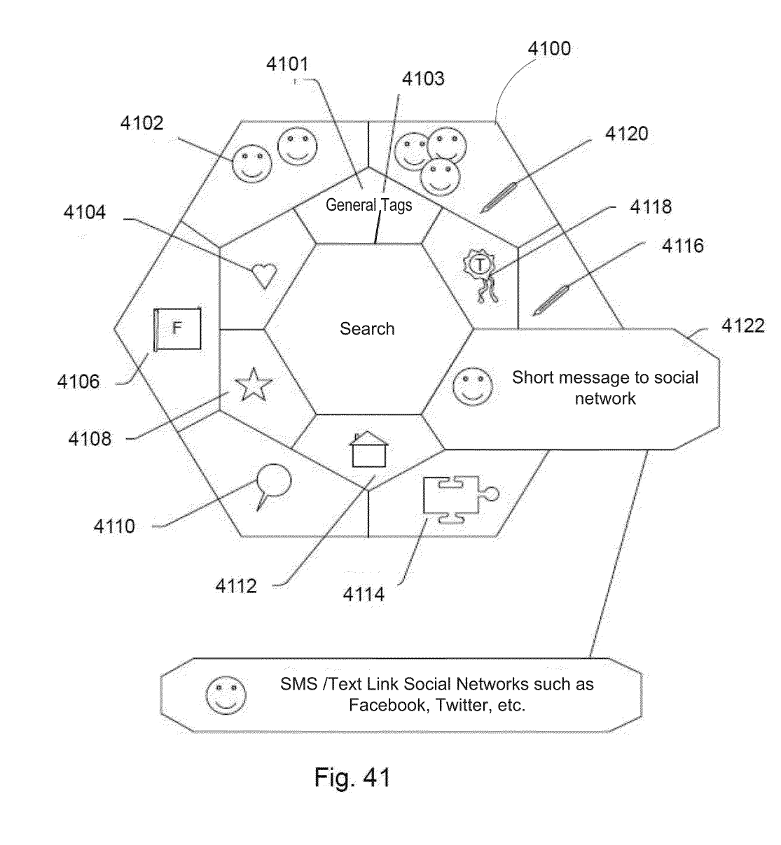

Directing attention to FIG. 41, tool rose 4100 links and interfaces with various browsers to maintain tagging across different sites on the internet, and identifies various programs and files to enable cross-tagging for personal cross-referencing of file types. A segment of tool rose 4100 is available for advertising to unidentified non-subscribers. Tool rose 4100 presents a plurality of functional buttons to a user that allow enable a user to perform tagging in accordance with the present invention. A user can generate a tag by selecting generate tag button 4101. Friend finder button 4102 allows a user to find other individuals with similar interests or tags. Search function 4103 provides functionality for a user to search as described above. Emotional tag 4104 allows a user to tag content with a symbol conveying the user's emotional reaction to the tagged content. Save to file function 4106 allows a user to capture content to local or cloud storage. Rating function 4108 allows a user to tag content with a rating indicator. Messages function 4110 allows the user to draft messages that are inserted into tags. Login/Settings function 4112 allows a user to perform login functions and manage login settings for various websites. Quick links button 4114 presents a plurality of URLs convenient to whatever context or state the user is in, for example the context or state can change as a user moves from connection to one website to another website. Notes function 4116 allows the user to draft, edit, store, or read notes associated with user context or state. Trusted button 4118 allows a user to endorse through tagging a website by placing an indication that the site is trusted by the user. Public notes 4120 allows a user to publish notes through tagging to other users regarding a particular site. Tool rose 4100 can be clicked or touched to be opened on a user device, and can run in background mode and remain active continuously. Tool rose 4100 is especially useful for users belonging to social networks, as short message to social network button 4122 provides a broadcast function to a subset of individuals belonging to the social network who are in communication with each other.

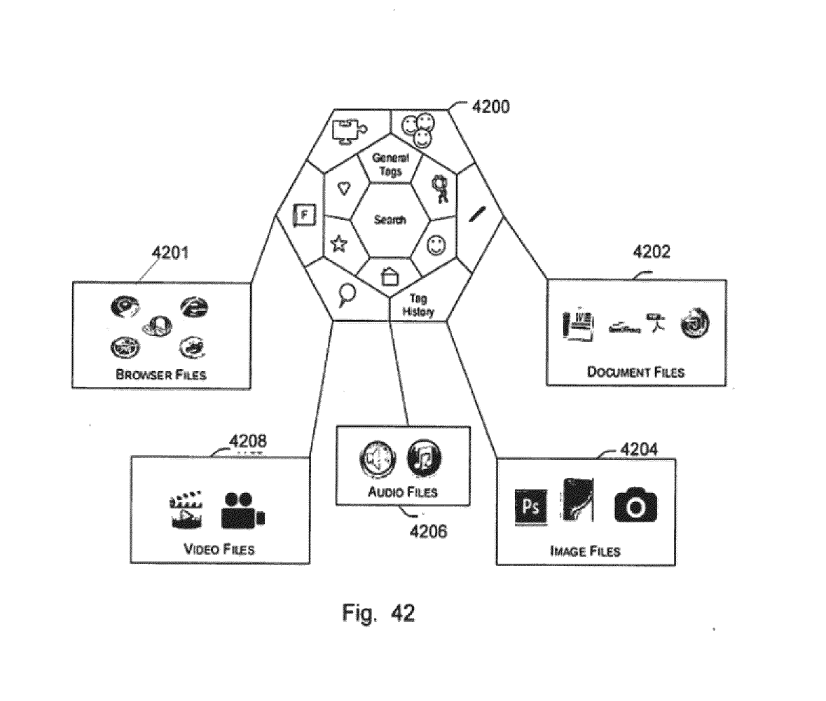

The tool rose is useful with a wide variety of files. Directing attention to FIG. 42, tool rose 4200 can be used with word processing or document files 4202, image files 4204, audio files 4206, video files 4208, and browser files 4210, such as webpages.

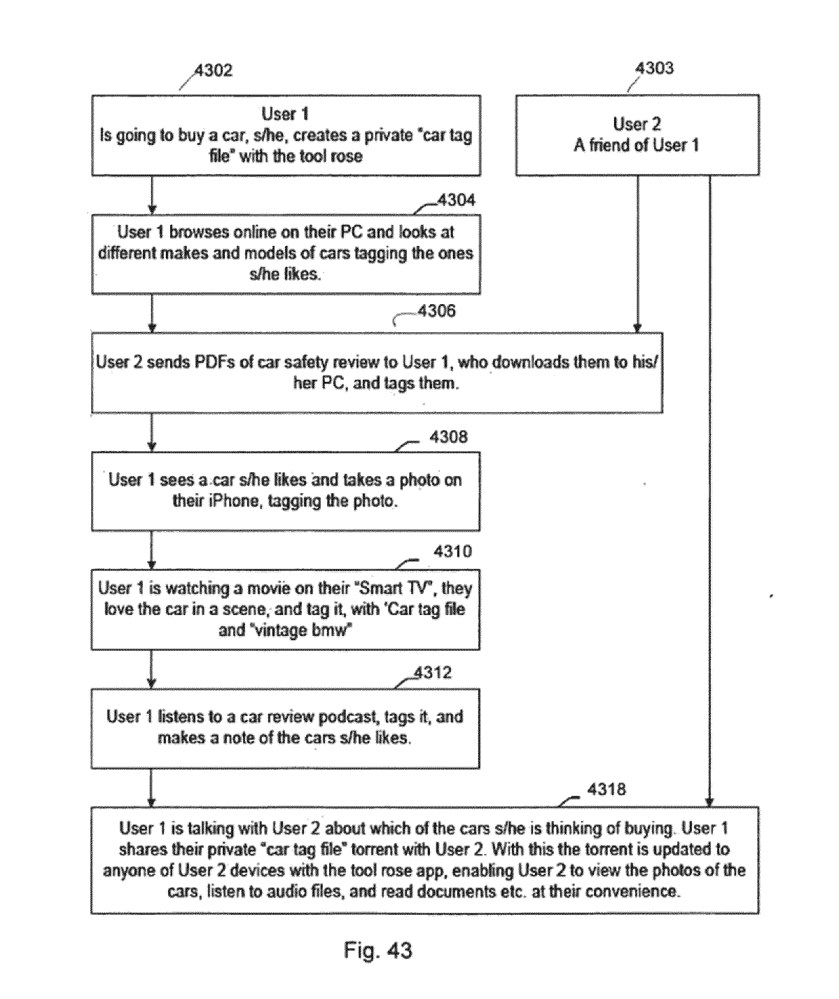

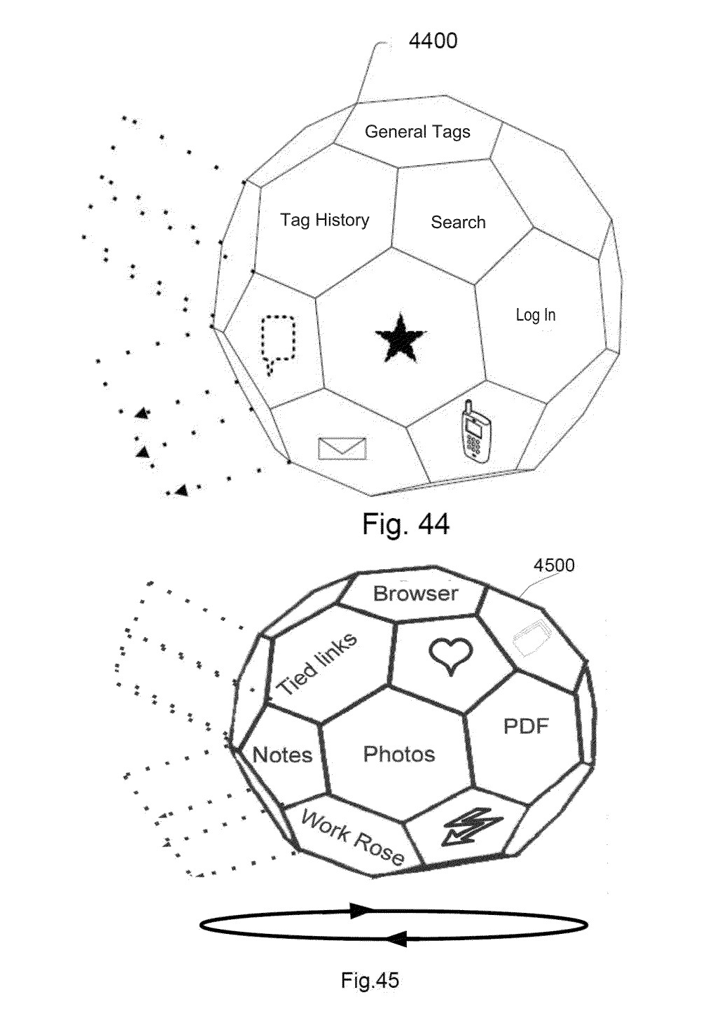

Use of the tool rose is shown as a sequence of steps in an exemplary sequence of steps shown in FIG. 43. User 1 is going to buy a car, and creates a private car tag file with tool rose 4100 at step 4302. At step 4304, user 1 browses online and reviews different makes and models of cars, tagging the ones s/he likes. At step 4306, user 2 sends files of car safety reviews to user 1, who then downloads them and tags them using tool rose 4100. At step 4308, User 1 sees a car s/he likes, and takes a photograph of it using a digital camera, and tags the photograph file using tool rose 4100. At step 4310, user 1 is watching a movie on a smart TV, and when s/he sees a car, s/he tags it with tool rose 4100 and tags the movie with a car tag file and vintage BMW. At step 4312, user 1 listens to a car review podcast, tags it with tool rose 4100, and makes a note of the cars s/he likes. At act 4318, user 1 is talking with user 2 about which of the cars s/he is thinking of buying. User 1 shares their private car tag file torrent with user 2. With this sharing, the torrent is updated to any of user 2's devices with tool rose 4100, enabling user 2 to view the photographs of the cars, listen to audio files, read documents, etc., at their convenience.

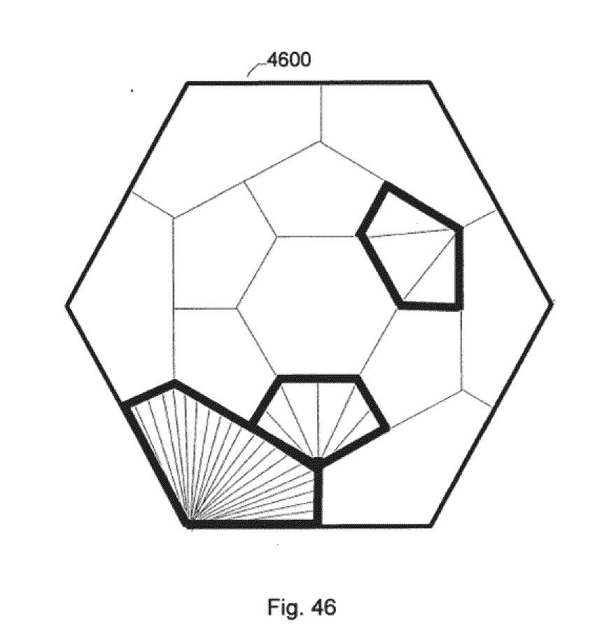

While tool rose 4100 is shown as a two-dimensional image, it can also be implemented as a three-dimensional image, as shown in FIGS. 45-46. Tool rose 4100, 4200, 4500, 4600, as shown, can be a spherical or other three-dimensional shape that displays one set of icons on one view, but allows the user to manipulate it through a touchscreen or other method to rotate the image in three-dimensional space, thus concealing the first-displayed set of icons and revealing another set of icons. This may be useful where some functions are used with certain files but not others. It also allows the user to focus on a simpler image, thus reducing eye fatigue on the user. Also, a portion of tool rose 4100, 4200 and tool rose 4500, 4600 can expand open to present a better view. Tool rose 4100, 4200, 4500, 4600 can be a transparent image, showing only faint lines to show the user that it is present while obstructing a small area of a displayed file, until tool rose 4100, 4200, 4500, 4600 is selected by the user for tagging of the file.

Directing attention to FIGS. 47 and 48, tool rose 4700 may be configured with a control switch 4800 for login operation and settings. Controls on control switch 4800 may include change password/email control 4802, generate another tool rose function 4803, configure color/appearance control 4804, reconfigure buttons or petals 4806, link social networks button 4807, and the like.

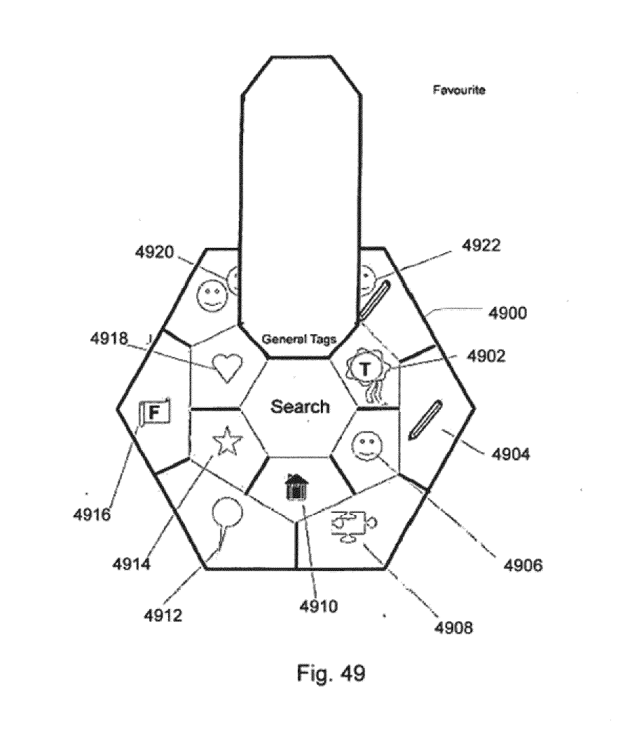

Similarly, in FIG. 49, tool rose 4900 has a plurality of functions such as tag by identity and trust 4902, notes 4904, short message to social network 4906, quick links 4908, control switch and login 4910, messages 4912, rating 4914, save to file 4916, emotion tag 4918, friend finder 4920, public notes 4922 and general tags.

FIG. 50 shows tool rose 5000 having a tag by identity and trust petal 5002 after a user selects it, thus expanding it for display. This petal (FIG. 51) of the tool rose allows additional details to be included such as degree of trust or distrust, degree of like or dislike, as well as a user-entered descriptor for a tag and an indication as to whether or not someone is known to the user in real life.

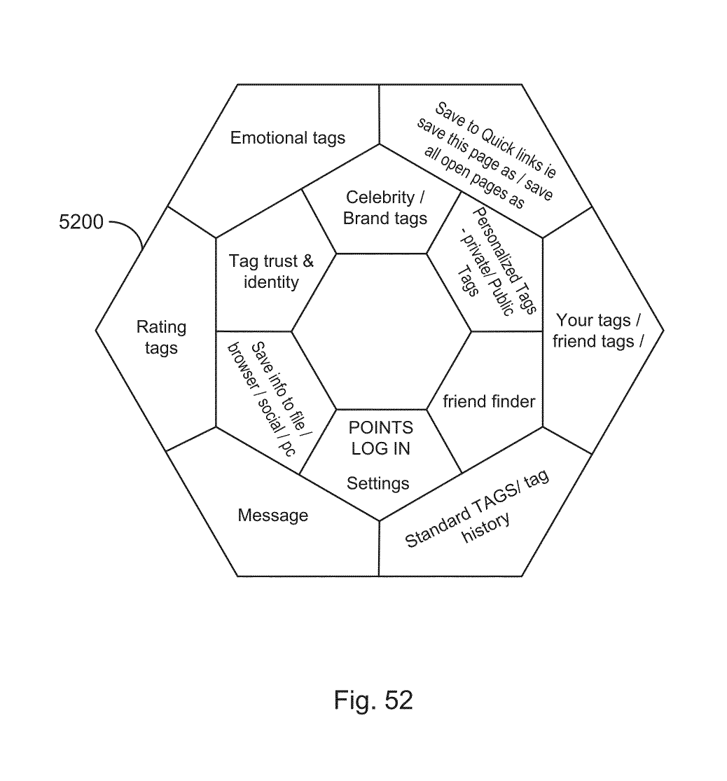

FIG. 52 shows how tool rose 5200 can be developed through additional circumferential layers placed around the original layer of petals. Upon creation by the user, the additional layer of petals is blank, and the user may custom configure them to control desired functions.

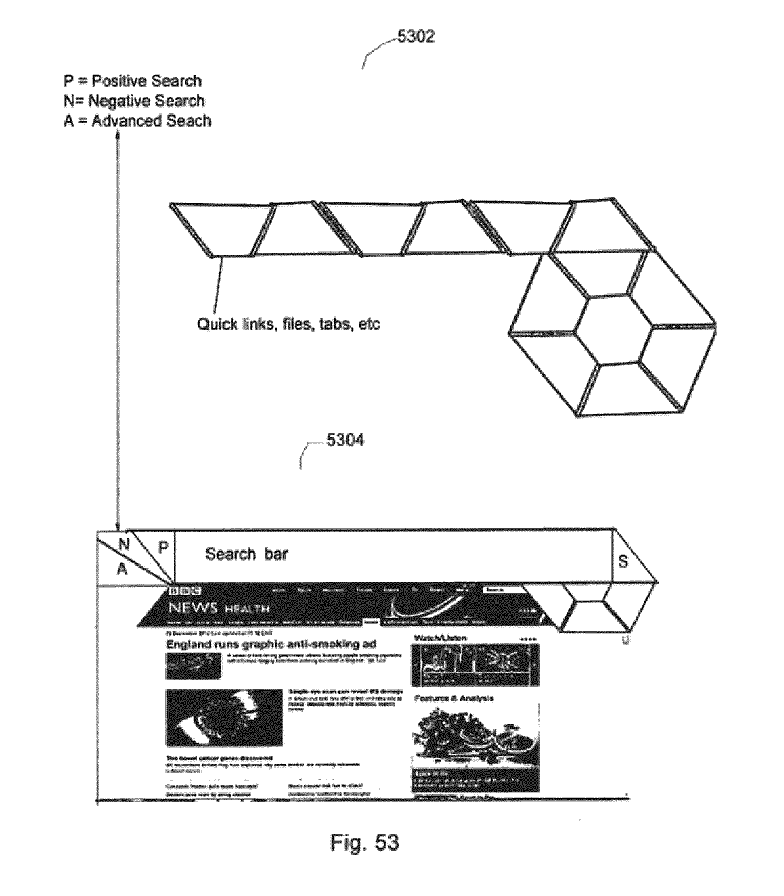

FIG. 53 shows tool rose 5300 with an expanded string of petals. In this embodiment, upon selecting a petal from tool rose 5300, a string of petals 5302 is displayed to the user in a linear format. Similarly, in FIG. 53, petal 5304 upon selection displays to a user a search bar that allows positive searching negative searching and advanced search capabilities.

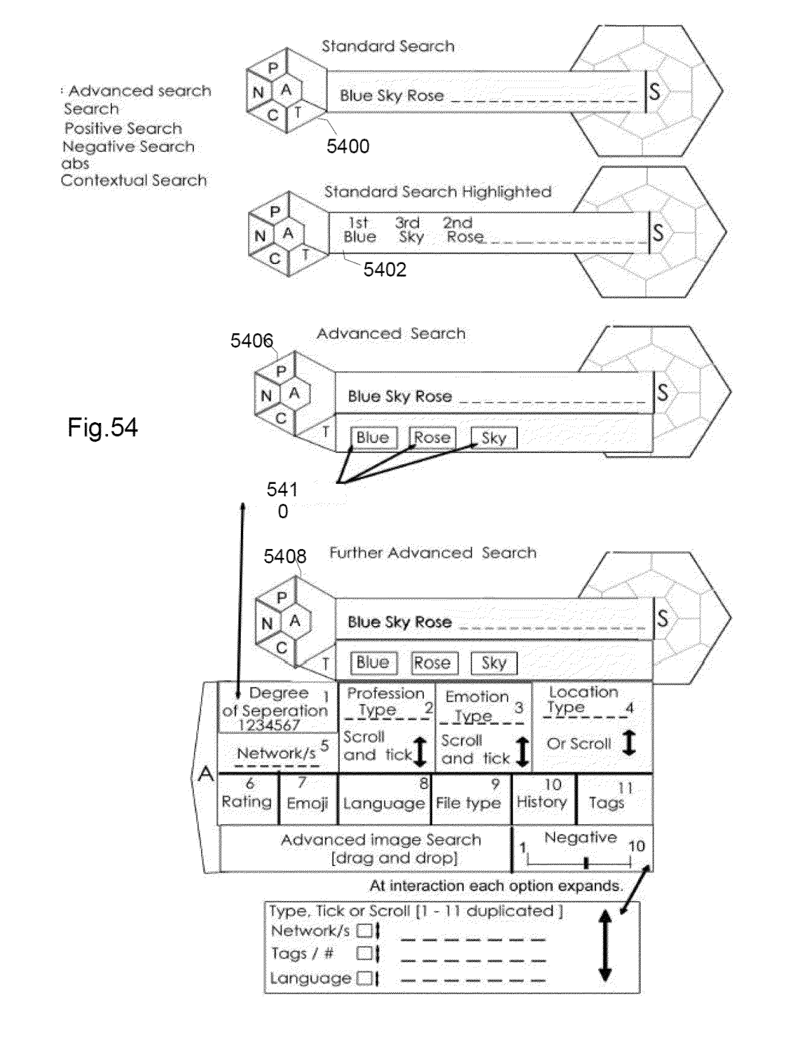

Directing attention to FIG. 54, tool rose 5400 can be manipulated by the user to provide search function based on a string such as “Blue Sky Rose.” A standard search highlighted expansion 5402 can break down individual words in the search string. Advanced search 5406 creates movable tabs 5410, ad further advanced search 5408 can provide additional search capabilities based on individual words in the search string such as degree of separation, profession type, emotion type, location type, and the like.

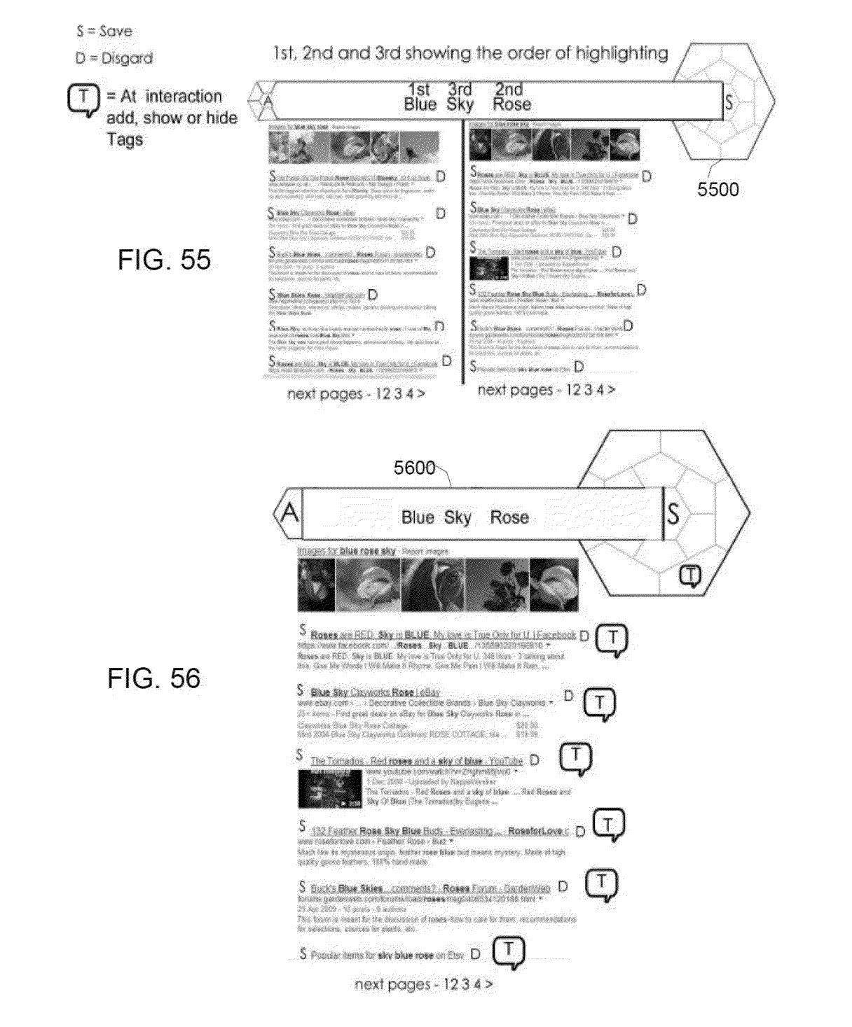

FIG. 55 shows multiple results from a completed search using tool rose 5500. Placement of the individual words in the string may determine the order of highlighting of returned search results.

FIG. 56 shows search results 5600 that allow display of tags placed on search results. These tags.

FIG. 57 shows tool rose 5700 having numeric labels on its individual petals. When a user selects a petal, it expands into a new instantiation of a tool rose, such as tool rose 5702.

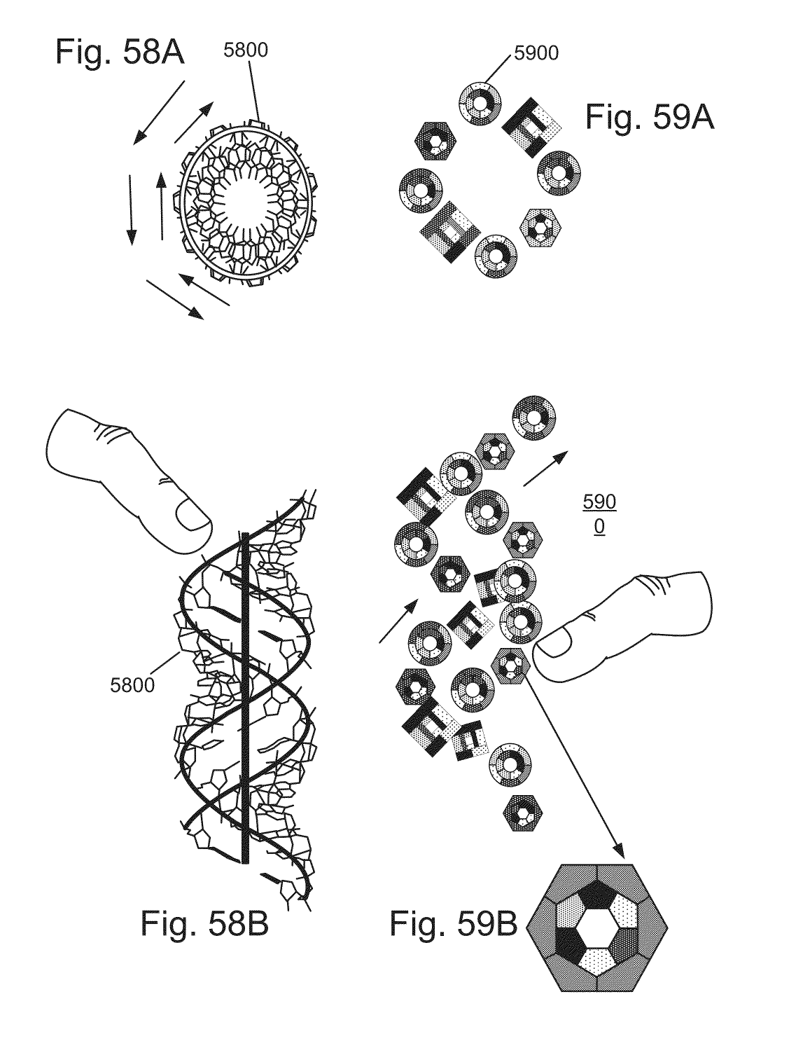

Tool roses may be linked together in a helical structure as described above. Directing attention to FIGS. 58-59, the user can manipulate helix 5800 with a finger, and select individual tool roses from associated pluralities of tool roses for operation or configuration. Also, tool roses may be created as a plurality, saving a user time by simply creating a helix of blank tool roses that a user may subsequently configure as desired. Tool roses have been illustrated thus far as one of two shapes, but it is to be understood that a wide variety of shapes can be utilized in connection with the tool rose of the present invention. As shown in helix 5900, tool roses are square, round, or multi-sided.

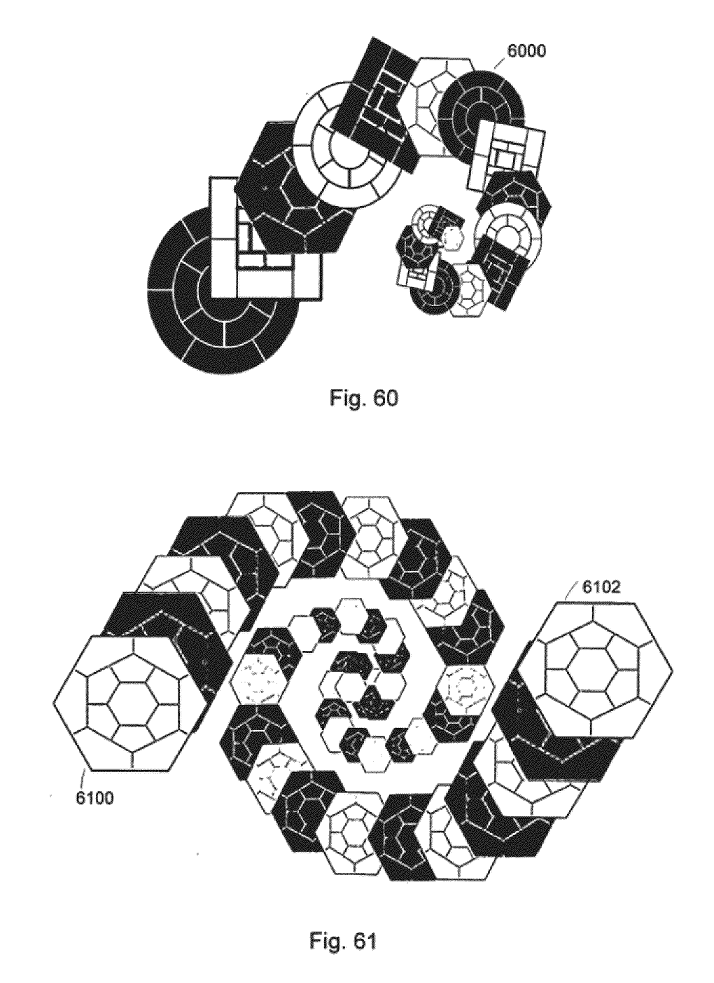

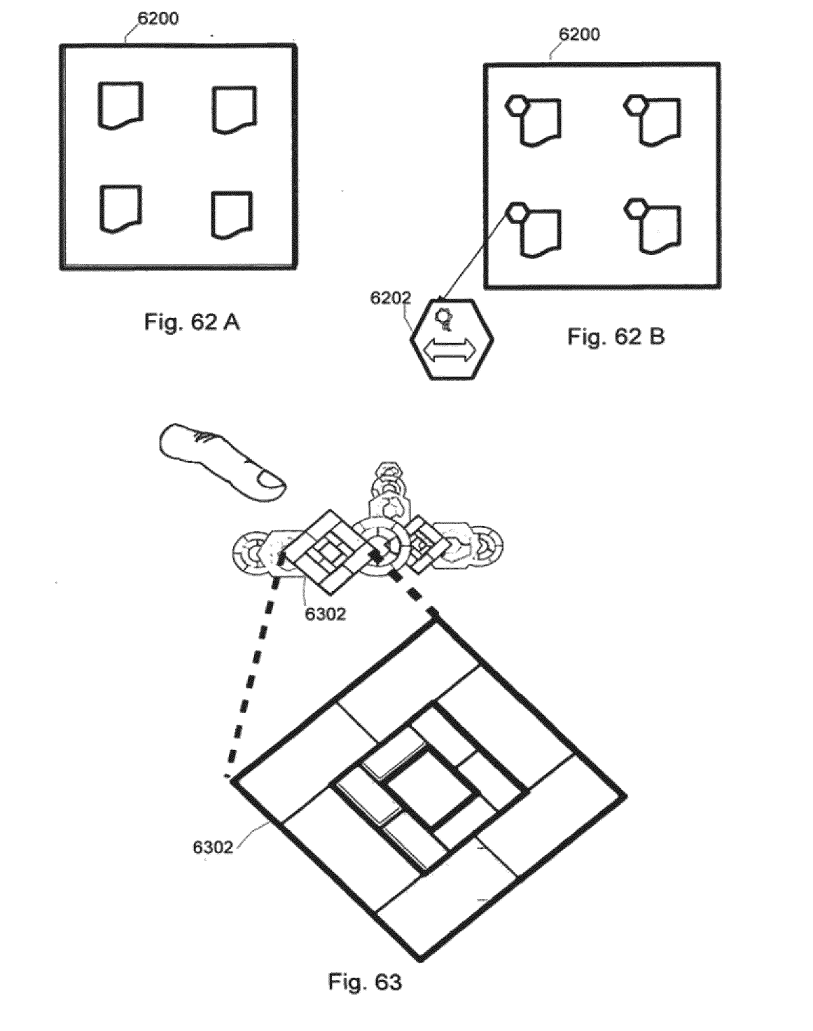

Eye strain and mental fatigue are a problem for computer users. Directing attention to FIGS. 60-61, tool roses 6000, 6100 can be displayed in alternating colors, for example black alternating with white. Similarly, color can be used for the tool rose as shown in FIG. 63. Tool rose 6302 shows various colors assigned to individual petals of a tool rose instance.

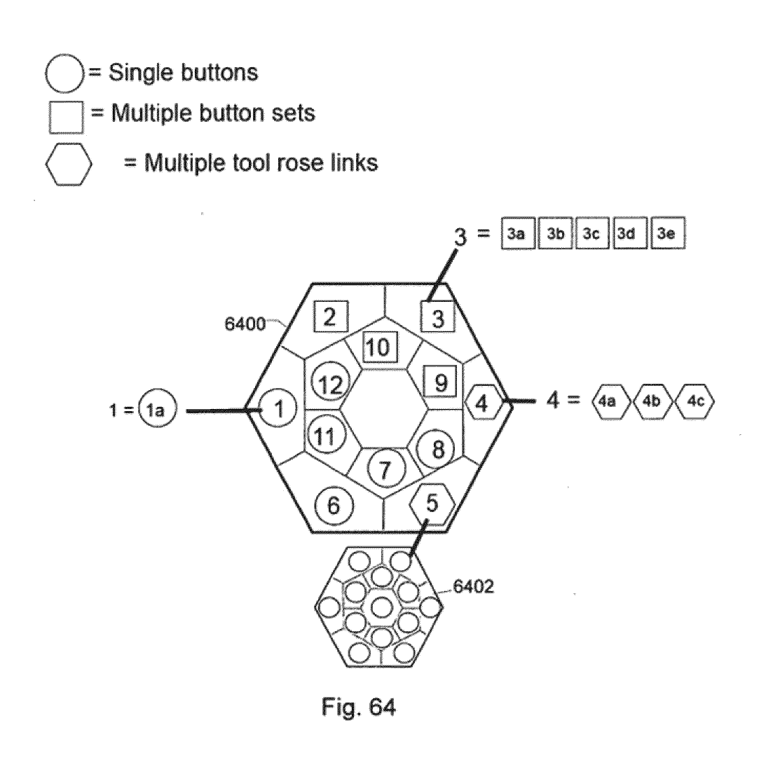

FIG. 64 shows a tool rose 6400 having strings of petals assigned to various numeric values. In this embodiment, 1, 6, 7, 8, 11 and 12 are single file, folder or application petals. 2, 3, 9, and 10 are multiple petal sets. Petal 3 is shown linked to five other files, folders or application petals. 4 is linked to three other tool roses, shown here as 4a, 4b, and 4c. Petal 5 is linked to another tool rose 6402.

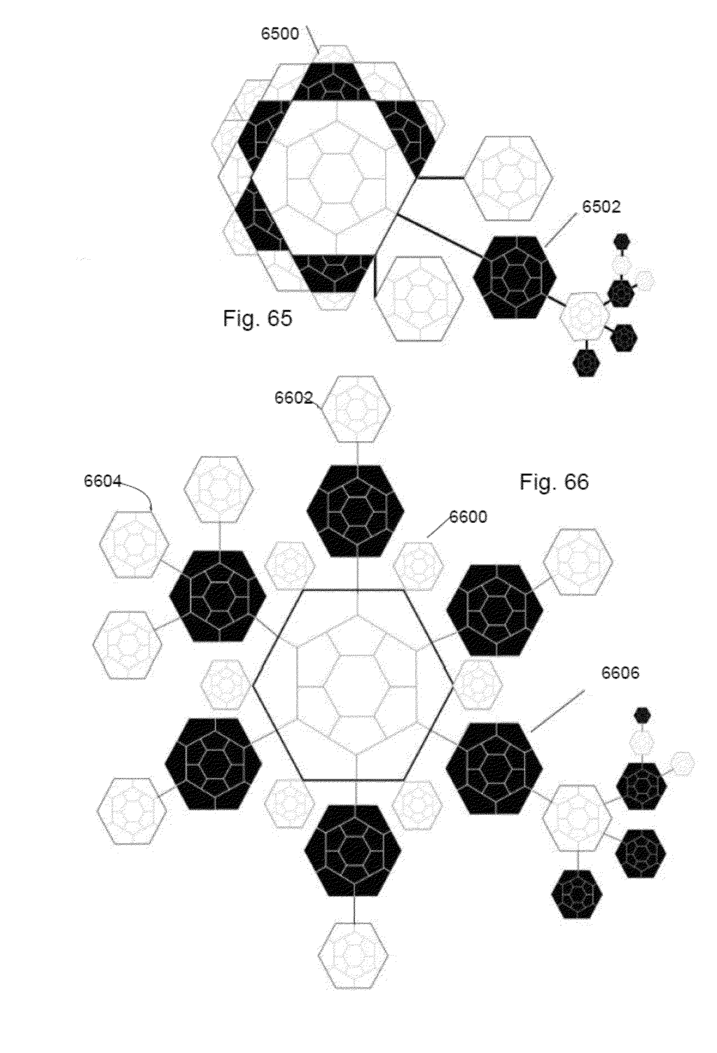

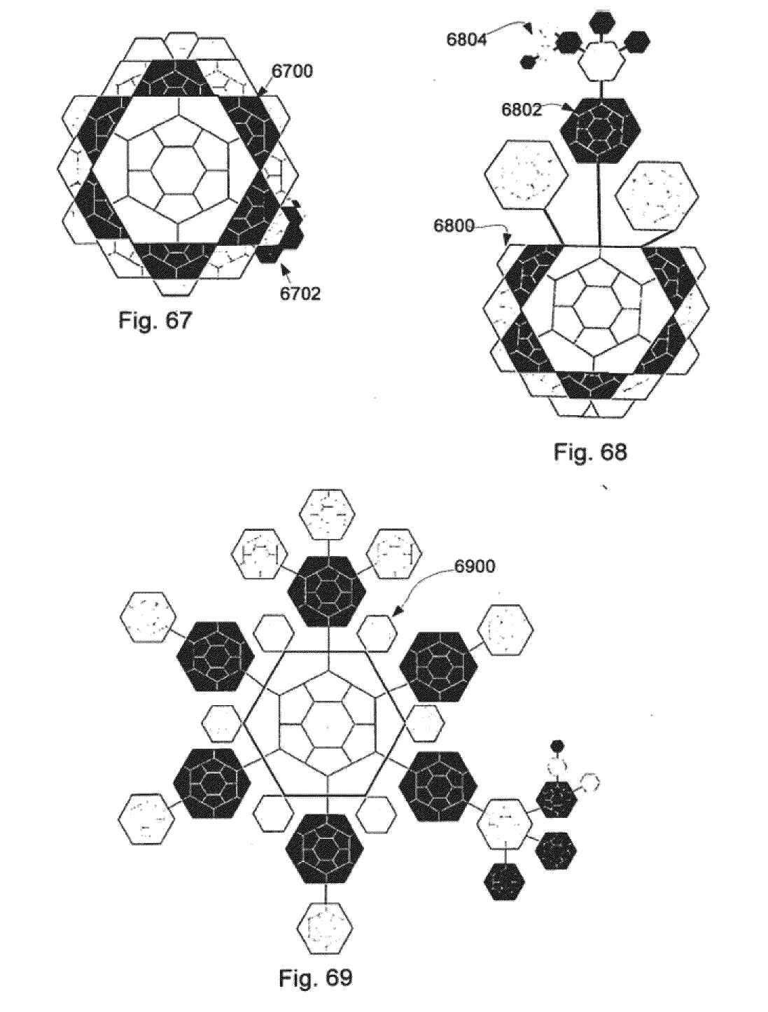

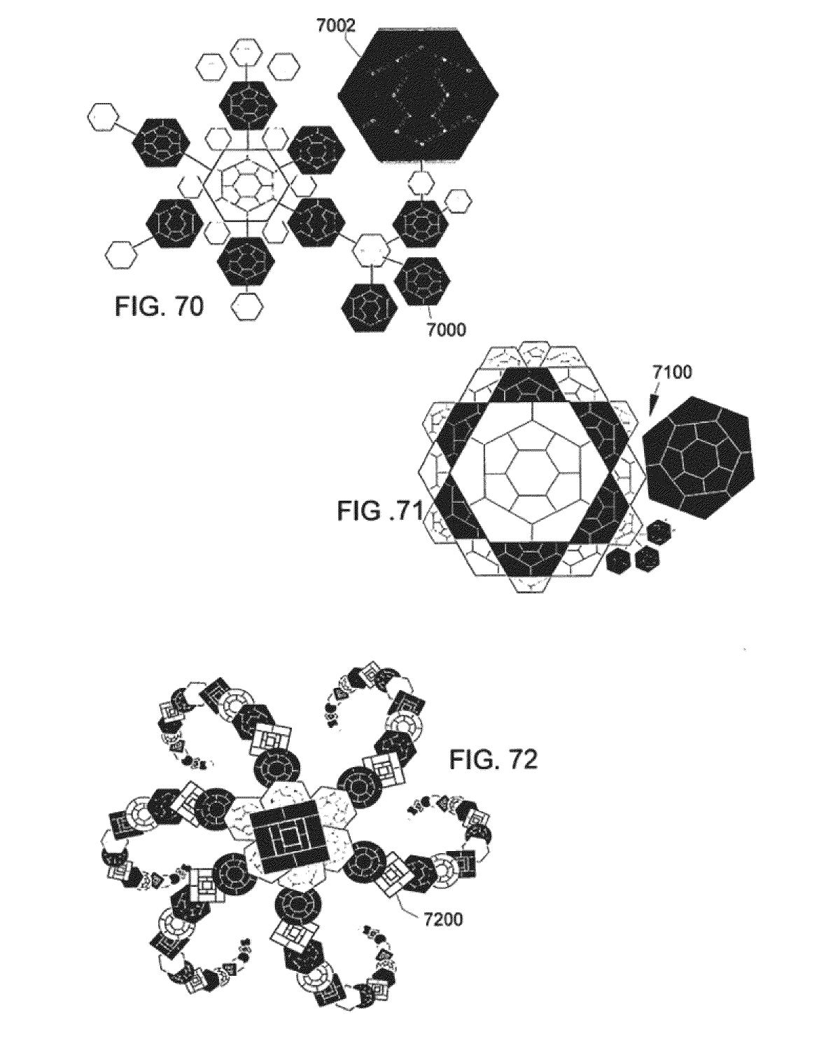

Tool roses are expandable as branches from other tool roses. Directing attention to FIG. 65, there is shown tool rose 6500 having branch C that includes directly linked tool roses and subsets of tool roses linked to tool rose through one or more intermediary tool rose instances. Multiple branches may be configured, as shown in FIG. 66. Here, tool rose 6500 has branches 6602, 6604, 6606. Layouts of branches can take a variety of user-selected variations, shown in FIG. 67, where tool rose 6700 has a branch 6702 in direct contact with tool rose 6700. FIG. 68 shows tool rose 6800 having branches 6802, 6804 of varying sizes. FIG. 69 shows tool rose 6900 having an alternating pattern of monochrome tool roses to reduce eye strain. FIG. 70 shows tool rose 7000 having branches attached, and when one tool rose on the branch is selected, such as tool rose 7002, that tool rose is enlarged and enhanced with an additional indicator, such as color, to show that this is a selected tool rose from a branch. For economy of screen space, as shown in FIG. 71, tool rose 7100 can be compressed to minimize tool roses that are not in use, while enlarging one that is selected.

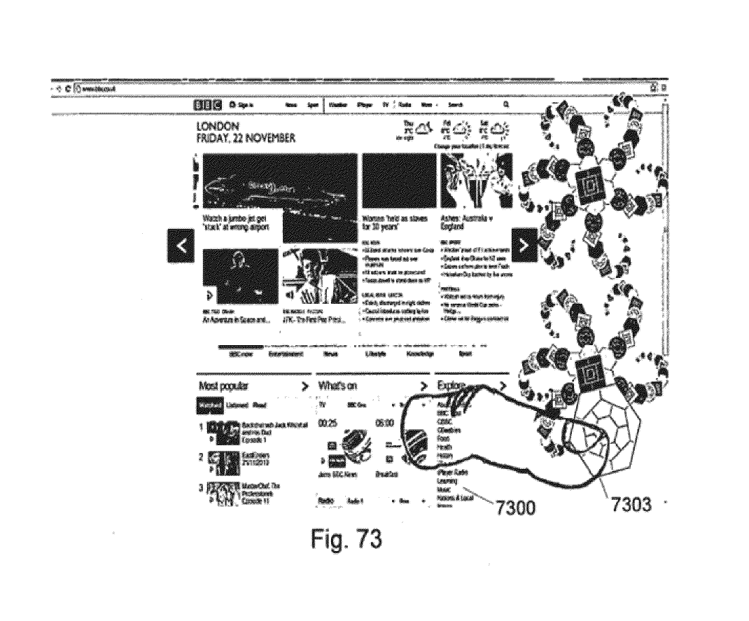

FIG. 72 shows tool rose helix combination 7200. This is particularly useful in collaborative settings, where multiple tool rose helices are associated based on a common link. However, tool rose helix 7200 can be used simply to organize a large number of tool rose instances for a single user, for example in an editing environment as shown in FIG. 73, where the user is fusing helix combination 7200 to review and/or edit web page 7300.

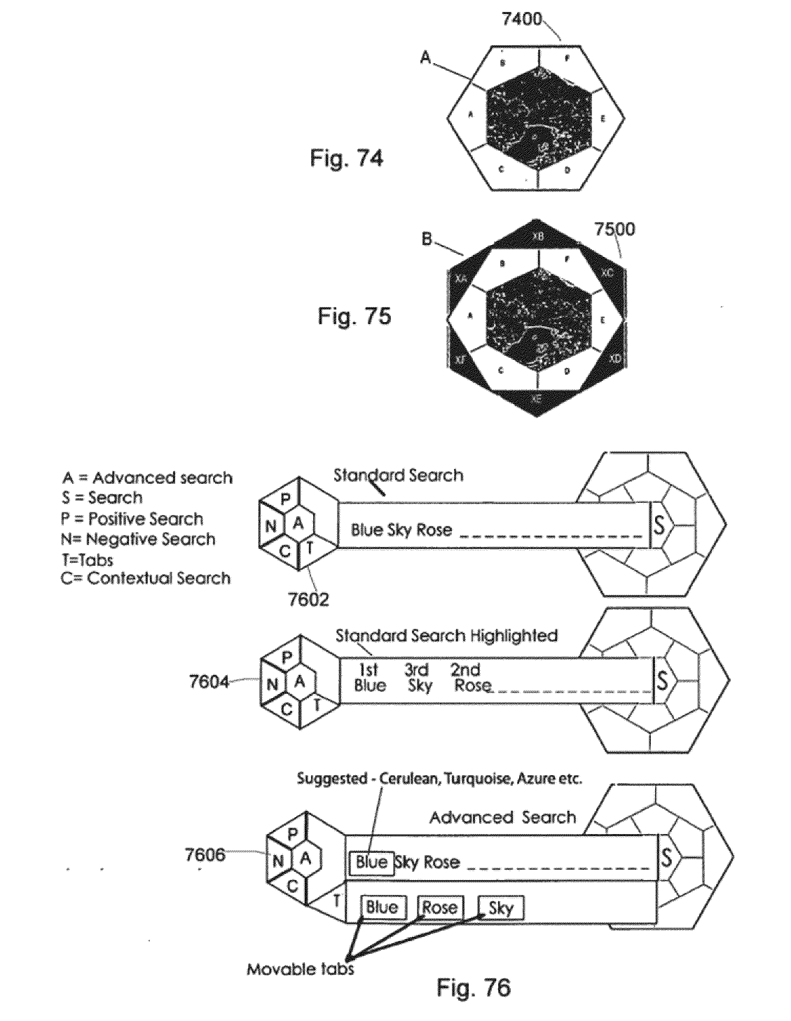

Directing attention to FIGS. 74 and 75, tool rose 7400 and 7500 may display images in the individual petals of the tool rose. As described above additional rings of petals can be added to the tool rose, as tool rose 7500 has an additional ring of petals placed around the first ring of petals.

Directing attention to FIG. 76, the tool rose search function can include tab 7602 that expands for a standard search, a negative search tab 7604 that highlights the standard search's search terms, and suggested search terms and movable tabs 7606.

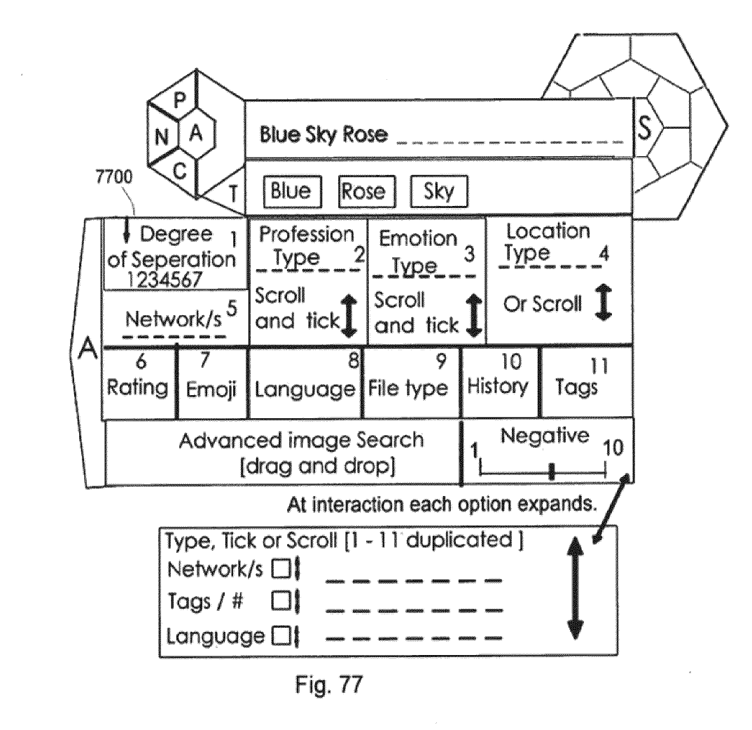

FIG. 77 shows the various searching options 7700 where each option expands upon selection by the user.

Encryption and Security

The tool rose can contract and expand its size at the users prompt or at a pre requested or automatic programmed response to minimize its impact, i.e. on a screen grow from a pea sized rose to something that takes up the whole screen, or if projected, grow from a walnut to a beach ball or bigger etc. In furtherance if idle for any length of time the rose, or roses could shrink back to their minim, unless pinned open.

Dissemination of messages or information using the tool rose and node network under high privacy settings—via breaking/splitting up and scrambling the initial message in to random component parts via a dynamic algorithm, each segment of information part of the whole, when all [or over a certain %] pieces of the information are collected the information/messages reforms at the end user's tool rose, if the end user has the key.

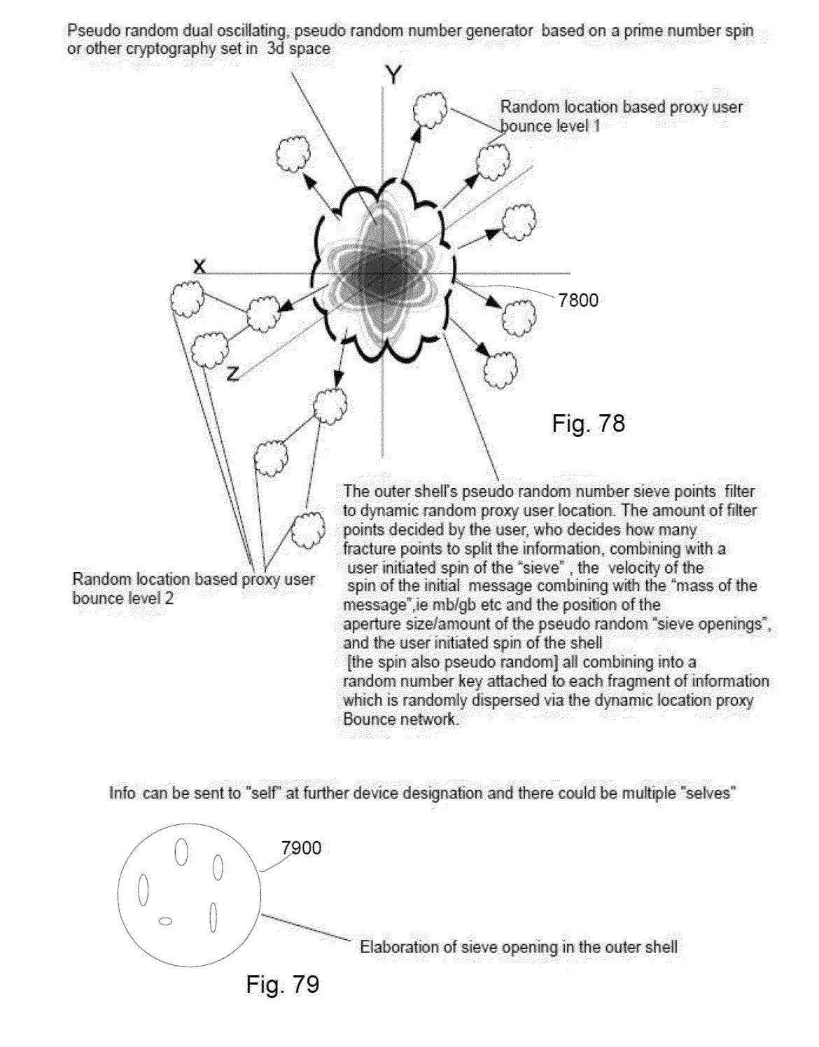

FIGS. 78 and 79 represent the two portions of the cryptographic process for encrypting information sent between nodes of the present invention. Pseudo-random number generator 7800 is a dual-oscillating number generator that produces values based on a prime number spin or other cryptography set in a three-dimensional space. Number generator 7800 is filtered by sieve 7900, visualized as an outer shell placed over a spinning pseudo-random number generator 7800. The outer shell or sieve 7900 points filter to dynamic random proxy user locations. The amount of filter points are selected by a user who decides how many fracture points to split the information, combining with a user-initiated spin of sieve 7900, the velocity of the spin of the initial message combining with the body of the message and the position and size of apertures in sieve 7900 and the user-initiated spin of the shell (also a pseudo-random velocity), all combining into a pseudo-random number key attached to each fragment of information with is randomly dispersed via the dynamic location proxy bounce network. This is a virtual visual interpretation of fluid dynamic equations combined with standard cryptography and biometric keys. The cryptography fracture and spin sets multiple cryptography key at layers, each fractured piece is a real or fake piece of a key, one key is only apparent when sufficient pieces are in place, then the end user then needs the other key to unlock the item encrypted.

A dynamic location proxy bounce network is how information or part a piece of information such as a fractured piece of torrent stream, can be shared by users of the node network who consent for their node to be used as a proxy, in particular their current IP and the like. Here, information bounced is routed directly or held in the cache dependent of the settings of the users involved and messages meta data un-accessed by the intermediate node. If the nodes were location aware (via GPS, IP, and the like), and if location was an important aspect to the message it would be in the meta data of the message and affect the routing, and one could have a message bounce around a select location though many nodes till the correct user arrived. One can set the proxy filter on your node with the same refines of the other emotional routing filters.

Tool Rose Glove and Wearable Interfaces

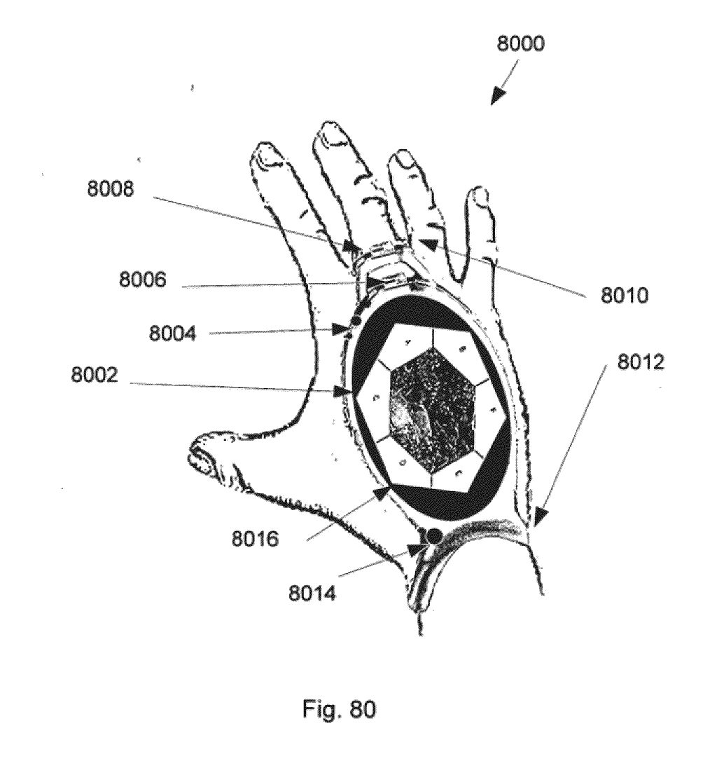

The glove, or palm amulet shown in FIG. 80 herein described as the palmulet in this configuration is designed to work primarily with the tool rose user interface shown 8002 and node network, to allow communication streams to function smoothly between devices in a personal network. The amulet of the palmulet is designed to have exchangeable casing 8016, so there are multiple embodiments apart from the primary design. The palmulet goes from the wrist joint 8012 to the knuckles 8010, not restricting movement of the hand or wrist, by having the palmulet on this area of the body, you have use of a broad surface of the back of the hand to interact with, its particularly useful for women or children, because smaller wrist dimensions makes smart watches with an adequate screen size infeasible or too bulky to ware comfortably. FIG. 80 shows the standard palmulet, FIG. 8008 showing projector, FIG. 8006 showing a camera, FIG. 8014 showing a microphone, FIG. 8004 showing a speaker, FIG. 8018 showing a scent emitter, FIG. 8020 a bio sensor. The size of the movable amulet in the palmulet is optimized for the back of a user hand, the palmulet is a held in place on the top of the hand from wrist to finger knuckle, it doesn't wriggle around the wrist like a smart watch or smart bracelet As the unit is primarily designed to fit on the back of the hand for viewing screen and easy interaction reasons, you can have various finger gestures as controls either on the touch screen or filmed by the camera, some gestures set as alerts so if a user is security conscious and walking late at night and they are concerned someone is following them, they could set a gesture to start filming notify someone specifically or do a broad alert and call emergency services after a set interval if they don't counter the gesture. There can be ranges of gestures, so if a gesture was innocuous a user wouldn't feel a fool at initiating the alert in case the person that was concerning them was not a certain danger, or have an obvious gesture if they were a certain, and the user wanted the danger alerted that they were being filmed and help is on the way.

As the central amulet unit can be moved from the original palmulet casing the casing can be made easily compatible for left or right handed people, the casing possibly formed by 3D printing, the amulet can be moved to a broach casing to a necklace casing and so on, further possible hand based embodiments include a dedicated gaming glove, a ski glove casing a biker glove casing and so on. With the variable containers for the amulet it is feasible that a user might have one child hand size palmulet as a neck amulet, and a full man sized amulet used as a palmulet, each device sharing processing power and storage, prioritized controlled and connected via linked the tool rose interface, possibly the neck amulet showing a security pass, and filming an event, and the palmulet containing a viewing and control screen.

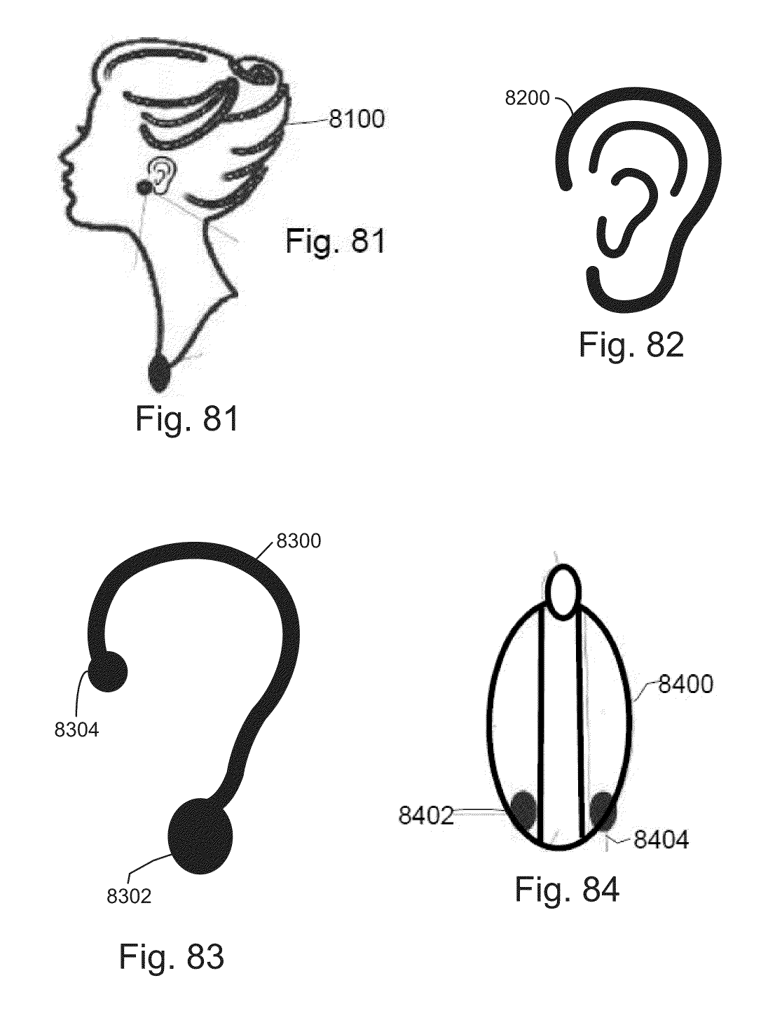

Directing attention to FIGS. 81-84, torrent-based contemplated by the inventor include a wearable pair of devices capable of fitting on a human head 8100. Fitting over ear 8200, device 8300 can include a microphone 8302 and speaker 8304. This device is particularly useful for bicycle or motorcycle riders in congested areas, where indication of a dangerous condition, such as an automobile getting to close to the rider, through proximity detection or radio beacons placed within vehicles, or motion sensors, or heat or sound or vibration detection.

Similarly, a pendant 8400 can be included with this functionality with microphone/speaker 8202, or camera 8404.

### Deep Product Placement

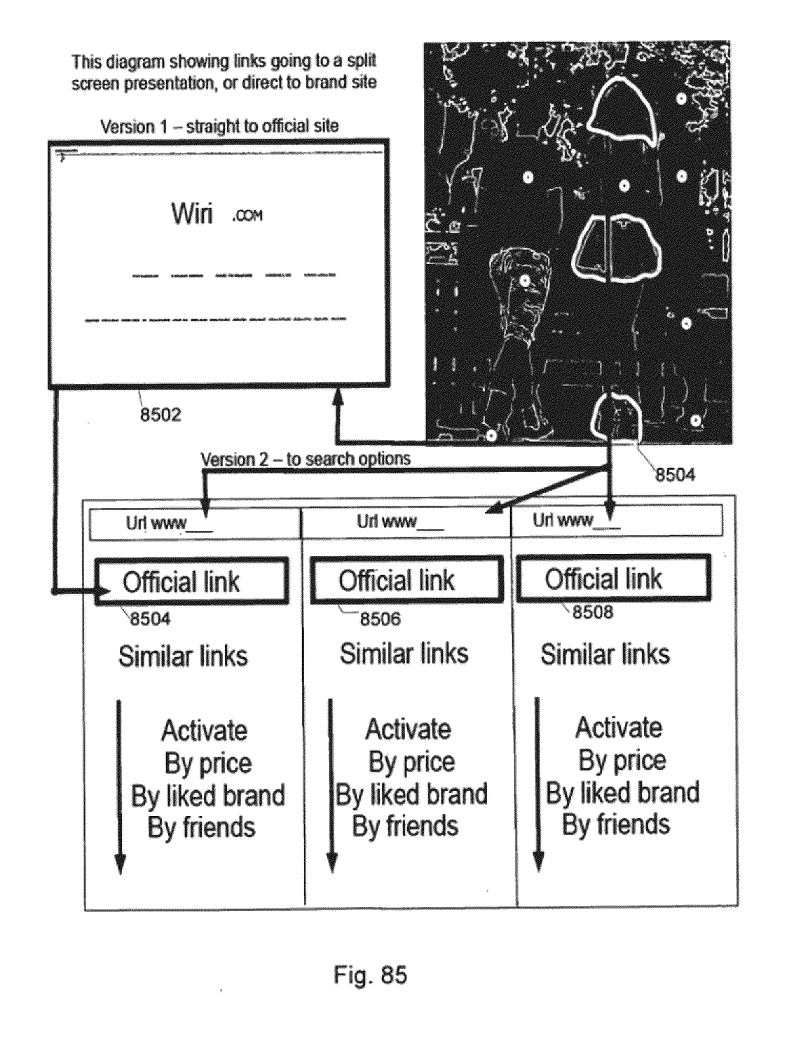

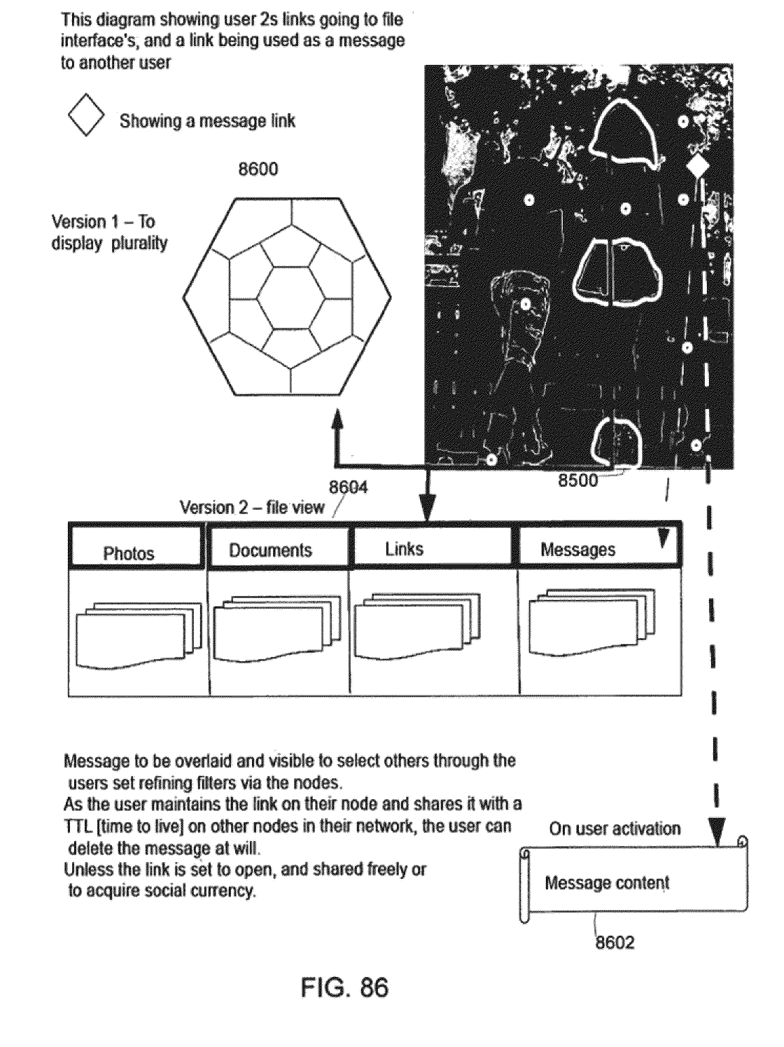

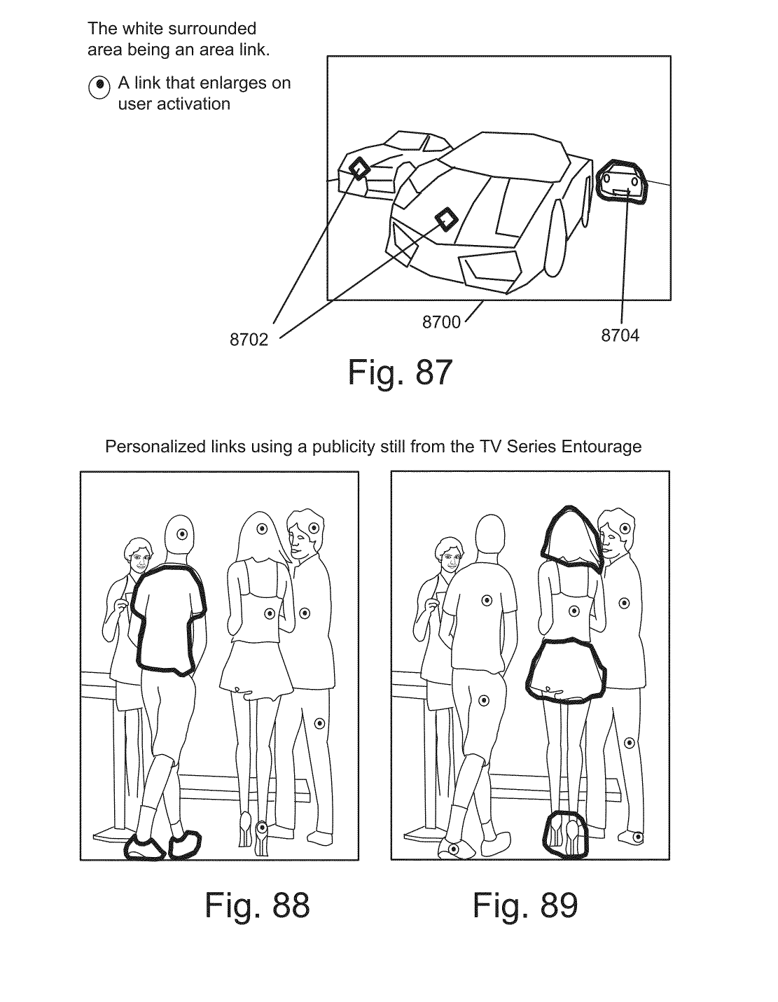

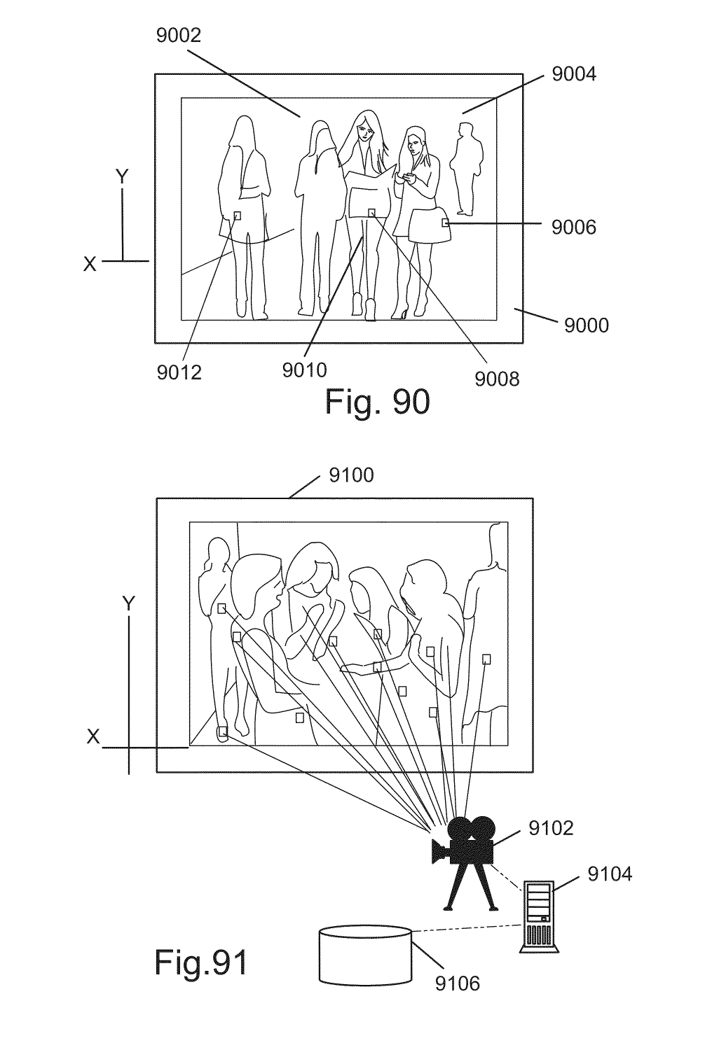

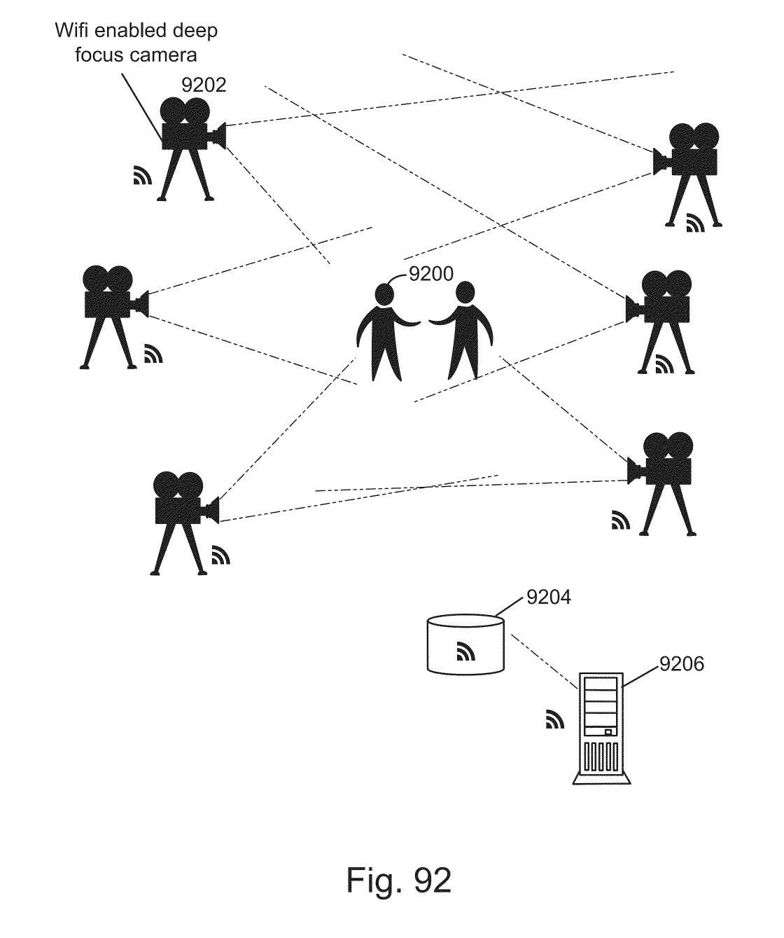

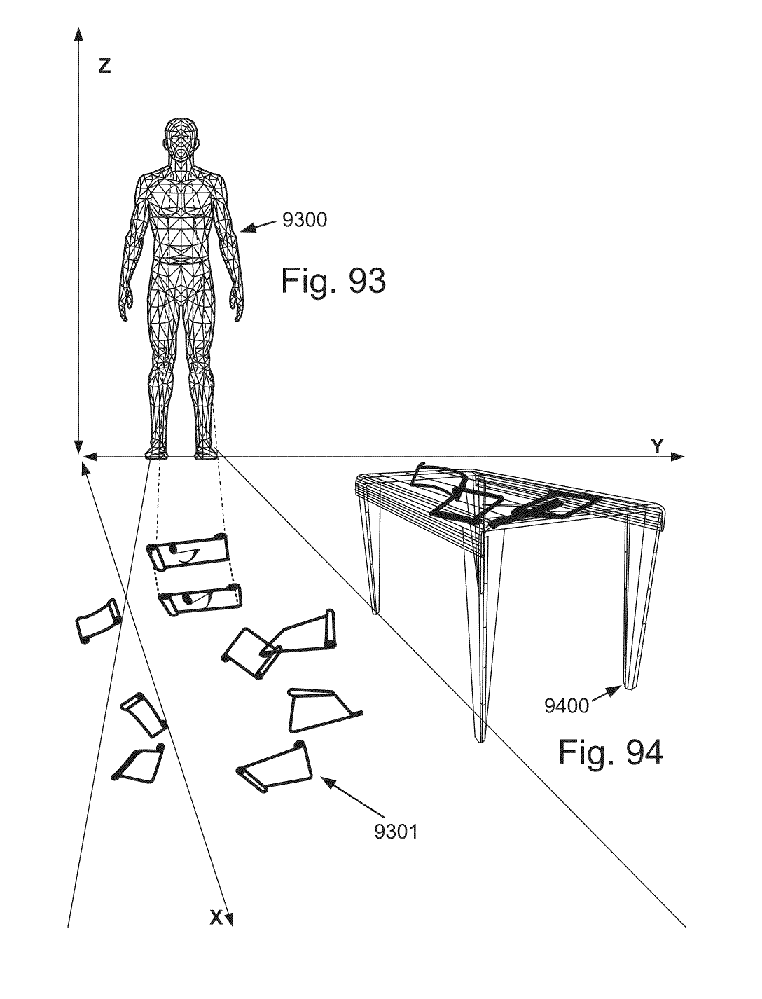

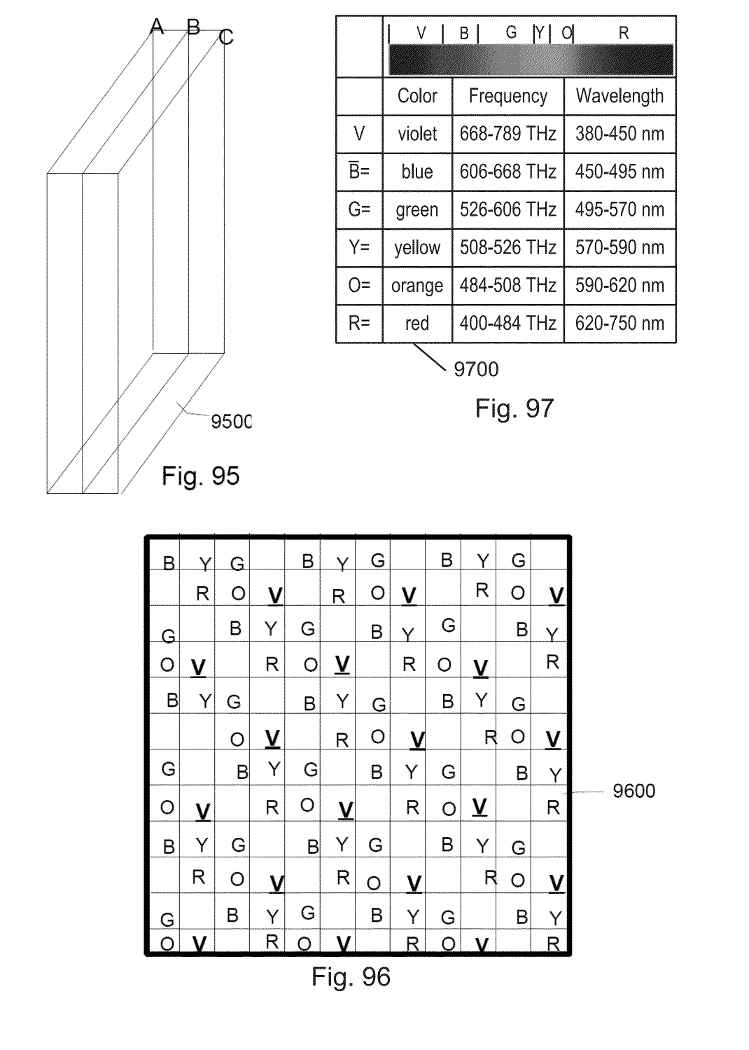

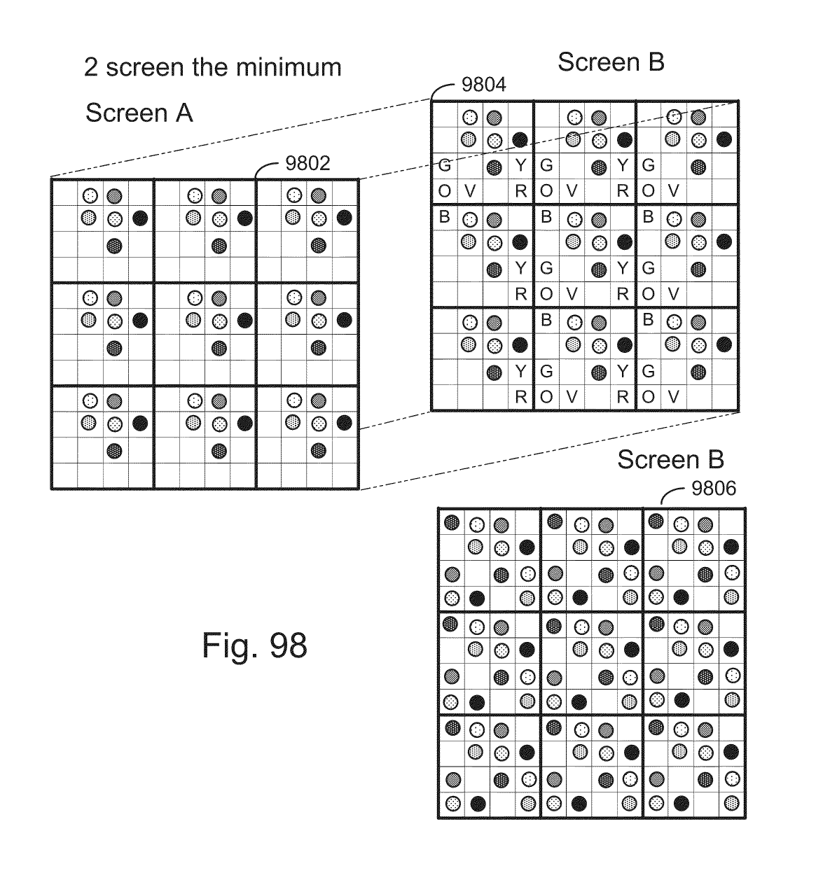

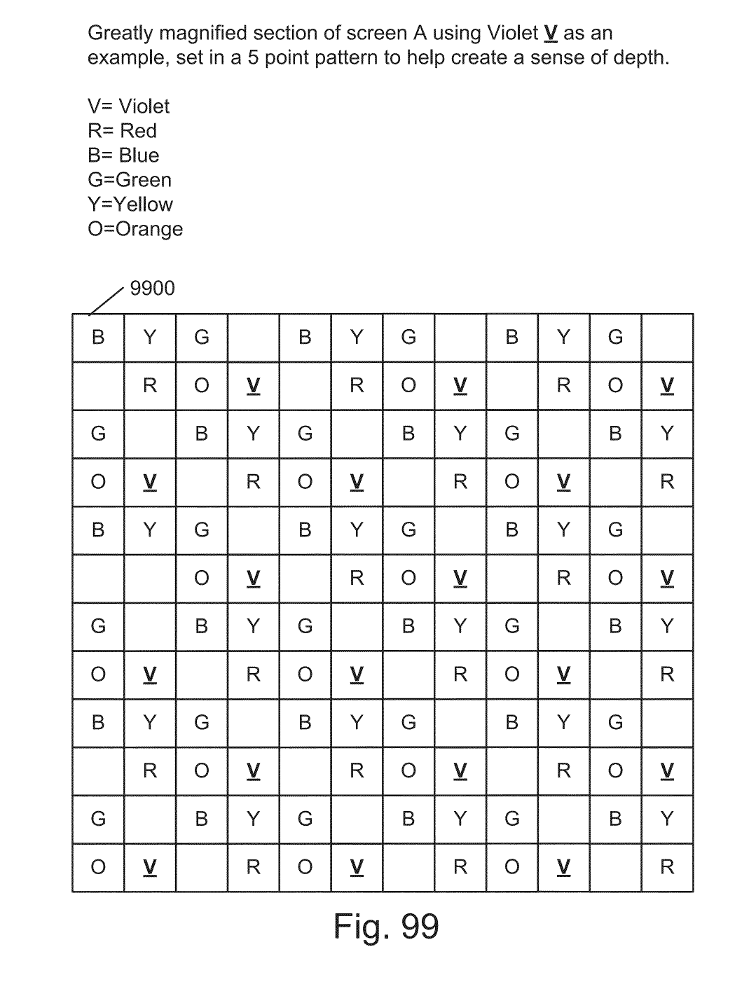

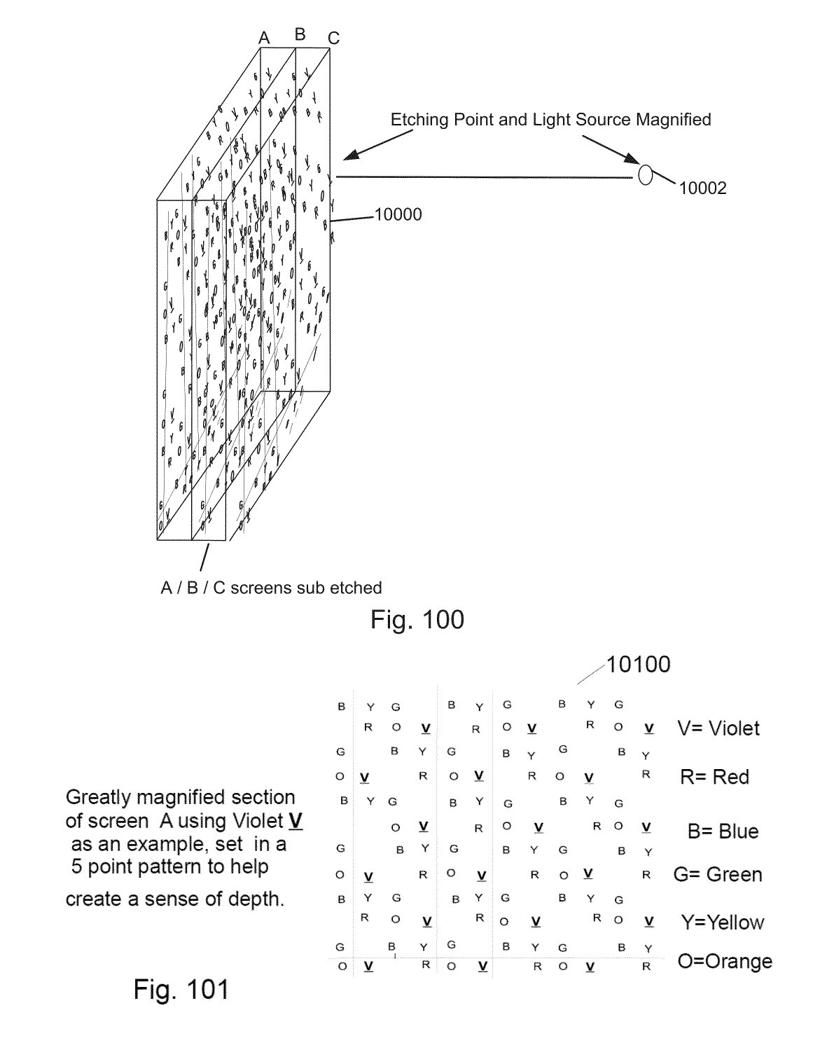

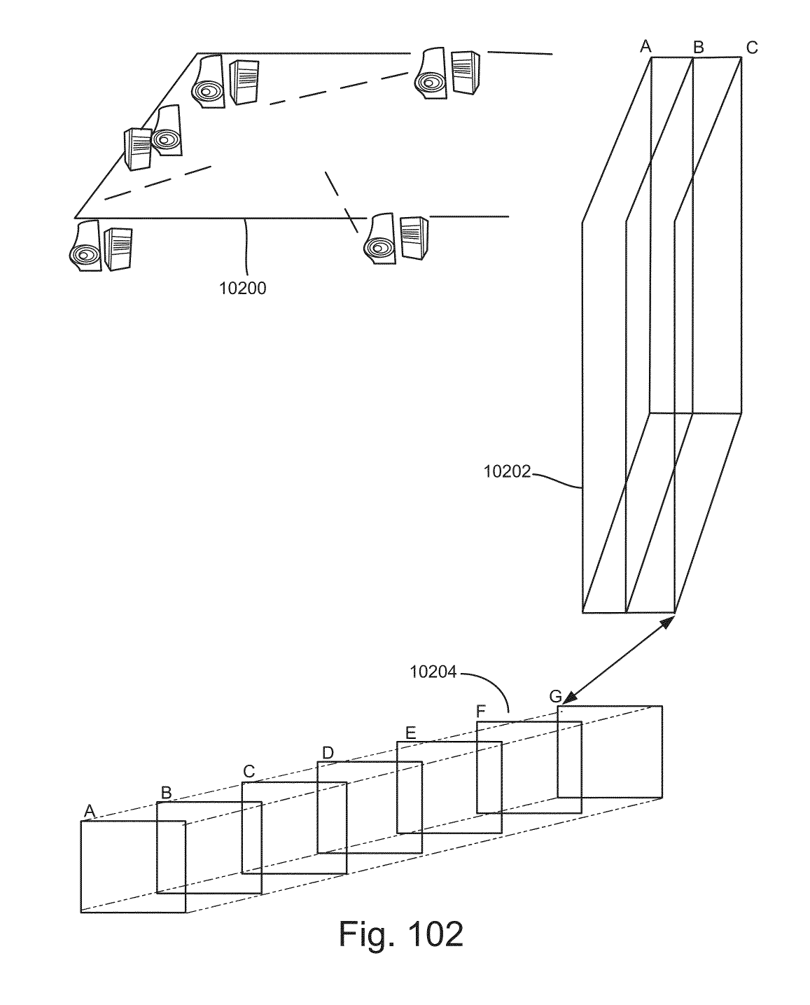

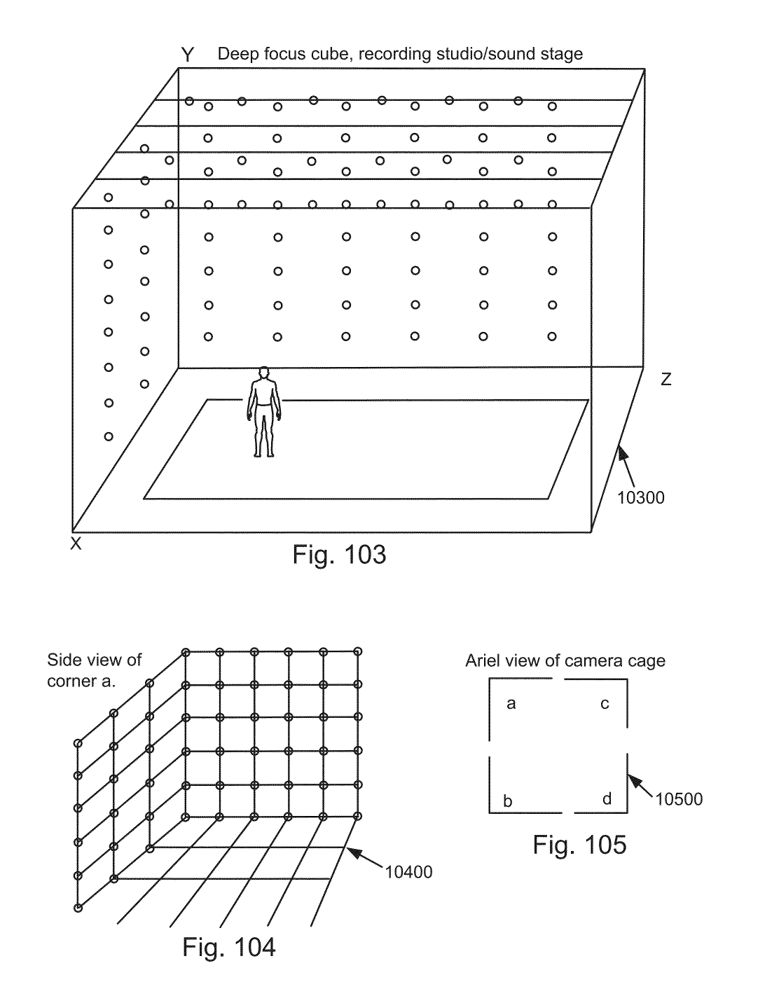

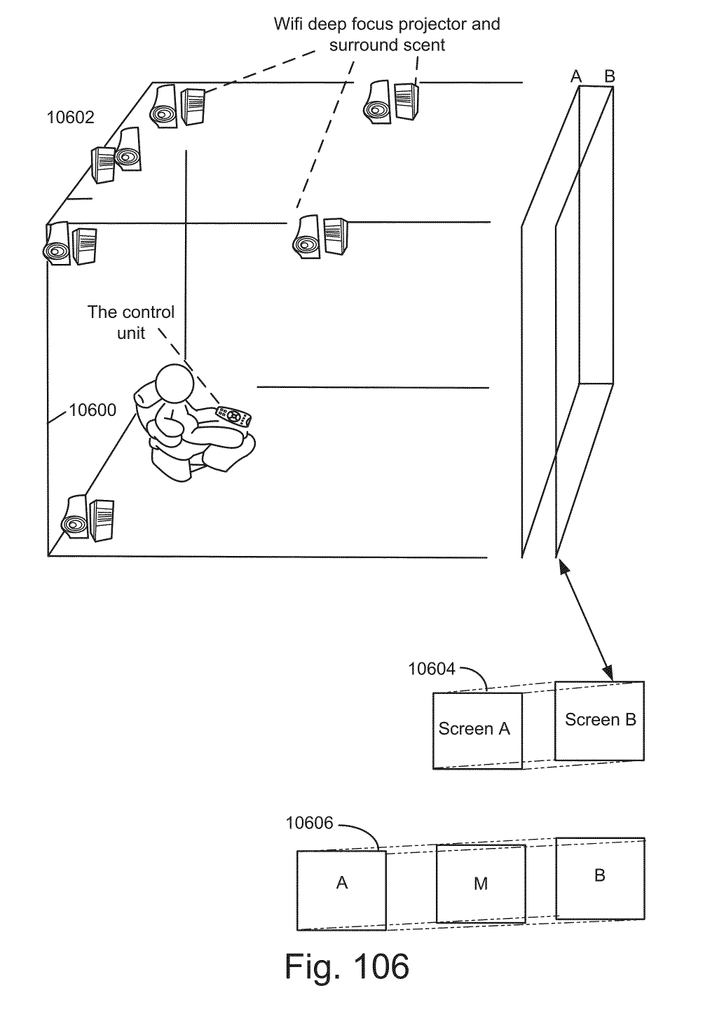

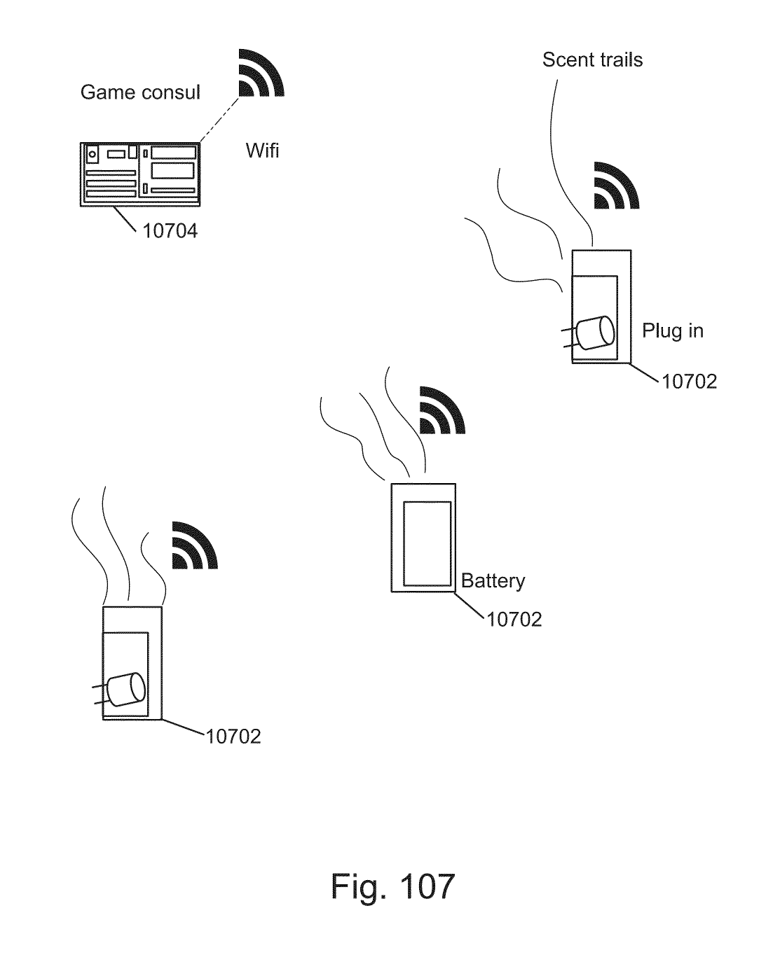

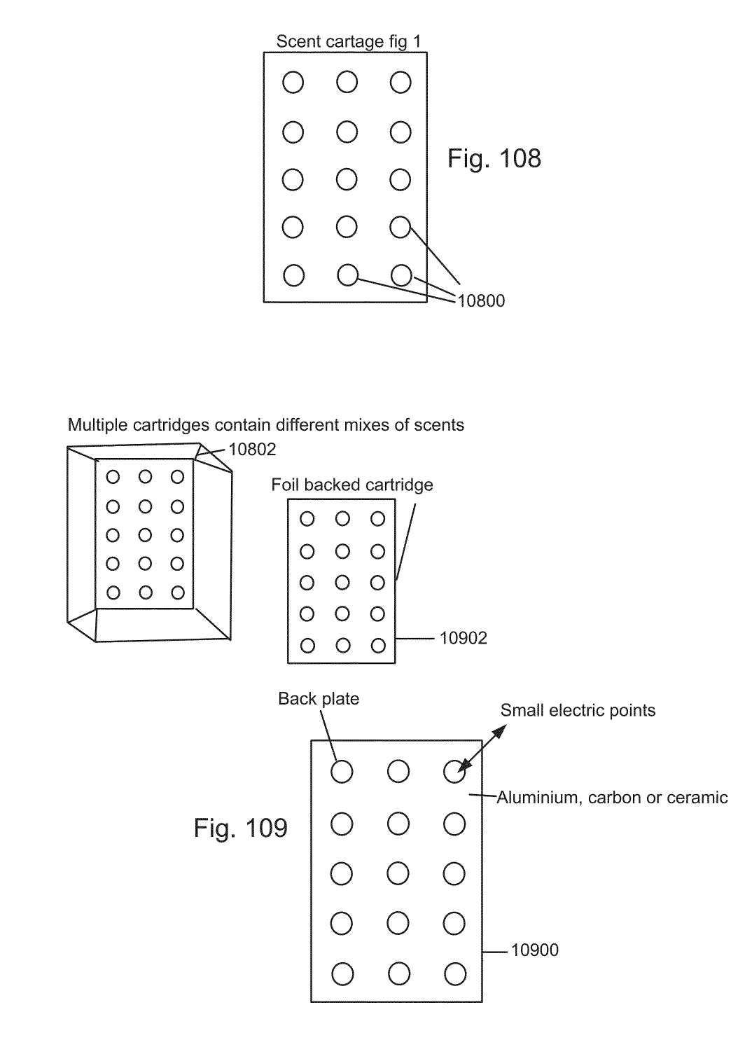

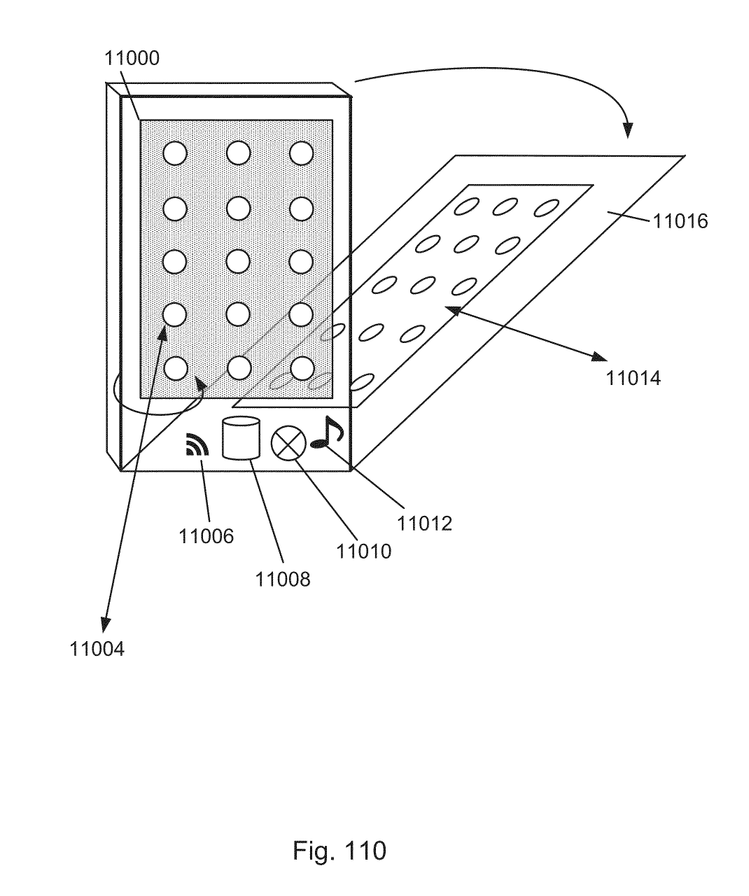

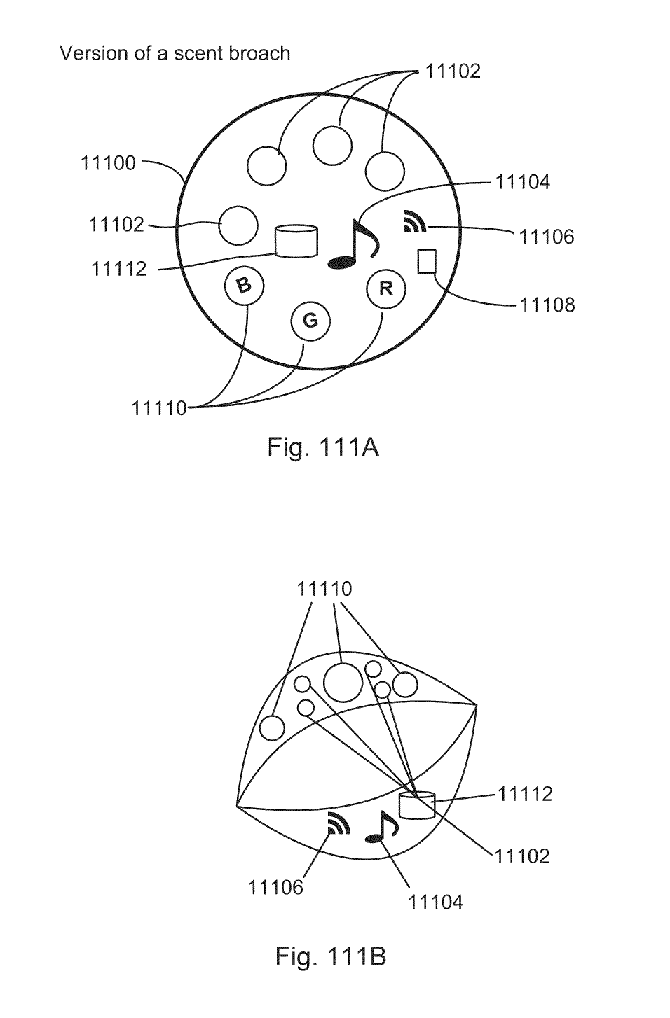

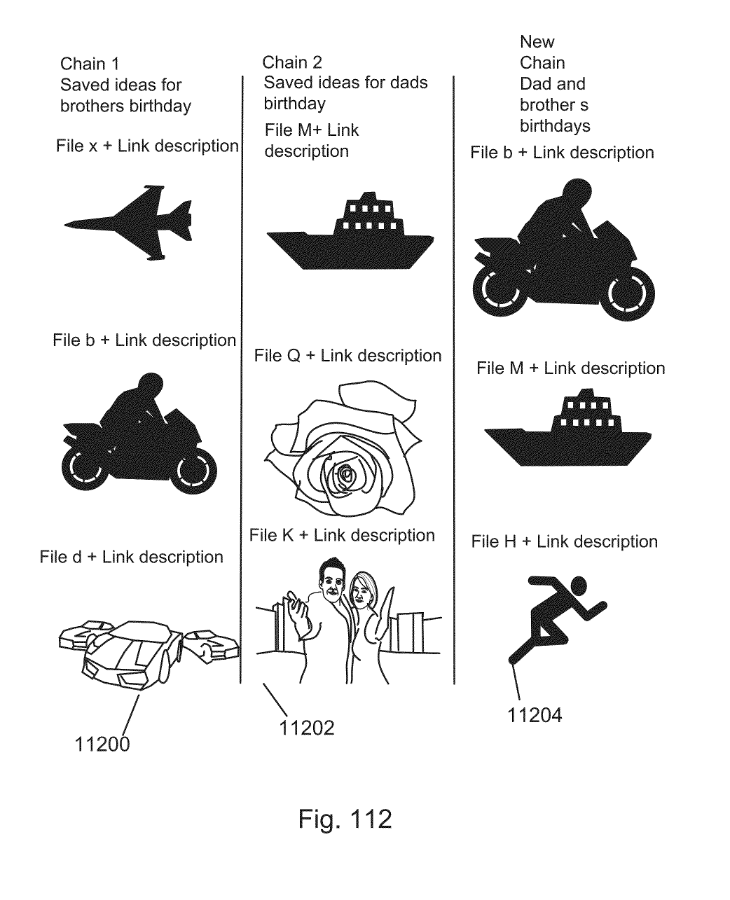

Directing attention to FIGS. 85-90, Meta data tags have file locations, descriptions and key words, x/y/z positioning and the tool rose nodes heuristically scan documents, images, videos etc. dependent on security and privacy settings at initial download or upon user request, after satisfying user security prompts. The tool rose program's meta data in the tag would have a timed and mapped location notation of where on the screen the tag was placed by the user [or professional tagger for retail/product placement], this would in effect give a virtual screen shot, and would allow the “key tag” of the system below Key word or image recognition based on a combination of “heuristic strings” and “user tags”, then either the key word, or image becoming automatically active, or a “key tag” tag becomes automatically active. The key word/image/tag activates in that manner that either becomes a hyper linked to the key word website, or other site such as retail, this would work in for brand recognition and in research. Contextual heuristic analysis to the positional grid tagging to enable identification in still, as well as moving images. The user tags to be visualized if desired by users in the user interface, for example the tags could be in different colors or shapes depending what emotion or profession etc. tags to be placed on a two or three axis grid, to show where the user s placing the tag. The tag position on the grid to be searchable by users. Users can set tags to act as hot links/deep links to specific points on a website, web page, or file, they can highlight an area and set a tag for the whole area that is highlighted, each tag can be a variation and a subset to an original definition, or a fresh tag. The user can also set a tag to a petal in the tool rose. The user can use a group set of multiple image tags using the grid points which are part of the tag system to aid pattern recognition and image analysis, such as by highlighting a section on an image or text to be transferred to a search request etc. This would be useful for example for highlighting a select item for search in an image with many items.

What is claimed is:

1. A dual node network system and method.
